(19) United States
(12) Patent Application Publication
(10) Pub. No.: US 2026/0051977 A1
(43) Pub. Date: Feb. 19, 2026

(54) METHOD AND DEVICE FOR HARQ FEEDBACK TRANSMISSION IN WIRELESS COMMUNICATION SYSTEM

(71) Applicant: Samsung Electronics Co., Ltd., Suwon-si (KR)

(72) Inventors: Sungjin PARK, Suwon-si (KR); Kyungjun CHOI, Suwon-si (KR); Hyoungju JI, Suwon-si (KR)

(21) Appl. No.: 19/289,759

(22) Filed: Aug. 4, 2025

(30) Foreign Application Priority Data
Aug. 16, 2024 (KR) 10-2024-0109809

(51) Int. Cl. H04L 1/1829; H04W 72/11

(52) U.S. Cl. CPC H04L 1/1854; H04L 1/1864; H04W 72/11

(57) ABSTRACT

A method performed by a user equipment (UE) in a wireless communication system is provided. The method includes receiving, from a base station, first configuration for a physical downlink shared channel (PDSCH) and second configuration information for a hybrid automatic repeat request (HARQ) acknowledgement (ACK), receiving, from the base station, scheduling information for receiving the PDSCH, receiving, from the base station, the PDSCH, identifying whether the scheduling information is associated with a downlink (DL) semi-persistent scheduling (SPS), and transmitting, to the base station, a negative acknowledgement (NACK) message, in case that the scheduling information is associated with the DL SPS and decoding of the received PDSCH fails.

### CROSS-REFERENCE TO RELATED APPLICATION(S)

This application is based on and claims priority under 35 U.S.C. § 119 (a) of a Korean patent application number 10-2024-0109809, filed on Aug. 16, 2024, in the Korean Patent Office, the disclosure of which is incorporated by reference herein in its entirety.

### BACKGROUND

### 1. Field

The disclosure relates to operations of a terminal and a base station in a wireless communication system. More particularly, the disclosure relates to a method for configuring/reporting uplink control information in a wireless communication system and a device capable of performing the same.

### 2. Description of Related Art

Fifth generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and a method capable of effectively providing services in a mobile communication system.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes receiving, from a base station, first configuration information for a physical downlink shared channel (PDSCH) and second configuration information for a hybrid automatic repeat request (HARQ) acknowledgement (ACK), receiving, from the base station, scheduling information for receiving the PDSCH, receiving, from the base station, the PDSCH, identifying whether the scheduling information is associated with a downlink (DL) semi-persistent scheduling (SPS), and transmitting, to the base station, a negative acknowledgement (NACK) message, in case that the scheduling information is associated with the DL SPS and decoding of the received PDSCH fails.

In accordance with another aspect of the disclosure, a user equipment (UE) in a wireless communication system is provided. The UE includes at least one transceiver, memory, comprising one or more storage media, storing instructions, and at least one processor communicatively coupled to the at least one transceiver and the memory, wherein the instructions, when executed by the at least one processor individually or collectively, cause the UE to receive, from a base station, first configuration information for a physical downlink shared channel (PDSCH) and second configuration information for a hybrid automatic repeat request (HARQ) acknowledgement (ACK), receive, from the base station, scheduling information for receiving the PDSCH, receive, from the base station, the PDSCH, identify whether the scheduling information is associated with a downlink (DL) semi-persistent scheduling (SPS), and transmit, to the base station, a negative acknowledgement (NACK) message, in case that the scheduling information is associated with the DL SPS and decoding of the received PDSCH fails.

In accordance with another aspect of the disclosure, a method performed by a base station in a wireless communication system is provided. The method includes transmitting, to a user equipment (UE), first configuration information for a physical downlink shared channel (PDSCH) and second configuration information for a hybrid automatic repeat request (HARQ) acknowledgement (ACK), transmitting, to the UE, scheduling information for the PDSCH, transmitting, to the UE, the PDSCH, and receiving, from the UE, a negative acknowledgement (NACK) message, in case that the scheduling information is associated with a downlink (DL) semi-persistent scheduling (SPS) and decoding of the PDSCH fails.

In accordance with another aspect of the disclosure, a base station in a wireless communication system is provided. The base station includes at least one transceiver, memory, comprising one or more storage media, storing instructions, and at least one processor communicatively coupled to the at least one transceiver and the memory, wherein the instructions, when executed by the at least one processor individually collectively, cause the base station to transmit, to a user equipment (UE), first configuration information for a physical downlink shared channel (PDSCH) and second configuration information for a hybrid automatic repeat request (HARQ) acknowledgement (ACK), transmit, to the UE, scheduling information for the PDSCH, transmit, to the UE, the PDSCH, and receive, from the UE, a negative acknowledgement (NACK) message, in case that the scheduling information is associated with a downlink (DL) semi-persistent scheduling (SPS) and decoding of the PDSCH fails.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include receiving, from a base station, first configuration information for a physical downlink shared channel (PDSCH) and second configuration information for a hybrid automatic repeat request (HARQ) acknowledgement (ACK), receiving, from the base station, scheduling information for receiving the PDSCH, receiving, from the base station, the PDSCH, identifying whether the scheduling information is associated with a downlink (DL) semi-persistent scheduling (SPS), and transmitting, to the base station, a negative acknowledgement (NACK) message, in case that the scheduling information is associated with the DL SPS and decoding of the received PDSCH fails.

Another aspect of the disclosure is to provide an apparatus and a method capable of effectively providing services in a wireless communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain in a wireless communication system according to an embodiment of the disclosure;

FIG. 2 illustrates a structure of a frame, a subframe, and a slot in a wireless communication system according to an embodiment of the disclosure;

FIG. 3 illustrates an example of PUSCH repetition type B transmission in a wireless communication system according to an embodiment of the disclosure;

FIG. 4 illustrates an example of an aperiodic CSI reporting method according to an embodiment of the disclosure;

FIG. 5 illustrates examples in which uplink control information is mapped to a PUSCH according to an embodiment of the disclosure;

FIG. 6 illustrates a procedure of transmitting and receiving UCI information between a UE and a base station on a PUSCH according to an embodiment of the disclosure;

FIG. 7 illustrates a method of configuring a semi-static HARQ-ACK codebook (or Type-1 HARQ-ACK codebook) in an NR system according to an embodiment of the disclosure;

FIG. 8 illustrates a method of configuring a dynamic HARQ-ACK codebook (or Type-2 HARQ-ACK codebook) in the NR system according to an embodiment of the disclosure;

FIG. 9 illustrates an operation for transmitting HARQ-ACK feedback according to an embodiment of the disclosure;

FIG. 10 illustrates a method of configuring a Type-3 HARQ-ACK codebook according to an embodiment of the disclosure;

FIG. 11 illustrates a situation in which a UE requests NACK-only feedback according to an embodiment of the disclosure;

FIG. 12 illustrates a situation in which a UE requests NACK-only feedback according to an embodiment of the disclosure;

FIG. 13 illustrates a structure of a UE in a wireless communication system according to an embodiment of the disclosure; and

FIG. 14 illustrates a structure of a base station in a wireless communication system according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’.

The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems.

In 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (COMP), reception-end interference cancellation and the like.

In the 5G system, Hybrid frequency shift keying (FSK) and quadrature amplitude modulation (QAM) (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

An electronic device may use a modulation scheme having a high peak to average power ratio (PAPR) to process considerable data capacity in the 5G system. To linearly amplify a modulation signal having a high PAPR, a power amplifier operates in a back-off region which is backed off from a maximum output by a specific value instead of a region having the maximum output. In so doing, the power amplifier operating in the back-off region decreases in efficiency, and increases in power consumption. To improve the amplifier efficiency in the back-off region, a Doherty power amplifier including two power amplifiers may be used. However, the Doherty power amplifier is limited in the back-off region for improving the efficiency, and its efficiency improvement capability may be limited.

The Internet is evolving from a human-centered network, where humans generate and consume information, into an Internet of Things (IoT) network, in which information is exchanged and processed among distributed components such as objects and devices. Technologies for processing big data—enabled through connections with cloud servers—are also emerging as part of the Internet of Everything (IoE), which combines such capabilities with IoT.

To implement IoT, various technological components are required, including sensing technologies, wired and wireless communication and network infrastructure, service interface technologies, and security technologies. Recently, technologies such as sensor networks for object-to-object connectivity, Machine to Machine (M2M) communication, and Machine Type Communication (MTC) have been actively researched.

In an IoT environment, intelligent Internet Technology (IT) services that collect and analyze data generated from connected objects can create new value for human life. IoT can be applied to various fields through the convergence and integration of traditional IT (information technology) with other industries, such as smart homes, smart buildings, smart cities, smart cars or connected cars, smart grids, healthcare, smart appliances, and advanced medical services.

Various efforts are being made to apply 5G communication systems (fifth-generation communication systems or New Radio (NR)) to IoT networks. For example, technologies such as sensor networks, M2M communication, and MTC are being implemented through 5G techniques like beamforming, MIMO, and array antennas. The application of cloud radio access networks (cloud RAN) for big data processing, as mentioned earlier, is also an example of the convergence between 5G technologies and IoT.

With the advance of wireless communication systems as described above, various services can be provided, and accordingly there is a need for ways to smoothly provide these services.

Embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

In the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. In describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include, for example, a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

It will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card. Furthermore, the “unit” in embodiments may include one or more processors.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers, for example, to a radio link via which a user equipment (UE) or a mobile station (MS) transmits data or control signals to a base station (BS) (or eNode B), and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

The eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. The mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, the URLLC is a cellular-based mission-critical wireless communication service. For example, the URLLC may be used for services such as remote control for robots or machines, industrial automation, unmanned aerial vehicles, remote health care, and emergency alert. The URLLC must provide communication with ultra-low latency and ultra-high reliability. For example, a service supporting the URLLC must satisfy an air interface latency of less than 0.5 ms, and also requires a packet error rate of 10-5 or less. Therefore, for the services supporting the URLLC, a 5G system must provide a transmit time interval (TTI) shorter than those of other services, and also may require a design for assigning a large number of resources in a frequency band in order to secure reliability of a communication link.

The three services in 5G, that is, the eMBB, the URLLC, and the mMTC, may be multiplexed and transmitted in a single system. In this case, different transmission/reception techniques and transmission/reception parameters may be used between services in order to satisfy different requirements of the respective services. Of course, 5G is not limited to the three services described above.

Hereinafter, embodiments of the disclosure will be described in detail in conjunction with the accompanying drawings. In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the following description of embodiments of the disclosure, 5G systems will be described by way of example, but the embodiments of the disclosure may also be applied to other communication systems having similar technical backgrounds or channel types. Examples of such communication systems may include LTE or LTE-A mobile communication systems and mobile communication technologies developed beyond 5G. Therefore, based on determinations by those skilled in the art, the embodiments of the disclosure may also be applied to other communication systems through some modifications without significantly departing from the scope of the disclosure. The contents of the disclosure may be applied to FDD and TDD systems.

In describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description of the disclosure, higher layer signaling may refer to signaling corresponding to at least one signaling among the following signaling, or a combination of one or more thereof.
Master information block (MIB)
System information block (SIB) or SIB X (X=1, 2, . . . )
Radio resource control (RRC)
Medium access control (MAC) control element (CE)

In addition, L1 signaling may refer to signaling corresponding to at least one signaling method among signaling methods using the following physical layer channels or signaling, or a combination of one or more thereof.
Physical downlink control channel (PDCCH)
Downlink control information (DCI)
UE-specific DCI
Group common DCI
Common DCI
Scheduling DCI (for example, DCI used for the purpose of scheduling downlink or uplink data)
Non-scheduling DCI (for example, DCI not used for the purpose of
scheduling downlink or uplink data)
Physical uplink control channel (PUCCH)
Uplink control information (UCI)

Hereinafter, determining priority between A and B may be variously described as, for example, selecting an entity having a higher priority according to a predetermined priority rule and performing an operation corresponding thereto, or omitting or dropping operations regarding an entity having a lower priority.

Hereinafter, the above examples may be described through several embodiments, but they are not independent of each other, and one or more embodiments may be applied simultaneously or in combination.

### [NR Time-Frequency Resources]

Hereinafter, a frame structure of a 5G system will be described in more detail with reference to the accompanying drawings.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

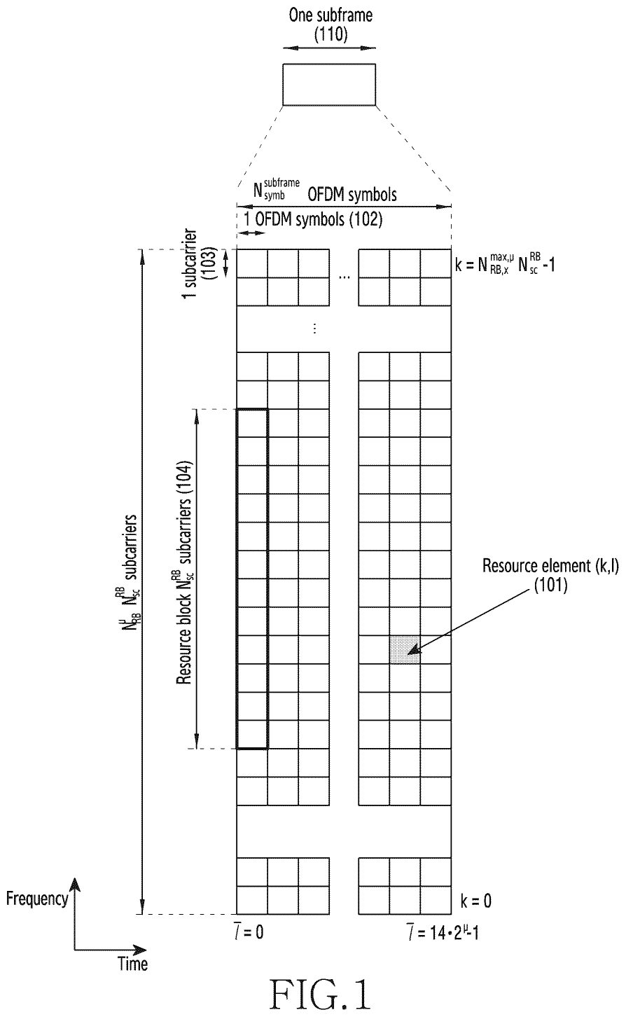

FIG. 1 illustrates a basic structure of a time-frequency domain in a wireless communication system according to an embodiment of the disclosure.

FIG. 1 illustrates a basic structure of a time-frequency domain (one subframe 110), which is a radio resource domain used to transmit data or control channels, in a 5G system.

Referring to FIG. 1, the horizontal axis denotes a time domain, and the vertical axis denotes a frequency domain. The basic unit of resources in the time-frequency domain is a resource element (RE) 101, which may be defined as one orthogonal frequency division multiplexing (OFDM) symbol 102 on the time axis and one subcarrier 103 on the frequency axis. In the frequency domain, N_{SC}^{RB} (for example, 12) consecutive REs may constitute one resource block (RB) 104.

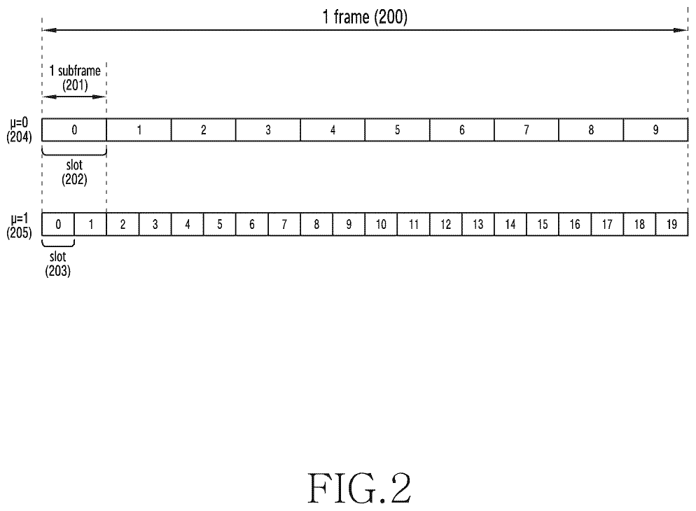

FIG. 2 illustrates a structure of a frame, a subframe, and a slot in a wireless communication system according to an embodiment of the disclosure.

An example of a structure of a frame 200, a subframe 201, and a slot 202 is illustrated in FIG. 2. One frame 200 may be defined as 10 ms. One subframe 201 may be defined as 1 ms, and thus one frame 200 may include a total of ten subframes 201. One slot 202 or 203 may be defined as 14 OFDM symbols (that is, the number of symbols per one slot

$${N}_{symb}^{slot} = 14 ) .$$

One subframe 201 may include, for example, one or multiple slots 202 and 203, and the number of slots 202 and 203 per one subframe 201 may vary depending on configuration values u for the subcarrier spacing 204 or 205. The example in FIG. 2 illustrates a case in which the subcarrier spacing configuration value is μ=0 (204), and a case in which μ=1 (205). In the case of μ=0 (204), one subframe 201 may include one slot 202, and in the case of μ=1 (205), one subframe 201 may include two slots 203. The number of slots per one subframe

$${N}_{slot}^{subframe , μ}$$

may differ depending on the subcarrier spacing configuration value μ, and the number of slots per one frame

$${N}_{slot}^{frame , μ}$$

may differ accordingly.

$${N}_{slot}^{subframe , μ} and {N}_{slot}^{frame , μ}$$

may be defined according to each subcarrier spacing configuration μ as in Table 1 below.

TABLE 1

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [PDCCH: Regarding DCI]

Next, downlink control information (DCI) in a 5G system will be described in detail.

In a 5G system, scheduling information regarding uplink data (or physical uplink shared channel (PUSCH)) or downlink data (or physical downlink shared channel (PDSCH)) is included in DCI and transferred from a base station to a UE through the DCI. The UE may monitor, with regard to the PUSCH or PDSCH, a fallback DCI format and a non-fallback DCI format. The fallback DCI format may include a fixed field predefined between the base station and the UE, and the non-fallback DCI format may include a configurable field.

The DCI may be subjected to channel coding and modulation processes and then transmitted through a physical downlink control channel (PDCCH) after a channel coding and modulation process. A cyclic redundancy check (CRC) may be attached, for example, to the payload of a DCI message, and the CRC may be scrambled by a radio network temporary identifier (RNTI) corresponding to the identity of the UE. Different RNTIs may be used according to the purpose of the DCI message, for example, UE-specific data transmission, power control command, or random access response. That is, the RNTI may not be explicitly transmitted, but may be transmitted while being included in a CRC calculation process. Upon receiving a DCI message transmitted through the PDCCH, the UE may identify the CRC by using the allocated RNTI, and if the CRC identification result is right, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

The DCI format 0_0 may be used as fallback DCI for scheduling a PUSCH, and in this case, the CRC may be scrambled by a C-RNTI. DCI format 0_0 in which the CRC is scrambled by a C-RNTI may include the following pieces of information given in Table 2 below, for example.

TABLE 2
Identifier for DCI formats - [1] bit
$Frequency domain resource assignment ‐ [ ⌈ {log}_{2} ( {N}_{RB}^{UL , BWP} ( {N}_{RB}^{UL , BWP} + 1 ) / 2 ) ⌉ ] bits$
Time domain resource assignment - X bits
Frequency hopping flag - 1 bit.
Modulation and coding scheme - 5 bits
New data indicator - 1 bit
Redundancy version - 2 bits
HARQ process number - 4 bits
Transmit power control (TPC) command for scheduled PUSCH - [2] bits
Uplink/ supplementary uplink (UL/SUL) indicator - 0 or 1 bit

The DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information given in Table 3 below, for example.

```
TABLE 3
    Carrier indicator - 0 or 3 bits
    UL/SUL indicator - 0 or 1 bit
    Identifier for DCI formats - [1] bits
    Bandwidth part indicator - 0, 1 or 2 bits
    Frequency domain resource assignment
        $For resource allocation type 0 , ⌈ {N}_{RB}^{UL , BWP} / P ⌉ bits$
        $For resource allocation type 1 , ⌈ {log}_{2} ( {N}_{RB}^{UL , BWP} ( {N}_{RB}^{UL , BWP} + 1 ) / 2 ) ⌉ bits$
    Time domain resource assignment - 1, 2, 3, or 4 bits
    Virtual resource block (VRB)-to-physical resource block (PRB) mapping - 0 or 1 bit,
only for resource allocation type 1.
        0 bit if only resource allocation type 0 is configured;
        1 bit otherwise.
    Frequency hopping flag - 0 or 1 bit, only for resource allocation type 1.
        0 bit if only resource allocation type 0 is configured;
        1 bit otherwise.
    Modulation and coding scheme - 5 bits
    New data indicator - 1 bit
    Redundancy version - 2 bits
    HARQ process number - 4 bits
    1st downlink assignment index - 1 or 2 bits
        1 bit for semi-static HARQ-ACK codebook;
        2 bits for dynamic HARQ-ACK codebook with single HARQ-ACK codebook.
    2nd downlink assignment index - 0 or 2 bits
        2 bits for dynamic HARQ-ACK codebook with two HARQ-ACK sub-codebooks;
        0 bit otherwise.
    TPC command for scheduled PUSCH - 2 bits
    $Sounding reference signal ( SRS ) resource indicator ‐ ⌈ {log}_{2} ( {\sum }_{k = 1}^{{L}_{max} \sum } ( \begin{matrix}{N}_{S R S} \\ k\end{matrix} ) ( ) ) ⌋ ⌋ ⌉ or$
[log₂(N_{SRS})] bits
        $⌈ {log}_{2} ( {\sum }_{k = 1}^{{L}_{max} \sum } ( \begin{matrix}{N}_{SRS} \\ k\end{matrix} ) ( ) ) \_ ⌋ ⌉ bits for non ‐ codebook based PUSCH$
        transmission;
        [log₂(N_{SRS})] bits for codebook based PUSCH transmission.
    Precoding information and number of layers - up to 6 bits
    Antenna ports - up to 5 bits
    SRS request - 2 bits
    Channel state information (CSI) request - 0, 1, 2, 3, 4, 5, or 6 bits
    Code block group (CBG) transmission information - 0, 2, 4, 6, or 8 bits
    Phase tracking reference signal (PTRS)-demodulation reference signal (DDMRS)
association - 0 or 2 bits.
    beta_offset indicator - 0 or 2 bits
    DMRS sequence initialization - 0 or 1 bit
```

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information given in Table 4 below, for example.

TABLE 4
Identifier for DCI formats - [1] bit
$Frequency domain resource assignment ‐ [ ⌈ {log}_{2} ( {N}_{RB}^{DL , BWP} ( {N}_{RB}^{DL , BWP} + 1 ) / 2 ) ⌉ ] bits$
Time domain resource assignment - X bits
VRB-to-PRB mapping - 1 bit.
Modulation and coding scheme - 5 bits
New data indicator - 1 bit
Redundancy version - 2 bits
HARQ process number - 4 bits
Downlink assignment index - 2 bits
TPC command for scheduled PUCCH - [2] bits
Physical uplink control channel (PUCCH) resource indicator - 3 bits
PDSCH-to-HARQ feedback timing indicator - [3] bits

The DCI format 1_1 may be used as non-fallback DCI for scheduling a PDSCH, and in this case, the CRC may be scrambled by a C-RNTI. DCI format 0_1 in which the CRC is scrambled by a C-RNTI may include the following pieces of information given in Table 5 below, for example.

```
TABLE 5
    Carrier indicator - 0 or 3 bits
    Identifier for DCI formats - [1] bits
    Bandwidth part indicator - 0, 1 or 2 bits
    Frequency domain resource assignment
        $For resource allocation type 0 , ⌈ {N}_{RB}^{DL , BWP} / P ⌉ bits$
        $For resource allocation type 1 , ⌈ {log}_{2} ( {N}_{RB}^{DL , BWP} ( {N}_{RB}^{DL , B W P} + 1 ) / 2 ) ⌉ bits$
    Time domain resource assignment - 1, 2, 3, or 4 bits
    VRB-to-PRB mapping - 0 or 1 bit, only for resource allocation type 1.
        0 bit if only resource allocation type 0 is configured;
        1 bit otherwise.
    Physical resource block (PRB) bundling size indicator - 0 or 1 bit
    Rate matching indicator - 0, 1, or 2 bits
    Zero power (ZP) channel state information (CSI)-reference signal (RS) trigger - 0, 1, or
2 bits
  For transport block 1:
    Modulation and coding scheme - 5 bits
    New data indicator - 1 bit
    Redundancy version - 2 bits
  For transport block 2:
    Modulation and coding scheme - 5 bits
    New data indicator - 1 bit
    Redundancy version - 2 bits
    HARQ process number - 4 bits
    Downlink assignment index - 0 or 2 or 4 bits
    TPC command for scheduled PUCCH - 2 bits
    PUCCH resource indicator - 3 bits
    PDSCH-to-HARQ_feedback timing indicator - 3 bits
    Antenna ports - 4, 5 or 6 bits
    Transmission configuration indication - 0 or 3 bits
    SRS request - 2 bits
    CBG transmission information - 0, 2, 4, 6, or 8 bits
    CBG flushing out information - 0 or 1 bit
    DMRS sequence initialization - 1 bit
```

### [PDSCH: Processing Time]

Next, a PDSCH processing time (PDSCH processing procedure time) will be described. If the base station schedules the UE to transmit a PDSCH by using DCI format 1_0, 1_1 or 1_2, the UE may need a PDSCH processing time for receiving a PDSCH by applying a transmission method (modulation/demodulation and coding indication index (MCS), demodulation reference signal-related information, time and frequency resource allocation information, and the like) indicated through DCI. The PUSCH preparation procedure time is defined in NR in consideration thereof. The PUSCH processing time of the UE may follow Equation 1 given below.

$${T}_{proc , 1} = ( {N}_{1} + {d}_{1 , 1} + {d}_{2} ) ( 2048 + 144 ) κ {2}^{- μ} {T}_{c} + {T}_{ext} \qquad Equation 1$$

Each parameter in T_{proc,1} described above in Equation 1 may have the following meaning.
N₁: the number of symbols determined according to UE processing capability 1 or 2 based on the UE's capability and numerology μ. N₁ may have a value in Table 6 if UE processing capability 1 is reported according to the UE's capability report, and may have a value in Table 7 if UE processing capability 2 is reported, and if availability of UE processing capability 2 is configured through upper layer signaling. Table 6 shows a PDSCH processing time in the case of PDSCH processing capability 1, and Table 7 shows a PDSCH processing time in the case of PDSCH processing capability 2. The numerology u may correspond to the minimum value among μ_{PDCCH}, μ_{PDSCH}, ρ_{UL} so as to maximize T_{proc,1}, and μ_{PDCCH}, μ_{PDSCH}, μ_{UL} may refer to the numerology of a PDCCH that scheduled a PDSCH, the numerology of the scheduled PDSCH, and numerology of an uplink channel in which a HARQ-ACK is to be transmitted.

TABLE 6

| | PDSCH decoding time N₁ [symbols] | |
|---|---|---|
| | If PDSCH mapping type A and B | If PDSCH mapping type A and B both do not |
| | both correspond to dmrs- | correspond to dmrs-AdditionalPosition = pos0 |
| | AdditionalPosition = pos0 inside | inside DMRS-DownlinkConfig which is upper |
| | DMRS-DownlinkConfig which is | layer signaling, or if no upper layer parameter |
| μ | upper layer signaling | is configured |
| 0 | 8 | N_{1, 0} |
| 1 | 10 | 13 |
| 2 | 17 | 20 |
| 3 | 20 | 24 |

TABLE 7

| | PDSCH decoding time N₁ [symbols] |
|---|---|
| | If PDSCH mapping type A and B both correspond |
| | to dmrs-AdditionalPosition = pos0 |
| | inside DMRS-DownlinkConfig which |
| μ | is upper layer signaling |
| 0 | 3 |
| 1 | 4.5 |
| 2 | 9 for frequency range 1 |

κ: 64
Text: if the UE uses a shared spectrum channel access scheme, the UE may calculate Tₑₓₜ and apply the same to the PDSCH processing time. Otherwise, Tₑₓₜ is assumed to be 0.
If l₁ which represents the PDSCH DMRS location value is 12, N_{1,0} in Table 6 above has the value of 14, and otherwise has the value of 13.
With regard to PDSCH mapping type A, if the last symbol of the PDSCH is the i^{th} symbol in the slot in which the PDSCH is transmitted, and if i<7, d_{1,1} is then 7-i, and d_{1,1} is otherwise 0.
d₂: if a PUCCH having a high priority index temporally overlaps another PUCCH or a PUSCH having a low priority index, d₂ of the PUCCH having a high priority index may be configured as a value reported from the UE. Otherwise, d₂ is 0.
If PDSCH mapping type B is used with regard to UE processing capability 1, the d_{1,1} value may be determined by the number (L) of symbols of a scheduled PDSCH and the number of overlapping symbols between the PDCCH that schedules the PDSCH and the scheduled PDSCH, as follows.

* If L ≥ 7, then d_{1,1} = 0.
* If − L ≥ 4 and L ≤ 6, then d_{1,1} = 7 − L.
* If L = 3, then d_{1,1} = min (d, 1).
* If L=2, then d_{1,1} = 3 + d.

If PDSCH mapping type B is used with regard to UE processing capability 2, the d_{1,1} value may be determined by the number (L) of symbols of a scheduled PDSCH and the number of overlapping symbols between the PDCCH that schedules the PDSCH and the scheduled PDSCH, as follows.

* If L ≥ 7, then d_{1,1} = 0.
* If − L ≥ 4 and L ≤ 6, then d_{1,1} = 7 − L.
* If L=2,

If the scheduling PDCCH exists inside a CORESET including three symbols, and if the CORESET and the scheduled PDSCH have the same start symbol, then d1,1=3.

• Otherwise, d1,1 = d.

In the case of a UE supporting capability 2 inside a given serving cell, the PDSCH processing time based on UE processing capability 2 may be applied by the UE if processingType2Enabled (higher layer signaling) is configured as “enable” with regard to the corresponding cell.

If the location of the first uplink transmission symbol of a PUCCH including HARQ-ACK information (in connection with the corresponding location, K₁ defined as the HARQ-ACK transmission timepoint, a PUCCH resource used to transmit the HARQ-ACK, and the timing advance effect may be considered) does not start earlier than the first uplink transmission symbol that comes after the last symbol of the PDSCH over a time of T_{proc,1}, the UE needs to transmit a valid HARQ-ACK message. The UE needs to transmit a PUCCH including a HARQ-ACK only if the PDSCH processing time is sufficient. The UE cannot otherwise provide the base station with valid HARQ-ACK information corresponding to the scheduled PDSCH. The T_{proc,1} may be used in the case of both a normal and an extended CP. In the case of a PDSCH having two PDSCH transmission locations configured inside one slot, d_{1,1} is calculated with reference to the first PDSCH transmission location inside the corresponding slot.

### [PDSCH: Reception Preparation Time During Cross-Carrier Scheduling]

Next, in the case of cross-carrier scheduling in which the numerology (μ_{PDCCH}) by which a scheduling PDCCH is transmitted and the numerology (μ_{PDSCH}) by which a PDSCH scheduled by the corresponding PDCCH is transmitted are different from each other, the PDSCH reception reparation time (N_{pdsch}) of the UE defined with regard to the time interval between the PDCCH and PDSCH will be described.

Table 8 below shows N_{pdsch} according to scheduled PDCCH subcarrier spacings.

If μ_{PDCCH}<μ_{PDSCH}, the scheduled PDSCH cannot be transmitted before the first symbol of the slot coming after N_{pdsch} symbols from the last symbol of the PDCCH that scheduled the corresponding PDSCH. The transmission symbol of the corresponding PDSCH may include a DM-RS.

If μ_{PDCCH}>μ_{PDSCH}, the scheduled PDSCH may be transmitted after N_{pdsch} symbols from the last symbol of the PDCCH that scheduled the corresponding PDSCH. The transmission symbol of the corresponding PDSCH may include a DM-RS.

TABLE 8

| μ_{PDCCH} | N_{pdsch} [symbols] |
|---|---|
| 0 | 4 |
| 1 | 5 |
| 2 | 10 |
| 3 | 14 |

### [PUSCH: Regarding Transmission Scheme]

Next, a PUSCH transmission scheduling scheme will be described. PUSCH transmission may be dynamically scheduled by a UL grant inside DCI, or operated by means of configured grant Type 1 or Type 2. Dynamic scheduling indication regarding PUSCH transmission may be made by DCI format 0_0 or 0_1.

Configured grant Type 1PUSCH transmission may be configured semi-statically by receiving configuredGrantConfig including rrc-ConfiguredUplinkGrant in Table 9 through upper signaling, without receiving a UL grant inside DCI. Configured grant Type 2PUSCH transmission may be scheduled semi-persistently by a UL grant inside DCI after receiving configuredGrantConfig not including rrc-ConfiguredUplinkGrant in Table 9 through upper signaling. If PUSCH transmission is operated by a configured grant, parameters applied to the PUSCH transmission are applied through configuredGrantConfig (upper signaling) in Table 9 except for dataScramblingIdentityPUSCH, txConfig, codebookSubset, maxRank, and scaling of UCI-OnPUSCH, which are provided by pusch-Config (upper signaling) in Table 10. If provided with transformPrecoder inside configuredGrantConfig (upper signaling) in Table 9, the UE applies tp-pi2BPSK inside pusch-Config in Table 10 to PUSCH transmission operated by a configured grant.

TABLE 9

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, resourceAllocationType1, |

dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, s3-0000} |

OPTIONAL, -- Need R

| | |
|---|---|
| periodicity | ENUMERATED { |
| | sym2, sym7, sym1x14, sym2x14, sym4x14, sym5x14, sym8x14, |

sym10x14, sym16x14, sym20x14,

sym32x14, sym40x14, sym64x14, sym80x14, sym128x14,

sym160x14, sym256x14, sym320x14, sym512x14,

```
      sym640x14, sym1024x14, sym1280x14, sym2560x14, sym5120x14,
      sym6, sym1x12, sym2x12, sym4x12, sym5x12, sym8x12, sym10x12,
```

sym16x12, sym20x12, sym32x12,

sym40x12, sym64x12, sym80x12, sym128x12, sym160x12,

sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. maxNrofPhysicalResourceBlocks-1) |

OPTIONAL, -- Need R

| | |
|---|---|
| pathlossReferenceIndex | INTEGER (0..maxNrofPUSCH-PathlossReferenceRSs-1), |

```
    ...
  }
OPTIONAL, -- Need R
  ...
}
```

Next, a PUSCH transmission method will be described. The DMRS antenna port for PUSCH transmission is identical to an antenna port for SRS transmission. PUSCH transmission may follow a codebook-based transmission method and a non-codebook-based transmission method according to whether the value of txConfig inside pusch-Config in Table 10, which is upper signaling, is “codebook” or “nonCodebook”.

As described above, PUSCH transmission may be dynamically scheduled through DCI format 0_0 or 0_1, and may be semi-statically configured by a configured grant. Upon receiving indication of scheduling regarding PUSCH transmission through DCI format 0_0, the UE performs beam configuration for PUSCH transmission by using pucch-spatialRelationInfoID corresponding to a UE-specific PUCCH resource corresponding to the minimum ID inside an activated uplink BWP inside a serving cell, and the PUSCH transmission is based on a single antenna port. The UE does not expect scheduling regarding PUSCH transmission through DCI format 0_0 inside a BWP having no configured PUCCH resource including pucch-spatialRelationInfo. If the UE has no configured txConfig inside pusch-Config in Table 10, the UE does not expect scheduling through DCI format 0_1.

TABLE 10

| PUSCH-Config ::= | SEQUENCE { | |
|---|---|---|
| dataScramblingIdentityPUSCH | INTEGER (0..1023) | OPTIONAL, |

-- Need S

| | |
|---|---|
| txConfig | ENUMERATED {codebook, nonCodebook} |

OPTIONAL, -- Need S

| | |
|---|---|
| dmrs-UplinkForPUSCH-MappingTypeA | SetupRelease { DMRS-UplinkConfig } |

OPTIONAL, -- Need M

| | |
|---|---|
| dmrs-UplinkForPUSCH-MappingTypeB | SetupRelease { DMRS-UplinkConfig } |

OPTIONAL, -- Need M

| | | |
|---|---|---|
| pusch-PowerControl | PUSCH-PowerControl | OPTIONAL, |

-- Need M

| | |
|---|---|
| frequencyHopping | ENUMERATED {intraSlot, interSlot} |

OPTIONAL, -- Need S

| | |
|---|---|
| frequencyHoppingOffsetLists | SEQUENCE (SIZE (1..4)) OF INTEGER (1.. |

maxNrofPhysicalResourceBlocks-1)
OPTIONAL, -- Need M

| | |
|---|---|
| resourceAllocation | ENUMERATED { resourceAllocationType0, resourceAllocationType1, |

dynamicSwitch},

| | |
|---|---|
| pusch-TimeDomainAllocationList | SetupRelease { PUSCH-TimeDomainResourceAllocationList } |

OPTIONAL, -- Need M

| | |
|---|---|
| pusch-AggregationFactor | ENUMERATED { n2, n4, n8 } |

OPTIONAL, -- Need S

| | |
|---|---|
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| transformPrecoder | ENUMERATED {enabled, disabled} |

OPTIONAL, -- Need S

| | |
|---|---|
| codebookSubset | ENUMERATED {fullyAndPartialAndNonCoherent, |

partialAndNonCoherent, nonCoherent }
OPTIONAL, -- Cond codebookBased

| | | |
|---|---|---|
| maxRank | INTEGER (1..4) | OPTIONAL, - |

- Cond codebookBased

| | | |
|---|---|---|
| rbg-Size | ENUMERATED { config2} | OPTIONAL, |

-- Need S

| | |
|---|---|
| uci-OnPUSCH | SetupRelease { UCI-OnPUSCH} |

OPTIONAL, -- Need M

| | | |
|---|---|---|
| tp-pi2BPSK | ENUMERATED {enabled} | OPTIONAL, |

-- Need S
...
}

Hereinafter, codebook-based PUSCH transmission will be described. The codebook-based PUSCH transmission may be dynamically scheduled through DCI format 0_0 or 0_1, and may be operated semi-statically by a configured grant. If a codebook-based PUSCH is dynamically scheduled through DCI format 0_1 or configured semi-statically by a configured grant, the UE determines a precoder for PUSCH transmission, based on an SRS resource indicator (SRI), a transmission precoding matrix indicator (TPMI), and a transmission rank (the number of PUSCH transmission layers).

The SRI may be given through the SRS resource indicator (a field inside DCI) or configured through srs-ResourceIndicator (upper signaling). During codebook-based PUSCH transmission, the UE has at least one SRS resource configured therefor, and may have a maximum of two SRS resources configured therefor. If the UE is provided with the SRI through DCI, the SRS resource indicated by the corresponding SRI refers to the SRS resource corresponding to the SRI, among SRS resources transmitted prior to the PDCCH including the corresponding SRI. In addition, the TPMI and the transmission rank may be given through “precoding information and number of layers” (a field inside DCI) or configured through precodingAndNumberOfLayers (upper signaling). In an embodiment, the TPMI is used to indicate a precoder to be applied to PUSCH transmission. If one SRS resource is configured for the UE, the TPMI may be used to indicate a precoder to be applied in the configured one SRS resource. If multiple SRS resources are configured for the UE, the TPMI is used to indicate a precoder to be applied in an SRS resource indicated through the SRI.

The precoder to be used for PUSCH transmission is selected from an uplink codebook having the same number of antenna ports as the value of nrofSRS-Ports inside SRS-Config (upper signaling). In connection with codebook-based PUSCH transmission, the UE determines a codebook subset, based on codebookSubset inside pusch-Config (upper signaling) and TPMI. The codebookSubset inside pusch-Config (upper signaling) may be configured to be one of “fullyAndPartialAndNonCoherent”, “partialAndNonCoherent”, or “nonCoherent”, based on UE capability reported by the UE to the base station. If the UE reported “partialAndNonCoherent” as UE capability, the UE does not expect that the value of codebookSubset (upper signaling) will be configured as “fullyAndPartialAndNonCoherent”. In addition, if the UE reported “nonCoherent” as UE capability, UE does not expect that the value of codebookSubset (upper signaling) will be configured as “fullyAndPartialAndNonCoherent” or “partialAndNonCoherent”. If nrofSRS-Ports inside SRS-ResourceSet (upper signaling) indicates two SRS antenna ports, the UE does not expect that the value of codebookSubset (upper signaling) will be configured as “partialAndNonCoherent”.

The UE may have one SRS resource set configured therefor, wherein the value of usage inside SRS-ResourceSet (upper signaling) is “codebook”, and one SRS resource may be indicated through an SRI inside the corresponding SRS resource set. If multiple SRS resources are configured inside the SRS resource set wherein the value of usage inside SRS-ResourceSet (higher signaling) is “codebook”, the UE expects that the value of nrofSRS-Ports inside SRS-Resource (upper signaling) is identical for all SRS resources.

In an embodiment, the UE transmits, to the base station, one or multiple SRS resources included in the SRS resource set wherein the value of usage is configured as “codebook” according to upper signaling, and the base station selects one from the SRS resources transmitted by the UE and indicates the UE to be able to transmit a PUSCH by using transmission beam information of the corresponding SRS resource. In connection with the codebook-based PUSCH transmission, the SRI is used as information for selecting the index of one SRS resource, and is included in DCI. The base station adds information indicating the rank and TPMI to be used by the UE for PUSCH transmission to the DCI. Using the SRS resource indicated by the SRI, the UE applies, in performing PUSCH transmission, the precoder indicated by the rank and TPMI indicated based on the transmission beam of the corresponding SRS resource, thereby performing PUSCH transmission.

Next, non-codebook-based PUSCH transmission will be described. The non-codebook-based PUSCH transmission may be dynamically scheduled through DCI format 0_0 or 0_1, and may be operated semi-statically by a configured grant. If at least one SRS resource is configured inside an SRS resource set wherein the value of usage inside SRS-ResourceSet (upper signaling) is “nonCodebook”, non-codebook-based PUSCH transmission may be scheduled for the UE through DCI format 0_1.

With regard to the SRS resource set wherein the value of usage inside SRS-ResourceSet (upper signaling) is “nonCodebook”, one connected NZP CSI-RS resource (non-zero power CSI-RS) may be configured for the UE. The UE may calculate a precoder for SRS transmission by measuring the NZP CSI-RS resource connected to the SRS resource set. If the difference between the last received symbol of an aperiodic NZP CSI-RS resource connected to the SRS resource set and the first symbol of aperiodic SRS transmission in the UE is less than 42 symbols, the UE does not expect that information regarding the precoder for SRS transmission will be updated.

For example, if the configured value of resourceType inside SRS-ResourceSet (upper signaling) is “aperiodic”, the connected NZP CSI-RS is indicated by an SRS request which is a field inside DCI format 0_1 or 1_1. If the connected NZP CSI-RS resource is an aperiodic NZP CSI-RS resource, the existence of the connected NZP CSI-RS is indicated with regard to the case in which the value of SRS request (a field inside DCI format 0_1 or 1_1) is not “00”. The corresponding DCI should not indicate cross carrier or cross BWP scheduling. In addition, if the value of SRS request indicates the existence of a NZP CSI-RS, the NZP CSI-RS is located in the slot used to transmit the PDCCH including the SRS request field. In this case, TCI states configured for the scheduled subcarrier are not configured as QCL-TypeD.

If there is a periodic or semi-persistent SRS resource set configured, the connected NZP CSI-RS may be indicated through associatedCSI-RS inside SRS-ResourceSet (upper signaling). With regard to non-codebook-based transmission, the UE does not expect that spatialRelationInfo which is upper signaling regarding the SRS resource and associatedCSI-RS inside SRS-ResourceSet (higher signaling) will be configured together.

For example, if multiple SRS resources are configured for the UE, the UE may determine a precoder to be applied to PUSCH transmission and the transmission rank, based on an SRI indicated by the base station. The SRI may be indicated through the SRS resource indicator (a field inside DCI) or configured through srs-ResourceIndicator (upper signaling). Similarly to the above-described codebook-based PUSCH transmission, if the UE is provided with the SRI through DCI, the SRS resource indicated by the corresponding SRI refers to the SRS resource corresponding to the SRI, among SRS resources transmitted prior to the PDCCH including the corresponding SRI.

The UE may use one or multiple SRS resources for SRS transmission, and the maximum number of SRS resources that can be transmitted simultaneously in the same symbol inside one SRS resource set and the maximum number of SRS resources are determined by UE capability reported to the base station by the UE. SRS resources simultaneously transmitted by the UE occupy the same RB. The UE may configure one SRS port for each SRS resource. There may be only one configured SRS resource set wherein the value of usage inside SRS-ResourceSet (upper signaling) is “nonCodebook”, and a maximum of four SRS resources may be configured for non-codebook-based PUSCH transmission.

The base station transmits one NZP-CSI-RS connected to the SRS resource set to the UE, and the UE calculates the precoder to be used when transmitting one or multiple SRS resources inside the corresponding SRS resource set, based on the result of measurement when the corresponding NZP-CSI-RS is received. In an embodiment, The UE applies the calculated precoder when transmitting, to the base station, one or multiple SRS resources inside the SRS resource set wherein the configured usage is “nonCodebook”, and the base station selects one or multiple SRS resources from the received one or multiple SRS resources. In connection with the non-codebook-based PUSCH transmission, the SRI indicates an index that may express one SRS resource or a combination of multiple SRS resources, and the SRI is included in DCI. The number of SRS resources indicated by the SRI transmitted by the base station may be the number of transmission layers of the PUSCH, and the UE may transmit the PUSCH by applying the precoder applied to SRS resource transmission to each layer.

### [PUSCH: Preparation Procedure Time]

Next, a PUSCH preparation procedure time will be described. If a base station schedules a UE so as to transmit a PUSCH by using DCI format 0_0, 0_1, or 0_2, the UE may require a PUSCH preparation procedure time such that a PUSCH is transmitted by applying a transmission method (SRS resource transmission precoding method, the number of transmission layers, spatial domain transmission filter) indicated through DCI. The PUSCH preparation procedure time is defined in NR in consideration thereof. The PUSCH preparation procedure time of the UE may follow Equation 2 given below.

$${T}_{proc , 2} = max ( ( {N}_{2} + {d}_{2 , 1} + {d}_{2} ) ( 2048 + 144 ) κ {2}^{- μ} {T}_{c} + {T}_{ext} + {T}_{switch} , {d}_{2 , 2} ) \qquad Equation 2$$

Each parameter in T_{proc,2} described above in Equation 2 may have the following meaning.
N₂: the number of symbols determined according to UE processing capability 1 or 2, based on the UE's capability, and numerology μ. N₂ may have a value in Table 11 if UE processing capability 1 is reported according to the UE's capability report, and may have a value in Table 12 if UE processing capability 2 is reported, and if availability of UE processing capability 2 is configured through upper layer signaling.

TABLE 11

| μ | PUSCH preparation time N₂ [symbols] |
|---|---|
| 0 | 10 |
| 1 | 12 |
| 2 | 23 |
| 3 | 36 |

TABLE 12

| μ | PUSCH preparation time N₂ [symbols] |
|---|---|
| 0 | 5 |
| 1 | 5.5 |
| 2 | 11 for frequency range 1 |

d_{2,1}: the number of symbols determined to be 0 if all resource elements of the first OFDM symbol of PUSCH transmission include DM-RSs, and to be 1 otherwise.
κ: 64
μ: follows a value, among μ_{DL} and μ_{UL}, which makes T_{proc,2} larger. μ_{DL} refers to the numerology of a downlink used to transmit a PDCCH including DCI that schedules a PUSCH, and μ_{UL} refers to the numerology of an uplink used to transmit a PUSCH.

$${T}_{c} : has 1 / ( Δ {f}_{max} \cdot {N}_{f} ) , Δ {f}_{max} = 480 \cdot {10}^{3} Hz , {N}_{f} = 40 96.$$

d_{2,2}: follows a BWP switching time if DCI that schedules a PUSCH indicates BWP switching, and has 0 otherwise.
d₂: if OFDM symbols overlap temporally between a PUSCH having a high priority index and a PUCCH having a low priority index, the d₂ value of the PUSCH having a high priority index is used. Otherwise, d₂ is 0.
Tₑₓₜ: if the UE uses a shared spectrum channel access scheme, the UE may calculate Tₑₓₜ and apply the same to a PUSCH preparation procedure time. Otherwise, Tₑₓₜ is assumed to be 0.
T_{switch}: if an uplink switching spacing has been triggered, T_{switch} is assumed to be the switching spacing time. Otherwise, T_{switch} is assumed to be 0.

The base station and the UE determine that the PUSCH preparation procedure time is insufficient if the first symbol of a PUSCH starts earlier than the first uplink symbol in which a CP starts after T_{proc,2} from the last symbol of a PDCCH including DCI that schedules the PUSCH, in view of the influence of timing advance between the uplink and the downlink and time domain resource mapping information of the PUSCH scheduled through the DCI. Otherwise, the base station and the UE determine that the PUSCH preparation procedure time is sufficient. The UE may transmit the PUSCH only if the PUSCH preparation procedure time is sufficient, and may ignore the DCI that schedules the PUSCH if the PUSCH preparation procedure time is insufficient.

### [PUSCH: Regarding Repetition Transmission]

Hereinafter, repetition transmission of an uplink data channel in a 5G system will be described in detail. A 5G system supports two types of uplink data channel repetition transmission methods, PUSCH repetition type A transmission and PUSCH repetition type B transmission. One of PUSCH repetition type A transmission and PUSCH repetition type B transmission may be configured for a UE through upper layer signaling.

### PUSCH Repetition Type A Transmission

As described above, the symbol length of an uplink data channel and the location of the start symbol may be determined by a time domain resource allocation method in one slot, and a base station may notify a UE of the number of repetition transmissions through upper layer signaling (for example, RRC signaling) or L1 signaling (for example, DCI).
Based on the number of repetition transmissions received from the base station, the UE may repetitively transmit an uplink data channel having the same length and start symbol as the configured uplink data channel, in a continuous slot. If the base station configured a slot as a downlink for the UE, or if at least one of symbols of the uplink data channel configured for the UE is configured as a downlink, the UE omits uplink data channel transmission, but counts the number of repetition transmissions of the uplink data channel.

### PUSCH Repetition Type B Transmission

As described above, the symbol length of an uplink data channel and the location of the start symbol may be determined by a time domain resource allocation method in one slot, and a base station may notify a UE of the number of repetition transmissions (numberofrepetitions) through upper layer signaling (for example, RRC signaling) or L1 signaling (for example, DCI).
The nominal repetition of the uplink data channel is determined as follows, based on the previously configured start symbol and length of the uplink data channel. The slot in which the n^{th} nominal repetition starts is given by

$${K}_{s} + ⌊ \frac{S + n \cdot L}{{N}_{symb}^{slot}} ⌋ ,$$

and the symbol starting in that slot is given by

$$mod ( S + n \cdot L , {N}_{symb}^{slot} ) .$$

The slot in which the n^{th} nominal repetition ends is given by

$${K}_{s} + ⌊ \frac{S + ( n + 1 ) \cdot L - 1}{{N}_{symb}^{slot}} ⌋ ,$$

and the symbol ending in that slot is given by

$$mod ( S + ( n + 1 ) \cdot L - 1 , {N}_{symb}^{slot} ) .$$

In this regard, n=0, . . . , numberofrepetitions−1, S refers to the start symbol of the configured uplink data channel, and L refers to the symbol length of the configured uplink data channel. Kₛ refers to the slot in which PUSCH transmission starts, and

$${N}_{symb}^{slot}$$

refers to the number of symbols per slot.
The UE may determine an invalid symbol for PUSCH repetition type B transmission. A symbol configured as a downlink by tdd-UL-DL-ConfigurationCommon or tdd-UL-DL-ConfigurationDedicated may be determined as the invalid symbol for PUSCH repeated transmission type B. Additionally, the invalid symbol may be configured in an upper layer parameter (for example, InvalidSymbolPattern). The upper layer parameter (for example, InvalidSymbolPattern) may provide a symbol level bitmap across one or two slots, thereby configuring the invalid symbol. In the bitmap, 1 represents the invalid symbol. Additionally, the periodicity and pattern of the bitmap may be configured through the upper layer parameter (for example, InvalidSymbolPattern). If an upper layer parameter (for example, InvalidSymbolPattern) is configured, and if parameter InvalidSymbolPatternIndicator-ForDCIFormat0_1 or InvalidSymbolPatternIndicator-ForDCIFormat0_2 indicates 1, the UE applies an invalid symbol pattern, and if the above parameter indicates 0, the UE does not apply the invalid symbol pattern. If an upper layer parameter (for example, InvalidSymbolPattern) is configured, and if InvalidSymbolPatternIndicator-ForDCIFormat0_1 or parameter InvalidSymbolPatternIndicator-ForDCIFormat0_2 is not configured, the UE applies the invalid symbol pattern.

After an invalid symbol is determined, the UE may consider, with regard to each nominal repetition, that symbols other than the invalid symbol are valid symbols. If one or more valid symbols are included in each nominal repetition, the nominal repetition may include one or more actual repetitions. Each actual repetition includes a set of consecutive valid symbols available for PUSCH repetition type B transmission in one slot.

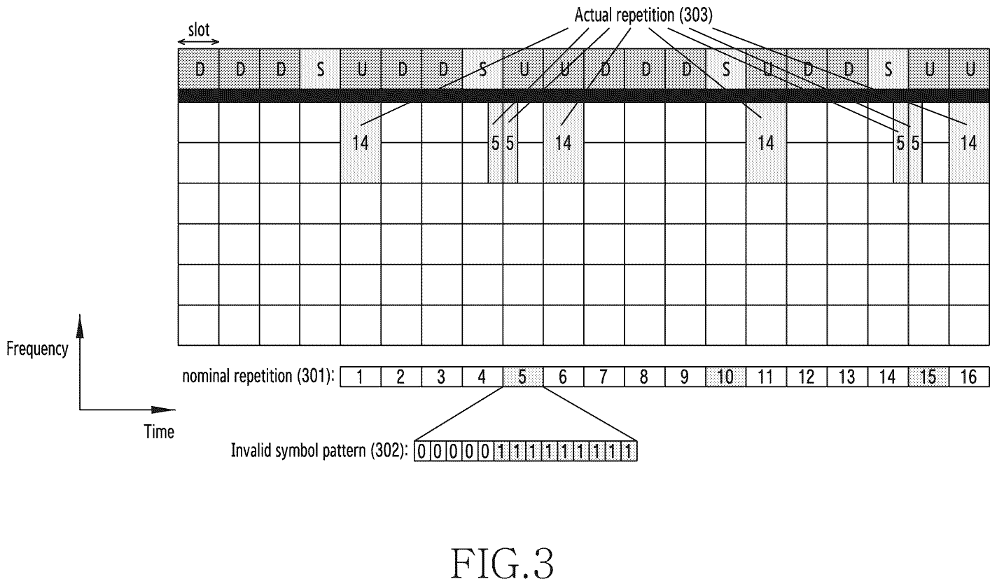

FIG. 3 illustrates an example of a bandwidth part configuration in a wireless communication system according to an embodiment of the disclosure.

The UE may receive the following configurations: the start symbol S of an uplink data channel is 0, the length L of the uplink data channel is 14, and the number of repeated transmissions is 16. In this case, nominal repetitions may appear in 16 consecutive slots. Thereafter, the UE may determine that the symbol configured as a downlink symbol in each nominal repetition 301 is an invalid symbol. The UE determines that symbols configured as 1 in the invalid symbol pattern 302 are invalid symbols. If valid symbols other than invalid symbols in respective nominal repetitions constitute one or more consecutive symbols in one slot, they are configured and transmitted as actual repetitions (303).

In addition, with regard to PUSCH repeated transmission, additional methods may be defined in NR Release 16 with regard to UL grant-based PUSCH transmission and configured grant-based PUSCH transmission, across slot boundaries, as follows:
Method 1 (mini-slot level repetition): through one UL grant, two or more PUSCH repetition transmissions are scheduled inside one slot or across the boundary of consecutive slots. In connection with method 1, time domain resource allocation information inside DCI indicates resources of the first repetition transmission. In addition, time domain resource information of remaining repetition transmissions may be determined according to time domain resource information of the first repetition transmission, and the uplink or downlink direction determined with regard to each symbol of each slot. Each repetition transmission occupies consecutive symbols.
Method 2 (multi-segment transmission): through one UL grant, two or more PUSCH repetition transmissions are scheduled in consecutive slots. Transmission no. 1 is designated for each slot, and the start point or repetition length differs between respective transmissions. In method 2, time domain resource allocation information inside DCI indicates the start point and repetition length of all repetition transmissions. In the case of performing repetition transmissions inside a single slot through method 2, if there are multiple bundles of consecutive uplink symbols in the corresponding slot, respective repetition transmissions may be performed with regard to respective uplink symbol bundles. If there is only a single bundle of consecutive uplink symbols in the corresponding slot, PUSCH repetition transmission is performed once according to the method of NR Release 15.
Method 3: two or more PUSCH repetition transmissions are scheduled in consecutive slots through two or more UL grants. Transmission no. 1 may be designated with regard to each slot, and the n^{th} UL grant may be received before PUSCH transmission scheduled by the (n−1)th UL grant is over.
Method 4: through one UL grant or one configured grant, one or multiple PUSCH repetition transmissions inside a single slot, or two or more PUSCH repetition transmissions across the boundary of consecutive slots may be supported. The number of repetitions indicated to the UE by the base station is only a nominal value, and the UE may actually perform a larger number of PUSCH repetition transmissions than the nominal number of repetitions. Time domain resource allocation information inside DCI or configured grant refers to resources of the first repetition transmission indicated by the base station. In an embodiment, time domain resource information of remaining repetition transmissions may be determined with reference to resource information of the first repetition transmission and the uplink or downlink direction of symbols. If time domain resource information of repetition transmission indicated by the base station spans a slot boundary or includes an uplink/downlink switching point, the corresponding repetition transmission may be divided into multiple repeated transmissions. One repetition transmission may be included in one slot with regard to each uplink period.

### [PUSCH: Frequency Hopping Process]

Hereinafter, frequency hopping of a physical uplink shared channel (PUSCH) in a 5G system will be described in detail.

5G supports two kinds of PUSCH frequency hopping methods with regard to each PUSCH repeated transmission type. First of all, in PUSCH repeated transmission type A, intra-slot frequency hopping and inter-slot frequency hopping are supported, and in PUSCH repeated transmission type B, inter-repetition frequency hopping and inter-slot frequency hopping are supported.

The intra-slot frequency hopping method supported in PUSCH repetition type A transmission may include a method in which a UE transmits allocated resources in the frequency domain, after changing the same by a configured frequency offset, by two hops in one slot. The start RB of each hop in connection with intra-slot frequency hopping may be expressed by Equation 3 below:

$${RB}_{start} = \{ \begin{matrix}{RB}_{start} & i = 0 \\ ( {RB}_{start} + {RB}_{offset} ) mod {N}_{BP}^{size} & i = 1\end{matrix} \qquad Equation 3$$

In Equation 3, i=0 and i=1 may denote the first and second hops, respectively, and RBₛₜₐᵣₜ may denote the start RB in a UL BWP and may be calculated from a frequency resource allocation method. RB_{offset} denotes a frequency offset between two hops through an upper layer parameter. The number of symbols of the first hop may be represented by

$$⌊ {N}_{symb}^{PUSCH , s} / 2 ⌋ ,$$

and number of symbols of the second hop may be represented by

$${N}_{symb}^{PUSCH , s} - ⌊ {N}_{symb}^{PUSCH , s} / 2 ⌋ .$$

$${N}_{symb}^{PUSCH , s}$$

is the length of PUSCH transmission in one slot and is expressed by the number of OFDM symbols.

Next, the inter-slot frequency hopping method supported in PUSCH repetition type A and type B transmissions is a method in which the UE transmits allocated resources in the frequency domain, after changing the same by a configured frequency offset, in each slot. The start RB during slot

$${n}_{s}^{μ}$$

in connection with inter-slot frequency hopping may be expressed by Equation 4 below.

$$R {B}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BP}^{siz} & {n}_{s}^{μ} mod 2 = 1\end{matrix} \qquad Equation 4$$

In Equation 4,

$${n}_{s}^{μ}$$

denotes the current slot number during multi-slot PUSCH transmission, and RBₛₜₐᵣₜ denotes the start RB inside a UL BWP and is calculated from a frequency resource allocation method. RB_{offset} denotes a frequency offset between two hops through an upper layer parameter.

Next, the inter-repetition frequency hopping method supported in PUSCH repetition type B transmission is a method in which resources allocated in the frequency domain regarding one or multiple actual repetitions in each nominal repetition are moved by a configured frequency offset and then transmitted. The index RBₛₜₐᵣₜ₍ₙ₎ of the start RB in the frequency domain regarding one or multiple actual repetitions in the n^{th} nominal repetition may follow Equation 5 given below.

$$R {B}_{start} ( n ) = \{ \begin{matrix}{RB}_{start} & n mod 2 = 0 \\ ( {RB}_{start} + {RB}_{offset} ) mod {N}_{BP}^{size} & n mod 2 = 1\end{matrix} \qquad Equation 5$$

In Equation 5, n denotes the index of nominal repetition, and RB_{offset} denotes an RB offset between two hops through an upper layer parameter.

### [PUSCH: Multiplexing Rules During AP/SP CSI Reporting]

Hereinafter, a method of measuring and reporting a channel state in the 5G communication system will be described in detail. Channel state information (CSI) may include a channel quality indicator (channel quality information (CQI)), a precoding matrix index (precoding matrix indicator (PMI)), a CSI-RS resource indicator (CRI), an SS/PBCH block resource indicator (SSBRI), a layer indicator (LI), a rank indicator (RI), a reference signal received power (L1-RSRP), and/or the like. A base station may control time and frequency resources for the aforementioned CSI measurement and report of a UE.

For the aforementioned CSI measurement and report, the UE may be configured, via higher-layer signaling, with setting information for N (N≥1) CSI reports (CSI-ReportConfig), setting information for M (M≥1) RS transmission resources (CSI-ResourceConfig), and list information of one or two trigger states (CSI-AperiodicTriggerStateList, CSI-SemiPersistentOnPUSCH-TriggerStateList). The configuration information for CSI measurement and reporting described above may be, more specifically, as described in Table 13 to Table 18 below.

TABLE 13
CSI-ReportConfig
The IE CSI-ReportConfig is used to configure a periodic or semi-persistent report sent
on PUCCH on the cell in which the CSI-ReportConfig is included, or to configure a semi-
persistent or aperiodic report sent on PUSCH triggered by DCI received on the cell in
which the CSI-ReportConfig is included (in this case, the cell on which the report is
sent is determined by the received DCI). See TS 38.214 [19], clause 5.2.1.
CSI-ReportConfig information element

```
  -- ASN1START
  -- TAG-CSI-REPORTCONFIG-START
```

| CSI-ReportConfig ::= | SEQUENCE { | |
|---|---|---|
| reportConfigId | CSI-ReportConfigId, | |
| carrier | ServCellIndex | OPTIONAL, -- Need S |
| resourcesForChannelMeasurement | CSI-ResourceConfigId, | |
| csi-IM-ResourcesForInterference | CSI-ResourceConfigId | OPTIONAL, -- Need R |
| nzp-CSI-RS-ResourcesForInterference | CSI-ResourceConfigId | OPTIONAL, -- Need R |

| | |
|---|---|
| reportConfigType | CHOICE { |
| periodic | SEQUENCE { |
| reportSlotConfig | CSI-ReportPeriodicityAndOffset, |
| pucch-CSI-ResourceList | SEQUENCE (SIZE (1..maxNrofBWPs)) |
| | OF PUCCH-CSI-Resource |

},

| | |
|---|---|
| semiPersistentOnPUCCH | SEQUENCE { |
| reportSlotConfig | CSI-ReportPeriodicityAndOffset, |
| pucch-CSI-ResourceList | SEQUENCE (SIZE (1..maxNrofBWPs)) |
| | OF PUCCH-CSI-Resource |

},

| | |
|---|---|
| semiPersistentOnPUSCH | SEQUENCE { |
| reportSlotConfig | ENUMERATED {sl5, sl10, sl20, sl40, |
| | sl80, sl160, sl320}, |
| reportSlotOffsetList | SEQUENCE (SIZE (1.. maxNrofUL-Allocations)) |
| | OF INTEGER(0..32), |
| p0alpha | P0-PUSCH-AlphaSetId |

},

| | |
|---|---|
| aperiodic | SEQUENCE { |
| reportSlotOffsetList | SEQUENCE (SIZE (1..maxNrofUL-Allocations)) |
| | OF INTEGER(0..32) |

```
      }
    },
```

| | |
|---|---|
| reportQuantity | CHOICE { |
| none | NULL, |
| cri-RI-PMI-CQI | NULL, |
| cri-RI-i1 | NULL, |
| cri-RI-i1-CQI | SEQUENCE { |
| pdsch-BundleSizeForCSI | ENUMERATED {n2, n4} |

```
  OPTIONAL -- Need S
      },
```

| | |
|---|---|
| cri-RI-CQI | NULL, |
| cri-RSRP | NULL, |
| ssb-Index-RSRP | NULL, |
| cri-RI-LI-PMI-CQI | NULL |

},

| | |
|---|---|
| reportFreqConfiguration | SEQUENCE { |
| cqi-FormatIndicator | ENUMERATED { widebandCQI, subbandCQI } |

OPTIONAL, -- Need R

| | |
|---|---|
| pmi-FormatIndicator | ENUMERATED { widebandPMI, subbandPMI } |

OPTIONAL, -- Need R

| | |
|---|---|
| csi-ReportingBand | CHOICE { |
| subbands3 | BIT STRING(SIZE(3)), |
| subbands4 | BIT STRING(SIZE(4)), |
| subbands5 | BIT STRING(SIZE(5)), |
| subbands6 | BIT STRING(SIZE(6)), |
| subbands7 | BIT STRING(SIZE(7)), |
| subbands8 | BIT STRING(SIZE(8)), |
| subbands9 | BIT STRING(SIZE(9)), |
| subbands10 | BIT STRING(SIZE(10)), |
| subbands11 | BIT STRING(SIZE(14)), |
| subbands12 | BIT STRING(SIZE(12)), |
| subbands13 | BIT STRING(SIZE(4)), |
| subbands14 | BIT STRING(SIZE(14)), |
| subbands15 | BIT STRING(SIZE(13)), |
| subbands16 | BIT STRING(SIZE(14)), |
| subbands17 | BIT STRING(SIZE(17)), |
| subbands18 | BIT STRING(SIZE(18)), |

...,

| | |
|---|---|
| subbands19-v1530 | BIT STRING(SIZE(19)) |

} OPTIONAL -- Need S

| | |
|---|---|
| } | OPTIONAL, - |

- Need R

| | |
|---|---|
| timeRestrictionForChannelMeasurements | ENUMERATED {configured, notConfigured} |
| timeRestrictionForInterferenceMeasurements | ENUMERATED {configured, notConfigured} |
| codebookConfig | CodebookConfig |

OPTIONAL, -- Need R

| | | |
|---|---|---|
| dummy | ENUMERATED {n1, n2} | OPTIONAL, |

-- Need R

| | |
|---|---|
| groupBasedBeamReporting | CHOICE { |
| enabled | NULL, |
| disabled | SEQUENCE { |
| nrofReportedRS | ENUMERATED {n1, n2, n3, n4} |

```
  OPTIONAL -- Need S
      }
    },
```

| | |
|---|---|
| cqi-Table | ENUMERATED {table1, table2, table3, spare1} |

OPTIONAL, -- Need R

| | |
|---|---|
| subbandSize | ENUMERATED {value1, value2}, |
| non-PMI-PortIndication | SEQUENCE (SIZE (1..maxNrofNZP-CSI-RS-ResourcesPerConfig)) OF |
| PortIndexFor8Ranks OPTIONAL, | -- Need R |

```
    ...,
    {{
```

| | |
|---|---|
| semiPersistentOnPUSCH-v1530 | SEQUENCE { |
| reportSlotConfig-v1530 | ENUMERATED {sl4, sl8, sl16} |

| | |
|---|---|
| } | OPTIONAL -- |

```
  Need R
    }},
    {{
```

| | |
|---|---|
| semiPersistentOnPUSCH-v1610 | SEQUENCE { |
| reportSlotOffsetListDCI-0-2-r16 | SEQUENCE (SIZE (1.. maxNrofUL-Allocations-r16)) OF INTEGER(0..32) |

OPTIONAL, -- Need R

| | |
|---|---|
| reportSlotOffsetListDCI-0-1-r16 | SEQUENCE (SIZE (1.. maxNrofUL-Allocations-r16)) OF INTEGER(0..32) |

| | |
|---|---|
| OPTIONAL -- Need R | OPTIONAL, - |

```
    }
  - Need R
```

| | |
|---|---|
| aperiodic-v1610 | SEQUENCE { |
| reportSlotOffsetListDCI-0-2-r16 | SEQUENCE (SIZE (1.. maxNrofUL-Allocations-r16)) OF INTEGER(0..32) |

OPTIONAL, -- Need R

| | |
|---|---|
| reportSlotOffsetListDCI-0-1-r16 | SEQUENCE (SIZE (1.. maxNrofUL-Allocations-r16)) OF INTEGER(0..32) |

OPTIONAL -- Need R

| | |
|---|---|
| } | OPTIONAL, - |

- Need R

| | |
|---|---|
| reportQuantity-r16 | CHOICE { |
| cri-SINR-r16 | NULL, |
| ssb-Index-SINR-r16 | NULL |

| | |
|---|---|
| } | OPTIONAL, - |

- Need R

| | |
|---|---|
| codebookConfig-r16 | CodebookConfig-r16 |

```
  OPTIONAL -- Need R
    ]]
  }
```

| | |
|---|---|
| CSI-ReportPeriodicityAndOffset ::= | CHOICE { |
| slots4 | INTEGER(0..3), |
| slots5 | INTEGER(0..4), |
| slots8 | INTEGER(0..7), |
| slots10 | INTEGER(0..9), |
| slots16 | INTEGER(0..15), |
| slots20 | INTEGER(0..19), |
| slots40 | INTEGER(0..39), |
| slots80 | INTEGER(0..79), |
| slots160 | INTEGER(0..159), |
| slots320 | INTEGER(0..319) |

}

| | |
|---|---|
| PUCCH-CSI-Resource ::= | SEQUENCE { |
| uplinkBandwidthPartId | BWP-Id, |
| pucch-Resource | PUCCH-ResourceId |

}

| PortIndexFor8Ranks ::= | CHOICE { | |
|---|---|---|
| portIndex8 | SEQUENCE{ | |
| rank1-8 | PortIndex8 | OPTIONAL, -- |

Need R

| | | |
|---|---|---|
| rank2-8 | SEQUENCE(SIZE(2)) OF PortIndex8 | OPTIONAL, |

-- Need R

| | | |
|---|---|---|
| rank3-8 | SEQUENCE(SIZE(3)) OF PortIndex8 | OPTIONAL, |

-- Need R

| | | |
|---|---|---|
| rank4-8 | SEQUENCE(SIZE(4)) OF PortIndex8 | OPTIONAL, |

-- Need R

| | | |
|---|---|---|
| rank5-8 | SEQUENCE(SIZE(5)) OF PortIndex8 | OPTIONAL, |

-- Need R

| | | |
|---|---|---|
| rank6-8 | SEQUENCE(SIZE(6)) OF PortIndex8 | OPTIONAL, |

-- Need R

| | | |
|---|---|---|
| rank7-8 | SEQUENCE(SIZE(7)) OF PortIndex8 | OPTIONAL, |

-- Need R

| | | |
|---|---|---|
| rank8-8 | SEQUENCE(SIZE(8)) OF PortIndex8 | OPTIONAL |

```
  -- Need R
    },
```

| portIndex4 | SEQUENCE{ | |
|---|---|---|
| rank1-4 | PortIndex4 | OPTIONAL, -- |

Need R

| | | |
|---|---|---|
| rank2-4 | SEQUENCE(SIZE(2)) OF PortIndex4 | OPTIONAL, |

-- Need R

| | | |
|---|---|---|
| rank3-4 | SEQUENCE(SIZE(3)) OF PortIndex4 | OPTIONAL, |

-- Need R

| | | |
|---|---|---|
| rank4-4 | SEQUENCE(SIZE(4)) OF PortIndex4 | OPTIONAL |

```
  -- Need R
    },
```

| portIndex2 | SEQUENCE{ | |
|---|---|---|
| rank1-2 | PortIndex2 | OPTIONAL, -- |

Need R

| | | |
|---|---|---|
| rank2-2 | SEQUENCE(SIZE(2)) OF PortIndex2 | OPTIONAL |

-- Need R
},

| | |
|---|---|
| portIndex1 | NULL |

}

| | |
|---|---|
| PortIndex8::= | INTEGER (0..7) |
| PortIndex4::= | INTEGER (0..3) |
| PortIndex2::= | INTEGER (0..1) |

-- TAG-CSI-REPORTCONFIG-STOP
-- ASN1STOP

CSI-ReportConfig field descriptions

carrier
Indicates in which serving cell the CSI-ResourceConfig indicated below are to be found. If
the field is absent, the resources are on the same serving cell as this report configuration.
codebookConfig
Codebook configuration for Type-1 or Type-2 including codebook subset restriction. Network
does not configure codebookConfig and codebookConfig-r16 simultaneously to a UE
cqi-FormatIndicator
Indicates whether the UE shall report a single (wideband) or multiple (subband) CQI (see
TS 38.214 [19], clause 5.2.1.4).
cqi-Table
Which CQI table to use for CQI calculation (see TS 38.214 [19], clause 5.2.2.1).
csi-IM-ResourcesForInterference
CSI IM resources for interference measurement. csi-ResourceConfigId of a CSI-ResourceConfig
included in the configuration of the serving cell indicated with the field “carrier” above.
The CSI-ResourceConfig indicated here contains only CSI-IM resources. The bwp-Id in that CSI-
ResourceConfig is the same value as the bwp-Id in the CSI-ResourceConfig indicated by
resourcesForChannelMeasurement.
csi-ReportingBand
Indicates a contiguous or non-contiguous subset of subbands in the bandwidth part which CSI
shall be reported for. Each bit in the bit-string represents one subband. The right-most bit
in the bit string represents the lowest subband in the BWP. The choice determines the number
of subbands (subbands3 for 3 subbands, subbands4 for 4 subbands, and so on) (see TS 38.214 [19],
clause 5.2.1.4). This field is absent if there are less than 24 PRBs (no sub band) and present
otherwise, the number of sub bands can be from 3 (24 PRBs, sub band size 8) to 18 (72 PRBs,
sub band size 4).
dummy
This field is not used in the specification. If received it shall be ignored by the UE.
groupBasedBeamReporting
Turning on/off group beam based reporting (see TS 38.214 [19], clause 5.2.1.4).
non-PMI-PortIndication
Port indication for RI/CQI calculation. For each CSI-RS resource in the linked ResourceConfig
for channel measurement, a port indication for each rank R, indicating which R ports to use.
Applicable only for non-PMI feedback (see TS 38.214 [19], clause 5.2.1.4.2).
The first entry in non-PMI-PortIndication corresponds to the NZP-CSI-RS-Resource indicated by
the first entry in nzp-CSI-RS-Resources in the NZP-CSI-RS-ResourceSet indicated in the first
entry of nzp-CSI-RS-ResourceSetList of the CSI-ResourceConfig whose CSI-ResourceConfigId is
indicated in a CSI-MeasId together with the above CSI-ReportConfigId; the second entry in
non-PMI-Portindication corresponds to the NZP-CSI-RS-Resource indicated by the second entry
in nzp-CSI-RS-Resources in the NZP-CSI-RS-ResourceSet indicated in the first entry of
nzp-CSI-RS-ResourceSetList of the same CSI-ResourceConfig, and so on until the NZP-CSI-RS-
Resource indicated by the last entry in nzp-CSI-RS-Resources in the in the NZP-CSI-RS-ResourceSet
indicated in the first entry of nzp-CSI-RS-ResourceSetList of the same CSI-ResourceConfig.
Then the next entry corresponds to the NZP-CSI-RS-Resource indicated by the first entry in
nzp-CSI-RS-Resources in the NZP-CSI-RS-ResourceSet indicated in the second entry of nzp-
CSI-RS-ResourceSetList of the same CSI-ResourceConfig and so on.
nrofReportedRS
The number (N) of measured RS resources to be reported per report setting in a non-group-based
report. N <= N_max, where N_max is either 2 or 4 depending on UE capability.
(see TS 38.214 [19], clause 5.2.1.4) When the field is absent the UE applies the value 1.
nzp-CSI-RS-ResourcesForInterference
NZP CSI RS resources for interference measurement. csi-ResourceConfigid of a CSI-ResourceConfig
included in the configuration of the serving cell indicated with the field “carrier” above. The
CSI-ResourceConfig indicated here contains only NZP-CSI-RS resources. The bwp-Id in that CSI-
ResourceConfig is the same value as the bwp-id in the CSI-ResourceConfig indicated by
resourcesForChannelMeasurement.
p0alpha
Index of the p0-alpha set determining the power control for this CSI report transmission
(see TS 38.214 [19], clause 6.2.1.2).
pdsch-BundleSizeForCSI
PRB bundling size to assume for CQI calculation when reportQuantity is CRI/RI/I1/CQI. If the field
is absent, the UE assumes that no PRB bundling is applied (see TS 38.214 [19], clause 5.2.1.4.2).
pmi-FormatIndicator
Indicates whether the UE shall report a single (wideband) of multiple (subband) PMI.
(see TS 38.214 [19], clause 5.2.1.4).
pucch-CSI-ResourceList
Indicates which PUCCH resource to use for reporting on PUCCH.
reportConfigType
Time domain behavior of reporting configuration.
reportFreqConfiguration
Reporting configuration in the frequency domain. (see TS 38.214 [19], clause 5.2.1.4).
reportQuantity
The CSI related quantities to report. see TS 38.214 [19], clause 5.2.1. If the field reportQuantity-r16
is present, UE shall ignore reportQuantity (without suffix).
reportSlotConfig
Periodicity and slot offset (see TS 38.214 [19], clause 5.2.1.4). If the field reportSlotConfig-v1530
is present, the UE shall ignore the value provided in reportSlotConfg (without suffix).
reportSlotOffsetList, reportSlotOffsetListDCI-0-1, reportSlotOffsetListDCI-0-2
Timing offset Y for semi persistent reporting using PUSCH. This field lists the allowed offset values.
This list must have the same number of entries as the pusch-TimeDomainAllocationList in PUSCH-Config.
A particular value is indicated in DCI. The network indicates in the DCI field of the UL grant, which
of the configured report slot offsets the UE shall apply. The DCI value 0 corresponds to the first
report slot offset in this list, the DCI value 1 corresponds to the second report slot offset in this
list, and so on. The first report is transmitted in slot n + Y, second report in n + Y + P, where P
is the configured periodicity.
Timing offset Y for aperiodic reporting using PUSCH. This field lists the allowed offset values. This
list must have the same number of entries as the pusch-TimeDomainAllocationList in PUSCH-Config. A
particular value is indicated in DCI. The network indicates in the DCI field of the UL grant, which
of the configured report slot offsets the UE shall apply. The DCI value 0 corresponds to the first
report slot offset is this list, the DCI value 1 corresponds to the second report slot offset in this
list, and so on (see TS 38.214 [19], clause 6.1.2.1). The field reportSlotOffsetList applies to DCI
format 0_0, the field reportSlotOffsetListDCI-0-1 applies to DCI formal 0_1 and the field
reportSlotOffsetListDCI-0-2 applies to DCI format 0_2 (see TS 38.214 [19], clause 6.1.2.1).
resourcesForChannelMeasurement
Resources for channel measurement csi-ResourceConfigId of a CSI-ResourceConfig included in the
configuration of the serving cell indicated with the field “carrier” above. The CSI-ResourceConfig
indicated here contains only NZP-CSI-RS resources and/or SSB resources. This CSI-ReportConfig is
associated with the DL BWP indicated by bwp-id in that CSI-ResourceConfig.
subbandSize
Indicates one out of two possible BWP-dependent values for the subband size as indicated in
TS 38.214 [19], table 5.2.1.4-2. If csi-ReportingBand is absent, the UE shall ignore this field.
timeRestrictionForChanneMeasurements
Time domain measurement restriction for the channel (signal) measurements (see TS 38.214 [19], clause 5.2.1.1).
timeRestrictionForInterferenceMeasurements
Time domain measurement restriction for interference measurements (see TS 38.214 [19], clause 5.2.1.1)

TABLE 14
CSI-ResourceConfig
The IE CSI-ResourceConfig defines a group of one or more NZP-CSI-
RS-ResourceSet, CSI-IM-ResourceSet and/or CSI-SSB-ResourceSet.
CSI-ResourceConfig information element

-- ASN1START
-- TAG-CSI-RESOURCECONFIG-START

| | |
|---|---|
| CSI-ResourceConfig ::= | SEQUENCE { |
| csi-ResourceConfigId | CSI-ResourceConfigId, |
| csi-RS-ResourceSetList | CHOICE { |
| nzp-CSI-RS-SSB | SEQUENCE { |
| nzp-CSI-RS-ResourceSetList | SEQUENCE (SIZE (1..maxNrofNZP-CSI-RS- |
| | ResourceSetsPerConfig)) OF NZP- |

CSI-RS-ResourceSetId
OPTIONAL, -- Need R

| | |
|---|---|
| csi-SSB-ResourceSetList | SEQUENCE (SIZE (1..maxNrofCSI-SSB- |
| | ResourceSetsPerConfig)) OF CSI-SSB- |

ResourceSetId OPTIONAL -- Need R
},

| | |
|---|---|
| csi-IM-ResourceSetList | SEQUENCE (SIZE (1..maxNrofCSI-IM- |
| | ResourceSetsPerConfig)) OF CSI-IM- |

ResourceSetId
],

| | |
|---|---|
| bwp-Id | BWP-Id, |
| resourceType | ENUMERATED { aperiodic, semiPersistent, periodic }, |

...
}
-- TAG-CSI-RESOURCECONFIG-STOP
-- ASN1STOP

CSI-ResourceConfig field descriptions

bwp-id
The DL BWP which the CSI-RS associated with this CSI-ResourceConfig
are located in (see TS 38.214 [19], clause 5.2.1.2.
csi-IM-ResourceSetList
List of references to CSI-IM resources used for beam measurement
and reporting in a CSI-RS resource set. Contains up to maxNrofCSI-
IM-ResourceSetsPerConfig resource sets if resourceType is ‘aperiodic’
and 1 otherwise (see TS 38.214 [19], clause 5.2.1.2).
csi-ResourceConfigId
Used in CSI-ReportConfig to refer to an instance of CSI-ResourceConfig.
csi-SSB-ResourceSetList
List of references to SSB resources used for beam measurement and
reporting in a CSI-RS resource set (see TS 38.214 [19], clause 5.2.1.2).
nzp-CSI-RS-ResourceSetList
List of references to NZP CSI-RS resources used for beam measurement
and reporting in a CSI-RS resource set. Contains up to maxNrofNZP-
CSI-RS-ResourceSetsPerConfig resource sets if resourceType is
‘aperiodic’ and 1 otherwise (see TS 38.214 [19], clause 5.2.1.2).
resourceType
Time domain behavior of resource configuration (see TS 38.214 [19],
clause 5.2.1.2). It does not apply to resources provided in the
csi-SSB-ResourceSetList.

TABLE 15
NZP-CSI-RS-ResourceSet
The IE NZP-CSI-RS-ResourceSet is a set of Non-Zero-Power
(NZP) CSI-RS resources (their IDs) and set-specific parameters.
NZP-CSI-RS-ResourceSet information element

-- ASN1START
-- TAG-NZP-CSI-RS-RESOURCESET-START

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI-RS- |
| | ResourcesPerSet)) OF NZP-CSI-RS- |

ResourceId,

| | |
|---|---|
| repetition | ENUMERATED { on, off } |

OPTIONAL, -- Need S

| | |
|---|---|
| aperiodicTriggeringOffset | INTEGER(0..6) |

OPTIONAL, -- Need S

| | |
|---|---|
| trs-Info | ENUMERATED {true} OPTIONAL, |

```
-- Need R
  ...,
  [[
```

| | |
|---|---|
| aperiodicTriggeringOffset-r16 | INTEGER(0..31) |

OPTIONAL -- Need S
]]
}
-- TAG-NZP-CSI-RS-RESOURCESET-STOP
-- ASN1STOP

NZP-CSI-RS-ResourceSet field descriptions

aperiodicTriggeringOffset, aperiodicTriggeringOffset-r16
Offset X between the slot containing the DCI that triggers a set of
aperiodic NZP CSI-RS resources and the slot in which the CSI-RS
resource set is transmitted. For aperiodicTriggeringOffset, the
value 0 corresponds to 0 slots, value 1 corresponds to 1 slot, value
2 corresponds to 2 slots, value 3 corresponds to 3 slots, value 4
corresponds to 4 slots, value 5 corresponds to 16 slots, value 6
corresponds to 24 slots. For aperiodicTriggeringOffset-r16, the value
indicates the number of slots. The network configures only one of the
fields. When neither field is included, the UE applies the value 0.
nzp-CSI-RS-Resources
NZP-CSI-RS-Resources associated with this NZP-CSI-RS resource
set (see TS 38.214 [19], clause 5.2). For CSI, there are at
most 8 NZP CSI RS resources per resource set.
repetition
Indicates whether repetition is on/off. If the field is set to off
or if the field is absent, the UE may not assume that the NZP-CSI-RS
resources within the resource set are transmitted with the same
downlink spatial domain transmission filter (see TS 38.214 [19],
clauses 5.2.2.3.1 and 5.1.6.1.2). It can only be configured for
CSI-RS resource sets which are associated with CSI-ReportConfig
with report of L1 RSRP or “no report”.
trs-Info
Indicates that the antenna port for all NZP-CSI-RS resources
in the CSI-RS resource set is same. If the field is absent or
released the UE applies the value false (see TS 38.214 [19],
clause 5.2.2.3.1).

CSI-SSB-ResourceSet
The IE CSI-SSB-ResourceSet is used to configure one
SS/PBCH block resource set which refers to SS/PBCH
as indicated in ServingCellConfigCommon.
CSI-SSB-ResourceSet information element

| -- ASN1START | |
|---|---|
| -- TAG-CSI-SSB-RESOURCESET-START | |
| CSI-SSB-ResourceSet ::= | SEQUENCE { |
| csi-SSB-ResourceSetId | CSI-SSB-ResourceSetId, |
| csi-SSB-ResourceList | SEQUENCE (SIZE (1..maxNrofCSI-SSB- |
| | ResourcePerSet)) OF SSB-Index, |

...
}
-- TAG-CSI-SSB-RESOURCESET-STOP
-- ASN1STOP

TABLE 16
CSI-IM-ResourceSet
The IE CSI-IM-ResourceSet is used to configure a set
of one or more CSI Interference Management (IM)
resources (their IDs) and set-specific parameters.
CSI-IM-ResourceSet information element

-- ASN1START
-- TAG-CSI-IM-RESOURCESET-START

| | |
|---|---|
| CSI-IK-ResourceSet ::= | SEQUENCE { |
| csi-IM-ResourceSetId | CSI-IM-ResourceSetId, |
| csi-IM-Resources | SEQUENCE (SIZE (1..maxNrofCSI- |
| | IM-ResourcesPerSet)) OF CSI-IM- |

ResourceId,
...
}
-- TAG-CSI-IM-RESOURCESET-STOP
-- ASN1STOP

CSI-IM-ResourceSet field descriptions

csi-IM-Resources
CSI-IM-Resources associated with this CSI-IM-ResourceSet
(see TS 38.214 [19], clause 5.2)

TABLE 17
CSI-AperiodicTriggerStateList
The CSI-AperiodicTriggerStateList IE is used to configure the UE
with a list of aperiodic trigger states. Each codepoint of the DCI
field “CSI request” is associated with one trigger state.
Upon reception of the value associated with a trigger state, the
UE will perform measurement of CSI-RS (reference signals) and
aperiodic reporting on L1 according to all entries in the
associatedReportConfigInfoList for that trigger state.
CSI-AperiodicTriggerStateList information element

```
  -- ASN1START
  -- TAG-CSI-APERIODICTRIGGERSTATELIST-START
```

| | |
|---|---|
| CSI-AperiodicTriggerStateList ::= | SEQUENCE (SIZE (1..maxNrofCSI-AperiodicTriggers)) OF CSI- |

AperiodicTriggerState

| | |
|---|---|
| CSI-AperiodicTriggerState ::= | SEQUENCE { |
| associatedReportConfigInfoList | SEQUENCE (SIZE(1..maxNrofReportConfigPerAperiodicTrigger)) OF CSI- |

```
  AssociatedReportConfigInfo,
    ...
  }
```

| | |
|---|---|
| CSI-AssociatedReportConfigInfo ::= | SEQUENCE { |
| reportConfigId | CSI-ReportConfigId, |
| resourcesForChannel | CHOICE { |
| nzp-CSI-RS | SEQUENCE { |
| resourceSet | INTEGER (1..maxNrofNZP-CSI-RS-ResourceSetsPerConfig), |
| qcl-info | SEQUENCE (SIZE(1..maxNrofAP-CSI-RS-ResourcesPerSet)) OF TCI- |

StateId OPTIONAL -- Cond Aperiodic
},

| | |
|---|---|
| csi-SSB-ResourceSet | INTEGER (1..maxNrofCSI-SSB-ResourceSetsPerConfig) |

},

| | | |
|---|---|---|
| csi-IM-ResourcesForInterference | INTEGER (1..maxNrofCSI-IM-ResourceSetsPerConfig) | OPTIONAL, -- |

Cond CSI-IM-ForInterference

| | | |
|---|---|---|
| nzp-CSI-RS-ResourcesForInterference | INTEGER (1..maxNrofNZP-CSI-RS-ResourceSetsPerConfig) | OPTIONAL, -- |

Cond NZP-CSI-RS-ForInterference
...
}
-- TAG-CSI-APERIODICTRIGGERSTATELIST-STOP
-- ASN1STOP

CSI-AssociatedReportConfigInfo field descriptions

csi-IM-ResourcesForInterference
CSI-IM-ResourceSet for interference measurement. Entry number in csi-IM-ResourceSetList in the
CSI-ResourceConfig indicated by csi-IM-ResourcesForInterference in the CSI-ReportConfig indicated
by reportConfigId above (1 corresponds to the first entry, 2 to the second entry, and so on). The
indicated CSI-IM-ResourceSet should have exactly the same number of resources like the NZP-CSI-
RS-ResourceSet indicated in nzp-CSI-RS-ResourcesforChannel.
csi-SSB-ResourceSet
CSI-SSB-ResourceSet for channel measurements. Entry number in csi-SSB-ResourceSetList in the
CSI-ResourceConfig indicated by resourcesForChannelMeasurement in the CSI-ReportConfig indicated
by reportConfigId above (1 corresponds to the first entry, 2 to the second entry, and so on).
nzp-CSI-RS-ResourcesForInterference
NZP-CSI-RS-ResourceSet for interference measurement. Entry number in nzp-CSI-RS-ResourceSetList
in the CSI-ResourceConfig indicated by nzp-CSI-RS-ResourcesForInterference in the CSI-ReportConfig
indicated by reportConfigId above (1 corresponds to the first entry, 2 to the second entry, and so on)
qcl-info
List of references to TCI-States for providing the QCL source and QCL type for each NZP-CSI-RS-
Resource listed in nzp-CSI-RS-Resources of the NZP-CSI-RS-ResourceSet indicated by nzp-CSI-RS-
ResourcesforChannel. Each TCI-StateId refers to the TCI-State which has this value for tci-StateId
and is defined in tci-StatesToAddModList in the PDSCH-Config included in the BWP-Downlink
corresponding to the serving cell and to the DL BWP to which the resourcesForChannelMeasurement
(in the CSI-ReportConfig indicated by reportConfigId above) belong to. First entry in qcl-info-
forChannel corresponds to first entry in nzp-CSI-RS-Resources of that NZP-CSI-RS-ResourceSet,
second entry in qcl-info-forChannel corresponds to second entry in nzp-CSI-RS-Resources, and
so on (see TS 38.214 [19], clause 5.2.1.5.1)
reportConfigId
The reportConfigId of one of the CSI-ReportConfigToAddMod configured in CSI-MeasConfig
resourceSet
NZP-CSI-RS-ResourceSet for channel measurements. Entry number in nzp-CSI-RS-ResourceSetList in the
CSI-ResourceConfig indicated by resourcesForChannelMeasurement in the CSI-ReportConfig indicated by
reportConfigId above (1 corresponds to the first entry, 2 to thesecond entry, and so on).

| Conditional Presence | Explanation |
|---|---|
| Aperiodic | The field is mandatory present if the NZP-CSI-RS-Resources in the associated |
| | resourceSet have the resourceType aperiodic. The field is absent otherwise. |
| CSI-IM-ForInterference | This field is optional need M if the CSI-ReportConfig identified by reportConfigId |
| | is configured with csi-IM-ResourcesForInterference; otherwise it is absent. |
| NZP-CSI-RS-ForInterference | This field is optional need M if the CSI-ReportConfig identified by reportConfigId |
| | is configured with nzp-CSI-RS-ResourcesForInterference; otherwise it is absent. |

TABLE 18
CSI-SemiPersistentOnPUSCH-TriggerStateList
The CSI-SemiPersistentOnPUSCH-TriggerStateList IE is used
to configure the UE with list of trigger states for semi-
persistent reporting of channel state information on L1.
See also TS 38.214 [19], clause 5.2.
CSI-SemiPersistentOnPUSCH-TriggerStateList information element

-- ASN1START
-- TAG-CSI-SEMIPERSISTENTONPUSCHTRIGGERSTATELIST-START

| | |
|---|---|
| CSI-SemiPersistentOnPUSCH-TriggerStateList ::= | SEQUENCE(SIZE (1..maxNrofSemiPersistentPUSCH-Triggers)) OF |

CSI-SemiPersistentOnPUSCH-TriggerState

| | |
|---|---|
| CSI-SemiPersistentOnPUSCH-TriggerState ::= | SEQUENCE { |
| associatedReportConfigInfo | CSI-ReportConfigId, |

...
}
-- TAG-CSI-SEMIPERSISTENTONPUSCHTRIGGERSTATELIST-STOP
-- ASN1STOP

With regard to the aforementioned CSI report settings (CSI-ReportConfig), each report setting CSI-ReportConfig may be associated with one downlink (DL) bandwidth part identified by a higher-layer parameter bandwidth part identifier (bwp-id) given by CSI resource setting CSI-ResourceConfig associated with the corresponding report setting. As time domain reporting for each report setting CSI-ReportConfig, “aperiodic”, “semi-persistent”, and “periodic” schemes may be supported, and these schemes may be configured for the UE by the base station via a reportConfigType parameter configured from a higher layer. A semi-persistent CSI report method may support a “PUCCH-based semi-persistent (semi-PersistentOnPUCCH)” method and a “PUSCH-based semi-persistent (semi-PersistentOnPUSCH)” method. In the case of the periodic or semi-persistent CSI report method, a PUCCH or PUSCH resource in which CSI is to be transmitted may be configured for the UE by the base station via higher-layer signaling. A periodicity and a slot offset of the PUCCH or PUSCH resource in which CSI is to be transmitted may be given by a numerology of an uplink (UL) bandwidth part configured for CSI report transmission. In the case of the aperiodic CSI report method, a PUSCH resource in which CSI is to be transmitted may be scheduled for the UE by the base station via L1 signaling (aforementioned DCI format 0_1).

With regard to the aforementioned CSI resource settings (CSI-ResourceConfig), each CSI resource setting CSI-ReportConfig may include S (≥1) CSI resource sets (e.g., given via a higher-layer parameter of csi-RS-ResourceSetList). A CSI resource set list may include a non-zero power (NZP) CSI-RS resource set and an SS/PBCH block set or may include a CSI-interference measurement (CSI-IM) resource set. Each CSI resource setting may be positioned in a downlink (DL) bandwidth part identified by higher-layer parameter bwp-id and may be connected to CSI report setting in the same downlink bandwidth part. A time domain operation of a CSI-RS resource in CSI resource setting may be, for example, configured to be one of “aperiodic”, “periodic”, or “semi-persistent” from the higher-layer parameter resourceType. With regard to the periodic or semi-persistent CSI resource setting, the number of CSI-RS resource sets may be limited to S (S=1), and the configured periodicity and slot offset may be given based on numerology of the downlink bandwidth part identified by bwp-id. One or more CSI resource settings for channel or interference measurement may be configured for the UE by the base station via higher-layer signaling, and may include, for example, the following CSI resources.
CSI-IM resource for interference measurement
NZP CSI-RS resource for interference measurement
NZP CSI-RS resource for channel measurement

With regard to CSI-RS resource sets associated with a resource setting in which the higher-layer parameter of resourceType is configured to be “aperiodic”, “periodic”, or “semi-persistent”, a trigger state of CSI report setting having reportType configured to be “aperiodic”, and a resource setting for channel or interference measurement on one or multiple component cells (CCs) may be configured via the higher-layer parameter of CSI-AperiodicTriggerStateList.

Aperiodic CSI reporting of the UE may be performed using a PUSCH, periodic CSI reporting may be performed using a PUCCH, and semi-persistent CSI reporting may be performed using a PUSCH when triggered or activated via DCI, and may be performed using a PUCCH after activated via a MAC control element (MAC CE). As described above, CSI resource setting may also be configured to be aperiodic, periodic, or semi-persistent. A combination of CSI reporting setting and CSI resource setting may be supported based on Table 19 below.

TABLE 19
Table 5.2.1.4-1: Triggering/Activation of CSI Reporting
for the possible CSI-RS Configurations.

| CSI-RS | Periodic CSI | | |
|---|---|---|---|
| Configuration | Reporting | Semi-Persistent CSI Reporting | Aperiodic CSI Reporting |
| Periodic | No dynamic | For reporting on PUCCH, | Triggered by DCI; |
| CSI-RS | triggering/ | the UE receives an | additionally, activation |
| | activation | activation command [10, TS | command [10, TS 38.321] |
| | | 38.321]; for reporting on | possible as defined in |
| | | PUSCH, the UE receives | Subclause 5.2.1.5.1. |
| | | triggering on DCI | |
| Semi-Persistent | Not Supported | For reporting on PUCCH, | Triggered by DCI; |
| CSI-RS | | the UE receives an | additionally, activation |
| | | activation command [10, TS | command [10, TS 38.321] |
| | | 38.321]; for reporting on | possible as defined in |
| | | PUSCH, the UE receives | Subclause 5.2.1.5.1. |
| | | triggering on DCI | |
| Aperiodic | Not Supported | Not Supported | Triggered by DCI; |
| CSI-RS | | | additionally, activation |
| | | | command [10, TS 38.321] |
| | | | possible as defined in |
| | | | Subclause 5.2.1.5.1. |

Aperiodic CSI reporting may be triggered by a “CSI request” field in DCI format 0_1 described above, which corresponds to scheduling DCI for a PUSCH. The UE may monitor a PDCCH, may acquire DCI format 0_1, and may acquire scheduling information of a PUSCH and a CSI request indicator. The CSI request indicator may be configured to have NTS (=0, 1, 2, 3, 4, 5, or 6) bits, and may be determined by higher-layer signaling (reportTriggerSize). One trigger state among one or multiple aperiodic CSI report trigger states which may be configured via higher-layer signaling (CSI-AperiodicTriggerStateList) may be triggered by the CSI request indicator.
If all bits in the CSI request field are 0, this may indicate that CSI reporting is not requested.
If the number M of configured CSI trigger states in CSI-AperiodicTriggerStateLite is greater than 2NTs−1, M CSI trigger states may be mapped to 2NTs−1 trigger states according to a predefined mapping relation, and one trigger state among the 2NTs−1 trigger states may be indicated by the CSI request field.
If the number M of configured CSI trigger states in CSI-AperiodicTriggerStateLite is less than or equal to 2NTs−1, one of the M CSI trigger states may be indicated by the CSI request field.

Table 20 below shows an example of a relationship between a CSI request indicator and a CSI trigger state that may be indicated by a corresponding indicator.

TABLE 20

| CSI request field | CSI trigger state | CSI-ReportConfigId | CSI-ResourceConfigId |
|---|---|---|---|
| 00 | no CSI request | N/A | N/A |
| 01 | CSI trigger state#1 | CSI report#1 | CSI resource#1, |
| | | CSI report#2 | CSI resource#2 |
| 10 | CSI trigger state#2 | CSI report#3 | CSI resource#3 |
| 11 | CSI trigger state#3 | CSI report#4 | CSI resource#4 |

The UE may measure a CSI resource in a CSI trigger state triggered via the CSI request field, and then generate CSI (including, for example, at least one of the CQI, PMI, CRI, SSBRI, LI, RI, or L1-RSRP described above) based on the measurement. The UE may transmit the acquired CSI by using the PUSCH scheduled via corresponding DCI format 0_1. If one bit corresponding to an uplink data indicator (UL-SCH indicator) in DCI format 0_1 indicates “1”, the UE may multiplex uplink data (UL-SCH) and the acquired CSI on the PUSCH resource scheduled by DCI format 0_1 so as to transmit the same. If one bit corresponding to the uplink data indicator (UL-SCH indicator) in DCI format 0_1 indicates “0”, the UE may map only CSI, without uplink data (UL-SCH), to the PUSCH resource scheduled by DCI format 0_1 so as to transmit the same.

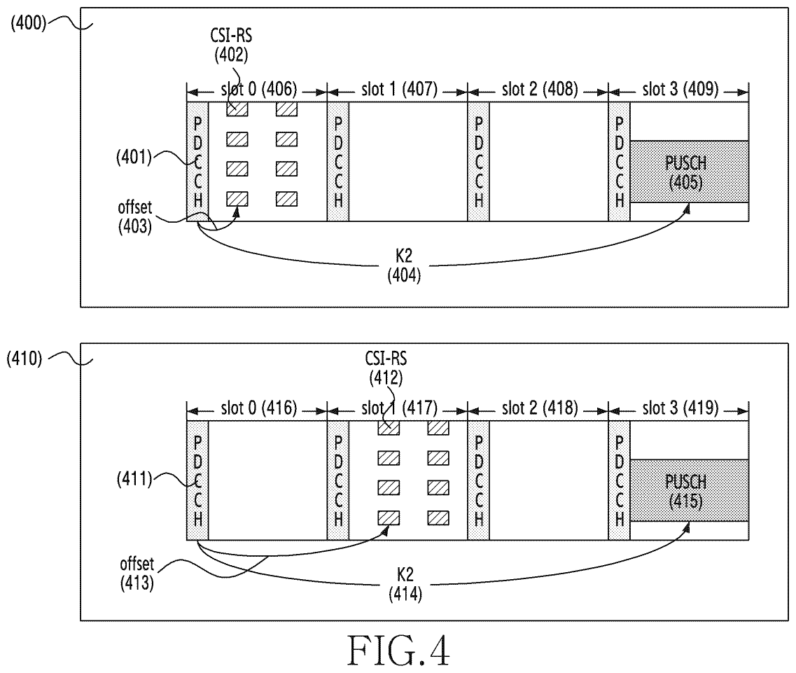

FIG. 4 illustrates an example of an aperiodic CSI reporting method according to an embodiment of the disclosure.

In an example 400 of FIG. 4, the UE may acquire DCI format 0_1 by monitoring a PDCCH 401, and may acquire scheduling information and CSI request information for a PUSCH 405 therefrom. The UE may acquire resource information of a CSI-RS 402 to be measured, from a received CSI request indicator. The UE may determine a time point at which the UE needs to measure a resource of the CSI-RS 402, based on a time point at which DCI format 0_1 is received, and a parameter for an offset (e.g., aforementioned aperiodicTriggeringOffset) in a CSI resource set configuration (e.g., an NZP CSI-RS resource set configuration (NZP-CSI-RS-ResourceSet)). More specifically, the UE may be configured with an offset value X of the parameter, aperiodicTriggeringOffset, in the NZP-CSI-RS resource set configuration from a base station via higher-layer signaling, and the configured offset value X may refer to an offset between a slot in which DCI triggering aperiodic CSI reporting is received, and a slot in which the CSI-RS resource is transmitted. For example, aperiodicTriggeringOffset parameter values and offset values X may have mapping relationships as shown in Table 21 below.

TABLE 21

| aperiodicTriggeringOffset | Offset X | |
|---|---|---|
| 0 | 0 | slot |
| 1 | 1 | slot |
| 2 | 2 | slots |
| 3 | 3 | slots |
| 4 | 4 | slots |
| 5 | 16 | slots |
| 6 | 24 | slots |

An example 400 of FIG. 4 shows an example in which aforementioned offset value X 403 is configured to be 0 (X=0). In this case, the UE may receive the CSI-RS 402 in a slot (corresponding to slot 0 406 of FIG. 4) in which DCI format 0_1 triggering aperiodic CSI reporting is received, and may report CSI information, which is measured based on the received CSI-RS, to the base station via the PUSCH 405. The UE may acquire, from DCI format 0_1, scheduling information (information corresponding to each field of DCI format 0_1 described above) on the PUSCH 405 for CSI reporting. For example, in DCI format 0_1, the UE may acquire information on a slot in which the PUSCH 405 is to be transmitted, from time domain resource allocation information for the PUSCH 405 described above. In the example 400 of FIG. 4, the UE acquires 3 as a K2 value 404 corresponding to a slot offset value 403 for PDCCH-to-PUSCH, and accordingly, the PUSCH 405 may be transmitted in slot 3 409, which is spaced 3 slots apart from slot 0 406, i.e., a time point at which the PDCCH 401 has been received.

In an example 410 of FIG. 4, the UE may acquire DCI format 0_1 by monitoring a PDCCH 411, and may acquire scheduling information and CSI request information for a PUSCH 415 therefrom. The UE may acquire resource information of a CSI-RS 412 to be measured, from a received CSI request indicator. The example 410 of FIG. 4 shows an example in which the offset value X 413 for CSI-RS described above is configured to be 1 (X=1). In this case, the UE may receive the CSI-RS 412 in a slot (corresponding to slot 1 417 of FIG. 4) in which DCI format 0_1 triggering aperiodic CSI reporting is received. In the example 410 of FIG. 4, the UE acquires a K2 value 414 corresponding to a slot offset value 413 for PDCCH-to-PUSCH. In this case, the UE may receive the CSI-RS 412 in a slot (corresponding to slot 0 416 of FIG. 4) in which DCI format 0_1 triggering aperiodic CSI reporting is received, and may report CSI information, which is measured based on the received CSI-RS, to the base station via the PUSCH 415.

The aperiodic CSI report may include at least one of or both CSI part 1 and CSI part 2, and when the aperiodic CSI report is transmitted via the PUSCH, the aperiodic CSI report may be multiplexed on a transport block. After a CRC is inserted into an input bit of aperiodic CSI for multiplexing, encoding and rate matching may be performed, and then transmission may be performed by mapping to resource elements within the PUSCH in a specific pattern. The CRC insertion may be omitted depending on a coding method or a length of the input bit. The number of modulation symbols, which is calculated for rate matching during multiplexing of CSI part 1 or CSI part 2 included in the aperiodic CSI report, may be calculated as shown in Table 22.

```
TABLE 22
For CSI part 1 transmission on PUSCH not using repetition type B with UL-SCH, the number of coded
modulation symbols per layer for CSI part 1 transmission, denoted as Q_{CSI-part1}′ is determined as follows:
[Equation 6]
${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ \cdot \\ ⌈ α \cdot {\sum }_{l = o}^{{N}_{symb , all}^{PUSCH} - 1} {M}_{sc}^{UCI} ( l ) ⌉ - {Q}_{ACK / CG - UCI}^{′} \}$
. . .
For CSI part 1 transmission on an actual repetition of a PUSCH with repetition Type B with UL-SCH,
the number of coded modulation symbols per layer for CSI part 1 transmission, denoted as Q_{CSI-part1}′, is
determined as follows:
[Equation 7]
  ${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , \\ ⌈ α \cdot {{\sum }_{l = 0}}^{{N}_{symb , nominal}^{PUSCH} - 1} {M}_{sc , nominal}^{UCI} ( l ) ⌉ - \\ {Q}_{ACK / CG - UCI}^{′} \cdot {{\sum }_{l = 0}}^{{N}_{symb , actual}^{PUSCH} - 1} {M}_{sc , actual}^{UCI} ( l ) - {Q}_{ACK / CG - UCI}^{′} \}$
. . .
For CSI part 1 transmission on PUSCH without UL-SCH, the number of coded modulation symbols per
layer for CSI part 1 transmission, denoted as Q_{CSI-part1}′, is determined as follows:
if there is CSI part 2 to be transmitted on the PUSCH.
[Equation 8]
  ${Q}_{CSI - 1}^{′} = min \{ ⌈ \frac{( {O}_{CSI - 1} + {L}_{CSI - 1} ) \cdot {β}_{offset}^{PUSCH}}{R \cdot {Q}_{m}} ⌉ \cdot \text{?} {M}_{sc}^{UCI} ( l ) - {Q}_{ACK}^{′} \}$
else
    ${Q}_{CSI - 1}^{′} = {\sum }_{\text{?}}^{\text{?}} {M}_{sc}^{UCI} ( l ) - {Q}_{ACK}^{′}$
end if
. . .
For CSI part 2 transmission on PUSCH not using repetition type B with UL-SCH, the number of coded
modulation symbols per layer for CSI part 2 transmission, denoted as Q_{CSI-part2}′, is determined as follows:
[Equation 9]
${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , {all}^{- 1}}^{PUSCH}} {M}_{sc}^{UCI} ( l )}{{\sum }_{r = 0}^{{C}_{UL - SCH} - 1} {K}_{r}} ⌉ , ⌈ α \cdot {\sum }_{l = 0}^{{N}_{symb , {all}^{- 1}}^{PUSCH}} {M}_{sc}^{UCI} ( l ) ⌉ - {Q}_{ACK / CG - UCI}^{′} - {Q}_{CSI - 1}^{′} \}$
For CSI part 2 transmission on an actual repetition of a PUSCH with repetition Type B with UL-SCH,
the number of coded modulation symbols per layer for CSI part 2 transmission, denoted as Q_{CSI-part2}′, is
determined as follows:
[Equation 10]
  ${Q}_{CSI - 2}^{′} = min \{ ⌈ \frac{{O}_{CSI - 2} + {L}_{CSI - 2} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , ⌈ α \cdot {\sum }_{l = 0}^{{N}_{symb , nominal}^{PUSCH} - 1} {M}_{sc , nominal}^{UCI} ( l ) ⌉ - {Q}_{ACK / CG - UCI}^{′} - {Q}_{CSI - 1}^{′} \cdot {\sum }_{l = 0}^{{N}_{symb , actual}^{PUSCH} - 1} {M}_{sc , actual}^{UCI} ( l ) - {Q}_{ACK / CG - UCI}^{′} - {Q}_{CSI - 1}^{′} \}$
. . .
For CSI part 2 transmission on PUSCH without UL-SCH, the number of coded modulation symbols per
layer for CSI part 2 transmission, denoted as Q_{CSI-part2}′, is determined as follows:
[Equation 11]
    ${Q}_{CSI - 2}^{′} = {\sum }_{\text{?}}^{\text{?}} {M}_{sc}^{UCI} ( l ) - {Q}_{ACK}^{′} - {Q}_{CSI - 1}^{′}$
```

Specifically, for repeated PUSCH transmission schemes A and B, the UE may multiplex the aperiodic CSI report only on the first repetition transmission among PUSCH repetition transmissions, so as to transmit the same. This is because aperiodic CSI report information to be multiplexed is encoded in a polar code scheme, and at this time, each PUSCH repetition needs to have the same frequency and time resource allocation in order to multiplex the aperiodic CSI report information on multiple PUSCH repetitions. Particularly, in the case of PUSCH repetition type B transmission, since each actual repetition may have different OFDM symbol durations, the aperiodic CSI report may be multiplexed only on the first repetition and then transmitted.

In addition, for repeated PUSCH transmission scheme B, when the UE receives DCI for activation of semi-persistent CSI reporting or scheduling of aperiodic CSI reporting without scheduling for a transport block, the UE may assume that a value of nominal repetition is 1 even if the number of repeated PUSCH transmissions, which is configured via higher-layer signaling, is greater than 1. When the aperiodic or semi-persistent CSI reporting is scheduled or activated without scheduling for a transport block, based on repeated PUSCH transmission scheme B, the UE may expect that a first nominal repetition is identical to a first actual repetition. With regard to the PUSCH transmitted while including semi-persistent CSI, based on repeated PUSCH transmission scheme B, without scheduling for DCI after the semi-persistent CSI reporting has been activated via the DCI, if the first nominal repetition is different from the first actual repetition, transmission for the first nominal repetition may be ignored.

### [PUCCH: UCI on PUSCH]

In the NR communication system, when an uplink control channel overlaps with an uplink data channel and satisfies a transmission time condition, or when L1 signaling or higher-layer signaling indicates transmission of uplink control information on the uplink data channel, the uplink control information may be included in the uplink data channel so as to be transmitted. In this case, a total of three pieces of uplink control information, i.e., HARQ-ACK, CSI part 1, and CSI part 2, may be transmitted on the uplink data channel, and each piece of the uplink control information may be mapped to the PUSCH according to a predetermined multiplexing rule.

Specifically, in a first step, if the number of HARQ-ACK information bits required to be included in the PUSCH is 2 bits or less, the UE may reserve an RE for transmitting HARQ-ACK in advance. A method of determining a resource to be reserved is the same as in a second step. However, the number and positions of REs to be reserved are determined on the assumption that the number of HARQ-ACK bits is 2. That is, in Equation 12, calculation is performed based on O_{ACK}=2. In the second step, if the number of HARQ-ACK information bits to be transmitted by the UE is more than 2 bits, the UE may map HARQ-ACK starting from a first OFDM symbol including no DMRS after a first DMRS symbol. In a third step, the UE may map CSI part 1 to the PUSCH. In this case, CSI part I may be mapped starting from a first OFDM symbol other than DMRS, and may not be mapped to the RE reserved in the first step and the RE to which the HARQ-ACK has been mapped in the second step.

In a fourth step, the UE may map CSI part 2 to the PUSCH. In this case, CSI part 2 may be mapped starting from a first OFDM symbol other than DMRS, and CSI part 2 may not be mapped to the RE where CSI part 1 is located and the RE where the HARQ-ACK mapped to the RE in the second step is located. However, CSI part 2 may be mapped to the RE reserved in the first step. When a UL-SCH exists, the UE may map the UL-SCH to the PUSCH. In this case, the UL-SCH may be mapped from a first OFDM symbol other than DMRS, and may not be mapped to the RE where CSI part 1 is located, the RE where the HARQ-ACK mapped to the RE in the second step is located, and the RE where CSI part 2 is located. However, CSI part 2 may be mapped to the RE reserved in the first step.

In a fifth step, if the HARQ-ACK has a size of 2 bits or less, the UE may puncture the HARQ-ACK and map the same to the RE reserved in the first step. The number of REs to which the HARQ-ACK is mapped is calculated based on an actual number of HARQ-ACKs. That is, the number of REs to which the HARQ-ACK is actually mapped may be less than the number of REs reserved in the first step. The puncturing refers to that, even if the CSI part 2 or UL-SCH has been mapped, in the fourth operation, to an RE to which the HARQ-ACK needs to be mapped, the ACK is mapped instead of the already mapped CSI part 2 or UL-SCH. CSI part I may not be mapped to the reserved RE, so that puncturing due to the HARQ-ACK may not occur. This may indicate that CSI part I has a higher priority and is intended to be better decoded than CSI part 2. If the number of bits (or the number of modulated symbols) of the uplink control information to be mapped to the PUSCH exceeds the number of bits (or REs) available for uplink control information mapping within the corresponding OFDM symbol to be mapped, frequency axis RE interval d between modulated symbols of the uplink control information to be mapped may be configured so that d=1. If the number of bits (or the number of modulated symbols) of the uplink control information to be mapped to the PUSCH is less than the number of bits (or REs) available for uplink control information mapping within the corresponding OFDM symbol to be mapped, frequency axis RE interval d between modulated symbols of the uplink control information to be mapped may be configured so that d=floor (# of available bits on 1−OFDM symbol/# of unmapped UCI bits at the beginning of 1−OFDM symbol).

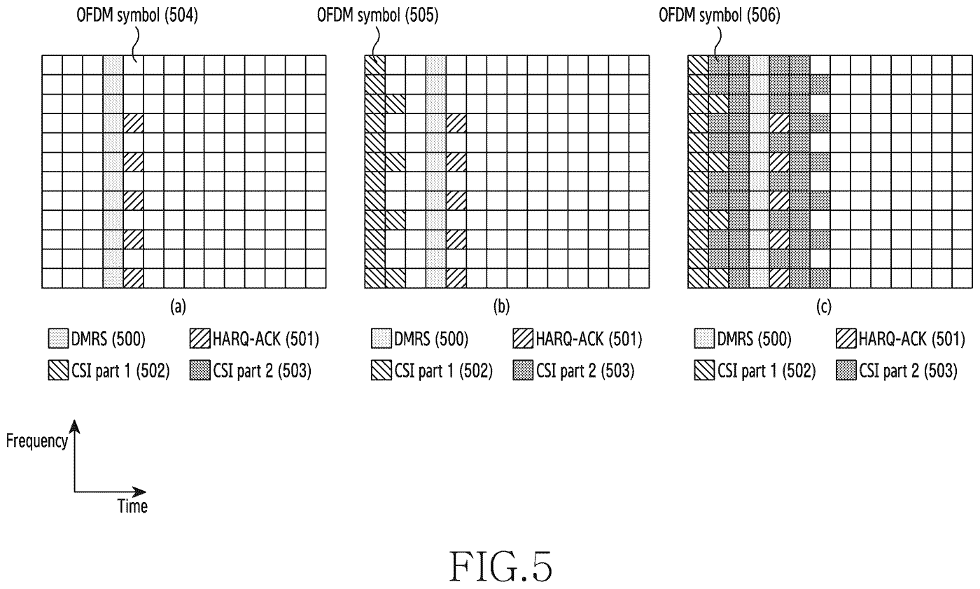

FIG. 5 shows an example of mapping uplink control information to a PUSCH according to an embodiment of the disclosure.

In FIG. 5, it is assumed that the number of HARQ-ACK symbols to be mapped to a PUSCH is 5, and a single resource block is configured or scheduled for the PUSCH. First, as shown in part (a) of FIG. 5, a UE may map HARQ-ACK 501 having 5 symbols, at intervals of d=floor (12/5)=2 on the frequency axis, starting from a lowest RE index (or a highest RE index) of a first OFDM symbol 504 that includes no DMRS after a first DMRS 500. Subsequently, as shown in part (b) of FIG. 5, the UE may perform CSI-part1 502 mapping starting from a first OFDM symbol 505 other than DMRS 500. Finally, as shown in part (c) of FIG. 5, the UE may map CSI part 2 503 to an RE, to which CSI-part1 and HARQ-ACK are not mapped, starting from a first OFDM symbol 506 including no DMRS.

When HARQ-ACK is transmitted on a PUSCH (or CG-PUSCH), the number of coded modulation symbols may be determined by Equation 12 below.

$${Q}_{ACK}^{′} = min \{ ⌈ \frac{{O}_{ACK} + {L}_{ACK} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot {{\sum }_{l = {l}_{0}}}^{{N}_{symb , all}^{PUSCH} - 1} {M}_{sc}^{UCI} ( l ) ⌉ \} \qquad Equation 12$$

Here, O_{ACK} denotes the number of bits of a payload of HARQ-ACK, and L_{ACK} denotes the number of CRC bits. More specifically, O_{ACK}≥360, L_{ACK}=11; otherwise, 360>O_{ACK}≥20, L_{ACK}=11; 20>O_{ACK}≥12, L_{ACK}=6; and 12>O_{ACK}, L_{ACK}=0. Kr is an r-th code block size of a UL-SCH, and

$${M}_{SC}^{UCI}$$

represents the number of subcarriers per OFDM symbol available for UCI transmission in a PUSCH configured or scheduled by a base station. In addition, α and

$${β}_{offset}^{PUSCH}$$

are values configured by the base station and are determined via higher-layer signaling or L1 signaling. More specifically,

$${β}_{offset}^{PUSCH} ,$$

i.e., a beta offset value, is a value defined to determine the number of resources when HARQ-ACK information is multiplexed with other UCI information and transmitted to the PUSCH (or CG-PUSCH). If fallback DCI (or DCI format 0_0) or non-fallback DCI (or DCI format 0_1) that has no beta_offset indicator field indicates PUSCH transmission, and the UE configures a beta offset value configuration to be “semi-static” via higher configuration, the UE may have one beta offset value configured via the higher configuration. In this case, beta offsets may have values as shown in Table 23, an index of a corresponding value may be indicated via higher configuration, and according to the number of bits of HARQ-ACK information, indexes

$${I}_{offset , 0}^{HARQ - ACK} , {I}_{offset , 1}^{HARQ - ACK} , and {I}_{offset , 2}^{HARQ - ACK}$$

may have beta offset values for a case where the number of HARQ-ACK information bits is 2 or less, a case where the number of HARQ-ACK information bits is greater than 2 and equal to or less than 11, and a case where the number of HARQ-ACK information bits is greater than 11, respectively. In addition, it is also possible to configure beta offset values for CSI-part1 and CSI-part2 in the same way. A code rate of UCI may be adjusted compared to an effective code rate of a UL-SCH by the beta offset value. That is, when the beta offset value is 2 (index=1), the code rate of UCI may be configured to be transmitted at a code rate that is lower than the effective code rate of UL-SCH by 1/2.

TABLE 23

| ${I}_{offset , 0}^{H ARQ - ACK}$ | |
|---|---|
| or | |
| ${I}_{offset , 1}^{HARQ - ACK}$ | |
| or | |
| ${I}_{offset , 2}^{H ARQ - ACK}$ | ${β}_{offset}^{HARQ - ACK}$ |
| 0 | 1.000 |
| 1 | 2.000 |
| 2 | 2.500 |
| 3 | 3.125 |
| 4 | 4.000 |
| 5 | 5.000 |
| 6 | 6.250 |
| 7 | 8.000 |
| 8 | 10.000 |
| 9 | 12.625 |
| 10 | 15.875 |
| 11 | 20.000 |
| 12 | 31.000 |
| 13 | 50.000 |
| 14 | 80.000 |
| 15 | 126.000 |
| 16 | Reserved |
| 17 | Reserved |
| 18 | Reserved |
| 19 | Reserved |
| 20 | Reserved |
| 21 | Reserved |
| 22 | Reserved |
| 23 | Reserved |
| 24 | Reserved |
| 25 | Reserved |
| 26 | Reserved |
| 27 | Reserved |
| 28 | Reserved |
| 29 | Reserved |
| 30 | Reserved |
| 31 | Reserved |

If the base station schedules PUSCH transmission for the UE by using non-fallback DCI (or DCI format 0_1), and the non-fallback DCI has a beta offset indicator field, that is, if the beta offset value is configured to be “dynamic” via higher configuration, the base station may configure, for the UE, beta offset values for four sets having

$${I}_{offset , 0}^{HARQ - ACK} , {I}_{offset , 1}^{HARQ - ACK} , or {I}_{offset , 2}^{HARQ - ACK}$$

in the case of the HARQ-ACK, as shown in Table 24, and the UE may use the beta offset indicator field to indicate beta offset values to be used at HARQ-ACK multiplexing, and each index is determined according to the number of HARQ-ACK information bits, as in the method described above. Sets of

$${I}_{offset}^{CSI - 1} and {I}_{offset}^{CSI - 2}$$

may also be indicated in the same way.

TABLE 24

| | $( {I}_{offset , 0}^{HARQ - ACK}$ |
|---|---|
| | or |
| | ${I}_{offset , 1}^{HARQ - ACK}$ |
| | or |
| | ${I}_{offset , 2}^{HARQ - ACK} ) ,$ $( {I}_{offset , 0}^{CSI - 1}$ |
| | or |
| | ${I}_{offset , 0}^{CSI - 2} ) ,$ $( {I}_{offset , 1}^{CSI - 1}$ |
| beta_offset | or |
| indicator | ${I}_{offset , 1}^{CSI - 2} )$ |
| ‘00’ | 1^{st} offset index provided by higher layers |
| ‘01’ | 2^{nd} offset index provided by higher layers |
| ‘10’ | 3^{rd} offset index provided by higher layers |
| ‘11’ | 4^{th} offset index provided by higher layers |

For HARQ-ACK transmission on an actual repetition of a PUSCH with repetition Type B with UL-SCH, the number of coded modulation symbols per layer for HARQ-ACK transmission, denoted as Q′_{ACK}, is determined as follows:

$${Q}_{ACK}^{′} = min \{ ⌈ \frac{{O}_{ACK} + {L}_{ACK} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , ⌈ α \cdot {{\sum }_{l = 0}}^{{N}_{symb , nominal}^{PUSCH} - 1} {M}_{sc , nominal}^{UCI} ( l ) ⌉ , {{\sum }_{l = 0}}^{{N}_{symb , nominal}^{PUSCH} - 1} {M}_{sc , nominal}^{UCI} ( l ) \} \qquad Equation 12 - A$$

Where,

$$- {M}_{sc , nominal}^{UCI} ( l )$$

is the number of resource elements that can be used for transmission of UCI in OFDM symbol l, for l=0, 1, 2, . . . ,

$${N}_{symb , nominal}^{PUSCH} - 1 ,$$

in the PUSCH transmission assuming a nominal repetition without segmentation, and

$${N}_{symb , nominal}^{PUSCH}$$

is the total number of OFDM symbols in a nominal repetition of the PUSCH, including all OFDM symbols used for DMRS;
For any OFDM symbol that carries DMRS of the PUSCH assuming a nominal repetition without segmentation,

$${M}_{sc , nominal}^{UCI} ( l ) = 0 ;$$

For any OFDM symbol that does not carry DMRS of the PUSCH assuming a nominal repetition without segmentation,

$${M}_{sc , nominal}^{UCI} ( l ) = {M}_{sc}^{PUSCH} - {M}_{sc , nominal}^{PT - RS} ( l ) where {M}_{sc , nominal}^{PT - RS} ( l )$$

is the number of subcarriers in OFDM symbol l that carries PTRS, in the PUSCH transmission assuming a nominal repetition without segmentation;

$${M}_{sc , actial}^{UCI} ( l )$$

is the number of resource elements that can be used for transmission of UCI in OFDM symbol l, for l=0, 1, 2, . . . ,

$${N}_{symb , actual}^{PUSCH} - 1 ,$$

in the actual repetition of the PUSCH transmission, and N_{symb,actual}^{PUSCH} is the total number of OFDM symbols in the actual repetition of the PUSCH transmission, including all OFDM symbols used for DMRS;
For any OFDM symbol that carries DMRS of the actual repetition of the PUSCH transmission,

$${M}_{sc , actual}^{UCI} ( l ) = 0 ;$$

For any OFDM symbol that does not carry DMRS of the actual repetition of the PUSCH transmission,

$${M}_{sc , actual}^{UCI} ( l ) = {M}_{sc}^{PUSCH} - {M}_{sc , actual}^{PT - RS} ( l ) where {M}_{sc , actual}^{PT - RS} ( l )$$

is the number of subcarriers in OFDM symbol l that carries PTRS, in the actual repetition of the PUSCH transmission;
and all the other notations in the formula are defined the same as for PUSCH not using repetition type B.

When HARQ-ACK is transmitted on a PUSCH (or CG-PUSCH), if no UL-SCH exists, the number of coded modulation symbols may be determined by Equation 12-B below.

$${Q}_{ACK}^{′} = min \{ ⌈ \frac{( {O}_{ACK} + {L}_{ACK} ) \cdot {β}_{offset}^{PUSCH}}{R \cdot {Q}_{m}} ⌉ \cdot ⌈ α \cdot {{\sum }_{l = {l}_{o}}}^{{N}_{symb , all}^{PUSCH} - 1} {M}_{sc}^{UCI} ( l ) ⌉ \} \qquad Equation 12 - B$$

R is a code rate of a PUSCH, which is a value configured by the base station, and is determined via higher-layer signaling or L1 signaling. In addition, Qₘ denotes an order of a modulation scheme of the PUSCH.

The number E_{ACK}=N_{L}·Q′_{ACK}·Qₘ of codeword bits of ACK may be obtained based on Q′_{ACK} determined in Equation 12 and Equation 12-A.

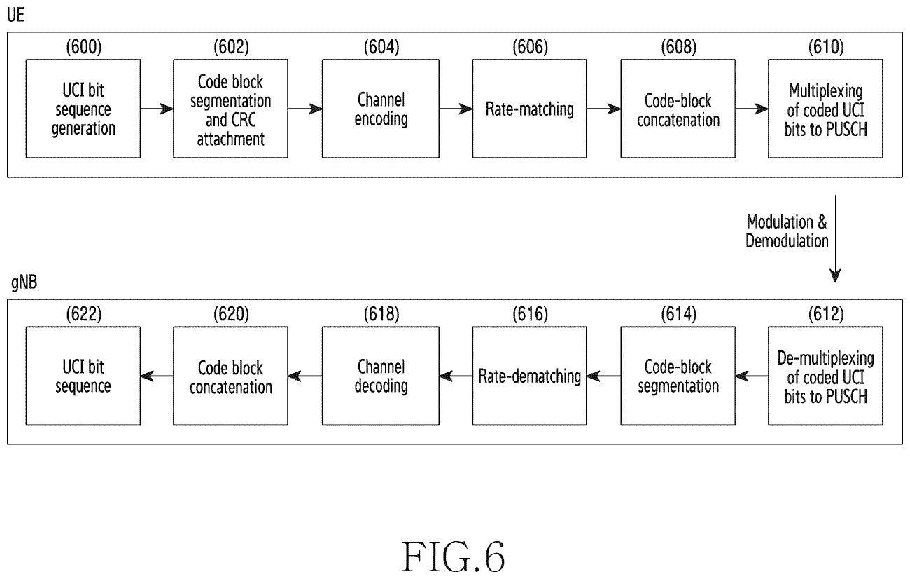

FIG. 6 is a diagram illustrating a procedure of transmitting and receiving UCI information between a UE and a base station on a PUSCH according to an embodiment of the disclosure.

The UE generates UCI information in operation 600 according to the procedure in FIG. 6. In operation 602, the UE determines a size of the UCI information, and if the size is 11 bits or less, the UE does not include a CRC, and if the size is greater than 12 bits, the UE additionally performs code block segmentation according to the size of the UCI information or includes a CRC. In operation 604, if the size of the UCI information is 11 bits or less, the UE performs channel coding of small block lengths, and if the size is greater than 12 bits, the UE performs polar coding. In operation 606, the UE may perform rate matching according to Equation 6 to Equation 12 based on a UCI information type, and calculate the number of coded modulation symbols. Code blocks are combined in operation 608, and coded UCI bit information is multiplexed onto a PUSCH in operation 610. After the UE transmits a modulated PUSCH to a base station, the base station may, in operation 612, demodulate the PUSCH and perform demultiplexing on coded UCI bits in the PUSCH. The base station may segment the received information into units of code blocks in operation 614, and perform rate dematching in operation 616. In operation 618, the base station may perform decoding according to a coded channel coding scheme based on the size of the UCI information. In operation 620, the base station may combine the decoded code blocks, and acquire the UCI information. The UCI information may be transmitted and received by being included in the PUSCH via the series of procedures described above. The flowchart described in FIG. 6 is merely an example, and it may be possible that at least one block in operations 600 to 622 is omitted under a certain condition. In addition, it may be fully possible to perform operation by adding a block other than the blocks in operations 600 to 622 included in the flowchart described in FIG. 6.

Subsequently, a procedure of multiplexing uplink data and control information will be described in Table 25.

TABLE 25
Step 1:

| | |
|---|---|
| - | If HARQ-ACK information to be transmitted on a PUSCH has a size of 0, 1, or 2 |
| | bits, reserved resources for latent HARQ-ACK transmission are determined. The |
| | reserved resources are determined according to a frequency-first scheme starting |
| | from a first symbol immediately after a symbol in which a first DMRS exists |
| | among resources allocated for the PUSCH. The frequency-first scheme refers to a |
| | general term for a scheme of sequentially mapping frequency resources for each |
| | symbol and then moving to a subsequent symbol to perform mapping. In this case, |
| | a reserved resource amount is calculated on the assumption that the HARQ-ACK |
| | information has a size of 2 bits. |
| | - Depending on the presence or absence of PUSCH hopping, it is determined |
| | whether coded bits for latent HARQ-ACK transmission are separated for each |
| | hop by using the reserved resources. |

Step 2:

| | |
|---|---|
| - | If the HARQ-ACK information to be transmitted on the PUSCH has a size greater |
| | than 2 bits, rate matching is performed. That is, coded bits of the HARQ-ACK |
| | information are mapped according to the frequency-first scheme, starting from a |
| | first symbol immediately after a symbol in which a first DMRS exists among |
| | resources allocated for the PUSCH. |

Step 2A:

| | |
|---|---|
| - | When CG-UCI information to be transmitted on the PUSCH exists, rate matching |
| | is performed. That is, for coded bits of the CG-UCI information, frequency-first |
| | mapping is performed starting from the first symbol immediately after the symbol |
| | in which the first DMRS exists among the resources allocated for the PUSCH. |

Step 3:

| | |
|---|---|
| - | When CSI part 1 information to be transmitted on a PUSCH exists, rate matching |
| | is performed. For CSI part 1, frequency-first mapping is performed starting from a |
| | first symbol in the resources allocated for the PUSCH, immediately after excluding |
| | resources to which DMRS, and the HARQ-ACK reserved, HARQ-ACK, or CG- |
| | UCI allocated in step 1, step 2, or step 2A have been allocated. Subsequently, for |
| | CSI part 2, frequency-first mapping is performed starting from a first symbol in the |
| | resources allocated for the PUSCH, excluding resources to which DMRS, and the |
| | HARQ-ACK or CG-UCI allocated in step 2 or 2A, or CSI part 1 have been |
| | allocated. CSI part 2 may be allocated to the reserved RE allocated in step 1. |

Step 4:

| | |
|---|---|
| - | Data information (UL-SCH) rate matching is performed. For a UL-SCH, |
| | frequency-first mapping is performed to the resources allocated for the PUSCH, |
| | excluding resources to which the UCI information mapped in steps 2 and 3 has |
| | been mapped. The UL-SCH may be allocated to the reserved RE allocated in step |
| | 1. |

Step 5:

| | |
|---|---|
| - | If the HARQ-ACK information to be transmitted on the PUSCH has a size no |
| | greater than 2 bits, mapping to the resources reserved in step 1 is performed. In |
| | this case, since calculation has been performed on the assumption that HARQ- |
| | ACK has 2 bits, actually mapped resources may be fewer than the number of the |
| | reserved REs. When there are the UCI resources or UL-SCH already mapped in |
| | steps 2 to 4 in the reserved resources, the corresponding information may be |
| | punctured and the HARQ-ACK information may be mapped. |
| | For the steps, if the number of bits (or the number of modulated symbols) of the |

uplink control information to be mapped to the PUSCH is more than the number of bits (or
REs) available for uplink control information mapping within the corresponding OFDM
symbol to be mapped, frequency axis RE interval d between modulated symbols of the
uplink control information to be mapped may be configured so that d=1. If the number of
bits (or the number of modulated symbols) of the uplink control information to be mapped
to the PUSCH is less than the number of bits (or REs) available for uplink control
information mapping within the corresponding OFDM symbol to be mapped, frequency
axis RE interval d between modulated symbols of the uplink control information to be
mapped may be configured so that d = floor (# of available bits on 1-OFDM symbol/# of
unmapped UCI bits at the beginning of 1-OFDM symbol).

### [PUCCH/PUSCH: Priority Level]

Hereinafter, descriptions will be provided for a UE transmission scheme according to priority information of a PUCCH and a PUSCH.

When one UE concurrently supports eMBB and URLLC, it may be possible for the UE to transmit data or control information for eMBB via a PUSCH or a PUCCH and may transmit data or control information for URLLC via a PUSCH or PUCCH. Requirements for two services are different, and generally a URLLC service is prioritized over an eMBB service, so that, when at least one symbol in a channel allocated for eMBB overlaps a channel allocated for URLLC, the UE may select at least one of the URLLC or eMBB channel to perform transmission. More specifically, the priority information may be indicated by a higher-layer signal or an LI signal, and a priority information value may be 0 or 1. A PUCCH or PUSCH indicated by 0 may be considered for eMBB and a PUCCH or PUSCH indicated by 1 may be considered for URLLC.

In an embodiment, for PUSCH, when there is a field capable of indicating priority information in DCI, the priority of the PUSCH may be determined by a value indicated by the field. Even for a PUSCH scheduled by DCI, if there is no field capable of indicating priority in the DCI, the UE may consider that the PUSCH has a priority value of 0. The PUSCH is applicable for both cases of including and not including aperiodic CSI or semi-persistent CSI. For a configured grant PUSCH periodically transmitted and received without DCI, priority may be determined by a higher-layer signal.

For PUCCH, a PUCCH for transmitting and receiving SR information and a PUCCH including HARQ-ACK information on an SPS PDSCH may have priority determined by a higher-layer signal. For a PUCCH including HARQ-ACK information on a PDSCH scheduled by DCI, if there is a priority field in the DCI, a priority value indicated by the field is applied, and if there is no corresponding field, it is considered to have a priority value of 0. In addition, a PUCCH including semi-persistent CSI or periodic CSI is always considered to have a priority value of 0.

When resources of PUSCHs or PUCCHs indicated by an L1 signal such as DCI or a higher-layer signal overlap each other, and at least some PUCCHs or PUSCHs have different priority information, the UE may first resolve overlapping between a PUCCH and a PUSCH having a priority information value of 0. As an example, a series of procedures of adding UCI information included in a PUCCH to a PUSCH may be included. When a resource of a PUCCH or PUSCH finally determined via an overlapping PUCCH or PUSCH having a lower priority is referred to as a second PUCCH or second PUSCH, and a PUCCH or PUSCH having a higher priority is referred to as a first PUCCH or second PUSCH, the UE may cancel transmission of the second PUCCH and second PUSCH if the second PUCCH or second PUSCH overlaps with the first PUCCH or first PUSCH in terms of time resources. The UE may expect that the transmission of the first PUCCH or first PUSCH starts after T_{proc,2}+d₁, that is, at least after the last symbol of PDCCH reception including DCI for scheduling of the transmission. Otherwise, the UE considers a case as an error case. A value proposed in Equation 2 may be used for the value of T_{proc,2}+d₁.

According to the description above, the PUCCH including HARQ-ACK information for a PDSCH including eMBB data may have a low priority value of 0, and the PUCCH including HARQ-ACK information for a PDSCH including URLLC data may have a high priority value of 1. Accordingly, when the PUCCH having a priority value of 0 and the PUCCH with a priority value of 1 overlap in terms of the time resource, the UE may drop the PUCCH having the priority value of 0 and may transmit the PUCCH having the priority value of 1. Therefore, from the perspective of the base station, since reception of HARQ-ACK information for the PDSCH including eMBB data has failed, the base station is unable to identify whether the UE has properly received the eMBB data, so that the eMBB data may need to be retransmitted. Accordingly, there is a possibility that eMBB data transmission and reception efficiency is deteriorated.

For convenience of description, HARQ-ACK information for a PDSCH including eMBB data is referred to as low priority (LP) HARQ-ACK, and HARQ-ACK information for a PDSCH including URLLC data is referred to as high priority (HP) HARQ-ACK. Low priority (LP) HARQ-ACK may refer to HARQ-ACK information having a priority value of 0, and high priority (HP) HARQ-ACK may refer to HARQ-ACK information having a priority value of 1.

A possible method to prevent deterioration of eMBB data transmission and reception efficiency may include a method of multiplexing HP HARQ-ACK and LP HARQ-ACK concurrently on one PUCCH or PUSCH channel. Therefore, when HP HARQ-ACK and LP HARQ-ACK are multiplexed on a PUCCH or PUSCH, there is a possibility of being multiplexed together with existing CSI part 1 and CSI part 2. If the base station or the UE is capable of multiplexing only up to three pieces of UCI information on a PUCCH or PUSCH, a method may be required, for this purpose, to determine information to be dropped among four pieces of information and to select the rest of the information.

In an embodiment, descriptions will be provided for a method of multiplexing UCI information on a PUSCH in an environment where HP HARQ-ACK and LP HARQ-ACK exist. In addition, even if HP HARQ-ACK and LP HARQ-ACK are the same HARQ-ACK information, the HP HARQ-ACK and LP HARQ-ACK have different requirements, and thus there may be a need for the HP HARQ-ACK to be transmitted more reliably than the LP HARQ-ACK, and accordingly different encoding and rate matching methods may be applied. As an example, when the number of coded modulation symbols for HP HARQ-ACK and LP HARQ-ACK is determined in Equation 12, different values may be applied for at least

$${β}_{offset}^{PUSCH}$$

or α. In addition, when HP HARQ-ACK and LP HARQ-ACK are multiplexed on one PUSCH, Equation 12 may be applied for the HP HARQ-ACK, whereas the number (Q′_{LP_ACK}) of coded modulation symbols may be determined by Equation 13 below when the LP HARQ-ACK is transmitted on the PUSCH (or CG-PUSCH).

$${Q}_{LP \_ ACK}^{′} = min \{ ⌈ \frac{( {O}_{LP \_ ACK} + {L}_{LP \_ ACK} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ \cdot ⌈ α \cdot {{\sum }_{l = {l}_{0}}}^{{N}_{symb , all}^{PUSCH} - 1} {M}_{sc}^{UCI} ( l ) ⌉ - {Q}_{ACK / CG - UCI}^{′} \} \qquad Equation 13$$

For HARQ-ACK LP transmission on an actual repetition of a PUSCH with repetition Type B with UL-SCH, the number of coded modulation symbols per layer for HARQ-ACK LP transmission, denoted as Q′_{ACK}, is determined as follows:

$${Q}_{ACK}^{′} = min \{ ⌈ \frac{( {O}_{LP \_ ACK} + {L}_{LP \_ ACK} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ \cdot ⌈ α \cdot {{\sum }_{l = 0}}^{{N}_{symb , nominal}^{PUSCH} - 1} {M}_{sc , nominal}^{UCI} ( l ) ⌉ - {Q}_{ACK / CG - UCI}^{′} \text{?} {{\sum }_{l = 0}}^{{N}_{symb , actual}^{PUSCH} - 1} {M}_{sc , actual}^{UCI} ( l ) - {Q}_{ACK / CG - UCI}^{′} \}$$

$$\text{?} \text{indicates text missing or illegible when filed}$$

In addition, when there is CSI part 1 without UL-SCH, the number (Q′_{LP_ACK}) of coded modulation symbols may be determined by Equation 13-A] below.

$${Q}_{LP \_ ACK}^{′} = min \{ ⌈ \frac{( {O}_{LP \_ ACK} + {L}_{LP \_ ACK} ) \cdot {β}_{offset}^{PUSCH}}{R \cdot {Q}_{m}} ⌉ \cdot ⌈ α \cdot {{\sum }_{l = {l}_{o}}}^{{N}_{symb , all}^{PUSCH} - 1} {M}_{sc}^{UCI} ( l ) ⌉ - {Q}_{ACK / CG - UCI}^{′} \} \qquad Equation 13 - A$$

In addition, when there is CSI part 1 without UL-SCH, the number (Q′_{LP_ACK}) of coded modulation symbols may be determined by Equation 13-B below.

$${Q}_{LP \_ ACK}^{′} = {{\sum }_{l = {l}_{o}}}^{{N}_{symb , all}^{PUSCH} - 1} {M}_{sc}^{UCI} ( l ) - {Q}_{ACK / CG - UCI}^{′} \qquad Equation 13 - B$$

Q′_{ACK/CG-UCI} is a value determined based on Equation 12, Equation 12-A, or Equation 12-B, and denotes the number of coded modulation symbols per layer for transmitting HARQ_ACK, CG-UCI, or HARQ_ACK/CG-UCI. (the number of coded modulation symbols per layer)

### [PUCCH: Type 1 HARQ-ACK Codebook]

Hereinafter, a semi-static HARQ-ACK codebook (or Type-1 HARQ-ACK codebook) is described.

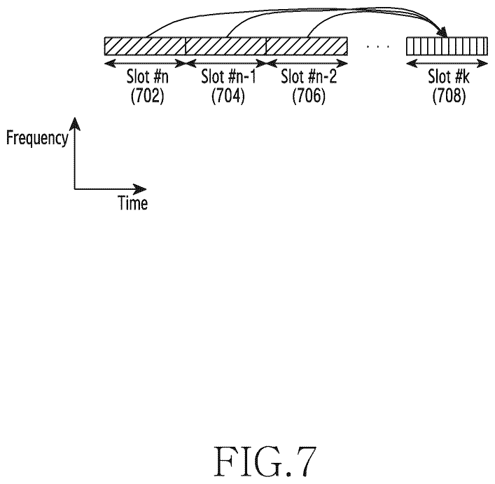

FIG. 7 is a diagram illustrating a method of configuring a semi-static HARQ-ACK codebook (or Type-1 HARQ-ACK codebook) in the NR system according to an embodiment of the disclosure.

In a situation where an HARQ-ACK PUCCH that a UE may transmit within one slot is limited to one, when the UE receives a higher-layer signal configuration of a semi-static HARQ-ACK codebook, the UE reports HARQ-ACK information for SPS PDSCH release or PDSCH reception within an HARQ-ACK codebook in a slot indicated by a value of a PDSCH-to-HARQ_feedback timing indicator in DCI format 1_x. The UE reports NACK for an HARQ-ACK information bit value in the HARQ-ACK codebook, in a slot that is not indicated by a PDSCH-to-HARQ_feedback timing indicator field in DCI format 1_x. If the UE reports only HARQ-ACK information for one SPS PDSCH release or one PDSCH reception in M_{A,C} cases for candidate PDSCH reception, and when the report is scheduled by DCI format 1_0 including information indicating that a counter DAI field indicates 1 in a PCell, the UE determines one HARQ-ACK codebook for the corresponding SPS PDSCH release or the corresponding PDSCH reception.

Otherwise, a method of determining an HARQ-ACK codebook according to the method described below is followed.

When a set of PDSCH reception candidates cases in serving cell c is M_{A,c}, M_{A,c} may be obtained via the following [pseudo-code 1] steps.

### [Start of Pseudo-Code 1]

Step 1: Initializing j to be 0, and M_{A,c} to be an empty set. Initializing k, i.e., an HARQ-ACK transmission timing index, to be 0.
Step 2: Configuring R to be a set of respective rows in a table including information on a slot to which PDSCH is mapped, start symbol information, and information on the length or number of symbols. If a PDSCH-capable mapping symbol indicated by each value of R is configured as an UL symbol according to DL and UL configurations configured in a higher level, a corresponding row is deleted from R.
Step 3-1: If the UE is able to receive up to one unicast PDSCH in one slot, and R is not an empty set, adding one to set M_{A,c}.
Step 3-2: If the UE is able to receive more than one unicast PDSCH in one slot, counting the number of PDSCHs allocatable to different symbols in the calculated R, and adding the corresponding number to M_{A,c}.
Step 4: Increasing k by 1, and starting steps again from step 2.

### [End of Pseudo-Code 1]

Taking the aforementioned pseudo-code 1 as an example of FIG. 7, in order to perform HARQ-ACK PUCCH transmission in slot #k 708, all slot candidates available for PDSCH-to-HARQ-ACK timing capable of indicating slot #k 708 may be considered. In FIG. 7, it is assumed that HARQ-ACK transmission is possible in slot #k 708 by a PDSCH-to-HARQ-ACK timing combination in which only PDSCHs scheduled in slot #n 702, slot #n+1 704, and slot #n+2 706 are possible. In consideration of time domain resource configuration information of the PDSCH available for scheduling in each of slots 702, 704, and 706 and information indicating whether a symbol within the slot is for downlink or uplink, the maximum number of PDSCHs available for scheduling for each slot is derived. For example, when two PDSCHs in slot 702, three PDSCHs in slot 704, and two PDSCHs in slot 706 are available for maximum scheduling, the maximum number of PDSCHs included in the HARQ-ACK codebook transmitted in slot 708 is seven in total. This is referred to as cardinality of the HARQ-ACK codebook.

### [PUCCH: Type 2 HARQ-ACK Codebook]

Hereinafter, a dynamic HARQ-ACK codebook (or Type-2 HARQ-ACK codebook) will be described.

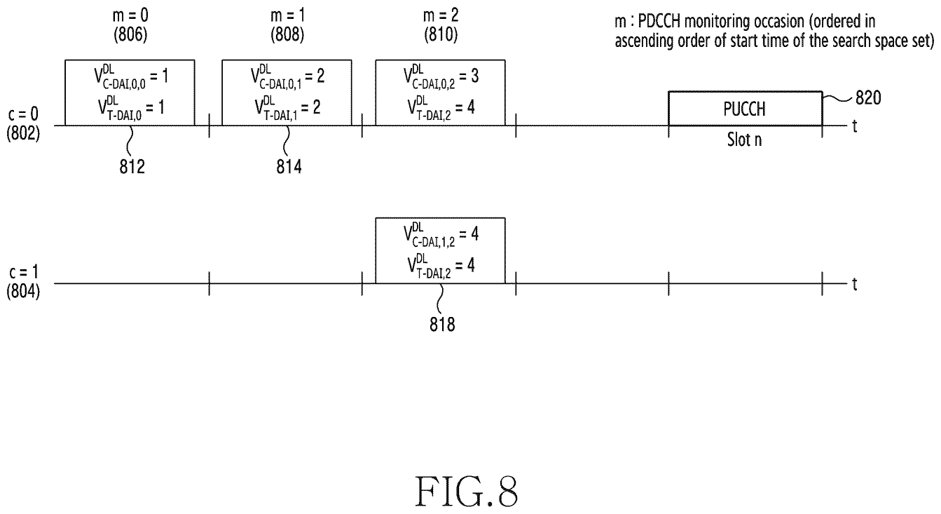

FIG. 8 is a diagram illustrating a method of configuring a dynamic HARQ-ACK codebook (or Type-2 HARQ-ACK codebook) in the NR system according to an embodiment of the disclosure.

Based on a PDSCH-to-HARQ_feedback timing value for PUCCH transmission of HARQ-ACK information in slot n for PDSCH reception or SPS PDSCH release, and K₀ that is transmission slot position information of a PDSCH scheduled in DCI format 1_x, a UE transmits HARQ-ACK information transmitted within one PUCCH in slot n. Specifically, for the described HARQ-ACK information transmission, the UE determines an HARQ-ACK codebook of a PDCCH transmitted in a slot determined by K₀ and PDSCH-to-HARQ_feedback timing, based on a DAI included in DCI indicating PDSCH or SPS PDSCH release.

The DAI includes a counter DAI and a total DAI. The counter DAI is information in which HARQ-ACK information corresponding to the PDSCH scheduled in DCI format 1_x indicates a position within the HARQ-ACK codebook. Specifically, a counter DAI value in DCI format 1_x indicates a cumulative value of SPS PDSCH release or PDSCH reception scheduled by DCI format 1_x in specific cell c. The cumulative value is configured based on a serving cell and a PDCCH monitoring occasion in which the scheduled DCI exists.

In an embodiment, the total DAI is a value indicating a size of the HARQ-ACK codebook. Specifically, a total DAI value refers to a total number of previously scheduled PDSCH or SPS PDSCH releases, including a point in time at which the DCI has been scheduled. The total DAI is a parameter used when HARQ-ACK information in serving cell c also includes HARQ-ACK information on a PDSCH scheduled in another cell including serving cell c in a carrier aggregation (CA) situation. In other words, there is no total DAI parameter in a system operating with one cell.

An operation example for DAI is described in FIG. 8.

FIG. 8 is a diagram illustrating a method of configuring a dynamic HARQ-ACK codebook (or Type-2 HARQ-ACK codebook) in the NR system according to an embodiment of the disclosure. FIG. 8 shows, in a situation where two carriers are configured, when a UE transmits an HARQ-ACK codebook, selected based on a DAI, on a PUCCH 820 in an n-th slot of carrier 0 802, a change in values of a counter DAI (C-DAI) and a total DAI (T-DAI) indicated by DCI retrieved for each PDCCH monitoring occasion configured for each carrier. First, in DCI retrieved at m=0 806, each of the C-DAI and the T-DAI indicates a value 812 of 1. In DCI retrieved at m=1 808, each of the C-DAI and the T-DAI indicates a value 814 of 2. In DCI retrieved on carrier 0 (c=0) 802 of m=2 810, C-DAI indicates a value 816 of 3. In DCI retrieved on carrier 1 (c=1) 804 of m=2 810, C-DAI indicates a value 818 of 4. If carriers 0 and 1 are scheduled at the same monitoring time point, both T-DAIs are indicated by 4.

In FIGS. 7 and 8, HARQ-ACK codebook determination is performed in a situation where only one PUCCH including HARQ-ACK information is transmitted in one slot. This is referred to as mode 1. As an example of a method in which one PUCCH transmission resource is determined within one slot, when PDSCHs scheduled in different DCI are multiplexed with one HARQ-ACK codebook and transmitted in the same slot, a PUCCH resource selected for HARQ-ACK transmission is determined as a PUCCH resource indicated by a PUCCH resource field indicated in DCI by which a PDSCH is most recently scheduled. That is, a PUCCH resource indicated by a PUCCH resource field indicated in DCI scheduled before the DCI is disregarded.

The following description defines HARQ-ACK codebook determination method and devices in a situation where two or more PUCCHs including HARQ-ACK information may be transmitted within one slot. This is referred to as mode 2. A UE may be able to operate only in mode 1 (only one HARQ-ACK PUCCH is transmitted within one slot) or operate only in mode 2 (one or more HARQ-ACK PUCCHs are transmitted within one slot). Alternatively, for a UE supporting both mode 1 and mode 2, it may be possible that a base station configures, via higher-layer signaling, operation in only one mode, or mode 1 and mode 2 are determined implicitly by a DCI format, an RNTI, a DCI-specific field value, scrambling, etc. In an example, a PDSCH scheduled in DCI format A and HARQ-ACK information associated therewith may be based on mode 1, and a PDSCH scheduled in DCI format B and HARQ-ACK information associated therewith may be based on mode 2.

### [PUCCH: Type 3 HARQ-ACK Codebook]

In the following, a Type-3 HARQ-ACK codebook will be described.

Unlike Type-1 and Type-2 HARQ-ACK codebooks, a Type-3 HARQ-ACK codebook is a scheme in which the UE reports all HARQ-ACK information for all configured serving cells, the number of HARQ processes, the number of TBs for each HARQ process, and the number of CBGs for each TB. For example, when there are 2 serving cells, 16 HARQ processes for each serving cell, 1 TB for each HARQ process, and 2 CBGs for each TB, the UE may report a total of 64 (=2×16×1×2) HARQ-ACK information bits. In addition, according to a separate configuration, it may also be possible for the UE to report both HARQ-ACK information and a recently received NDI value for each HARQ process related thereto. Based on the NDI value, the base station may determine whether a PDSCH received for each HARQ process of the UE is determined to be initial transmission or is determined to be retransmission. When there is no separate report of the NDI value, if HARQ-ACK information has already been reported for a specific HARQ process before the base station receives DCI for requesting of the Type-3 HARQ-ACK codebook, the UE maps the HARQ process to NACK, and otherwise maps an HARQ-ACK information bit to a PDSCH received for each corresponding HARQ process. The number of serving cells, the number of HARQ processes, the number of TBs, and the number of CBGs can be configured separately, and if there are no separate configurations, the UE may consider the number of serving cells to be 1, the number of HARQ processes to be 8, the number of TB to be 1, and the number of CBG to be 1. In addition, the number of HARQ processes may be different for each serving cell. In addition, the number of TBs may have a different value for each serving cell or for each BWP within a serving cell. In addition, the number of CBGs may vary for each serving cell.

One of reasons that the Type-3 HARQ-ACK codebook is required may be occurrence of a case where the UE cannot transmit a PUSCH or a PUCCH including HARQ-ACK information for a PDSCH due to a channel access failure, overlapping with another channel having a high priority, etc. Therefore, it is reasonable for the base station to request reporting of only corresponding HARQ-ACK information without needing to reschedule a separate PDSCH. Accordingly, it may be possible for the base station to schedule the Type-3 HARQ-ACK codebook and the PUCCH resource including the codebook via a higher-layer signal or an L1 signal (e.g., a specific field in DCI).

In an embodiment, if the UE searches for a DCI format including 1 as a field value for requesting one-shot HARQ-ACK, the UE determines a PUCCH or PUSCH resource for multiplexing the Type-3 HARQ-ACK codebook in a specific slot indicated by the DCI format. In addition, the UE multiplexes only the Type-3 HARQ-ACK codebook in the PUCCH or PUSCH for transmission in the corresponding slot. That is, if two PUCCHs overlap, one is a Type-1 HARQ-ACK codebook (or Type-2 HARQ-ACK codebook), and the other is a Type-3 HARQ-ACK codebook, the UE multiplexes only the Type-3 HARQ-ACK codebook on a PUCCH or PUSCH. This is because the Type-3 HARQ-ACK codebook includes HARQ-ACK information bits for all serving cells, all HARQ process numbers, all TBs, and all CBGs configured for the UE, and therefore information of the Type-1 HARQ-ACK codebook and Type-2 HARQ-ACK codebook is considered to be already included in the Type-3 HARQ-ACK codebook.

However, since the Type-3 HARQ-ACK codebook includes all HARQ-ACK information bits based on information configured for all UEs, HARQ-ACK information bits for a PDSCH that is not actually scheduled also needs to be included in the codebook even if the HARQ-ACK information bits are mapped to NACK, and accordingly, there is a disadvantage that an information bit size is large. Therefore, there is a possibility that uplink transmission coverage or transmission reliability decreases as a size of an uplink control information bit increases. Therefore, an HARQ-ACK codebook having a size smaller than that of the Type-3 HARQ-ACK codebook is required. In the disclosure, this HARQ-ACK codebook is considered to be different from the existing Type-3 HARQ codebook, and is described as an enhanced Type-3 HARQ-ACK codebook (or Type-4 HARQ-ACK codebook) for convenience. However, it is quite possible for this HARQ-ACK codebook to be replaced with another name. For example, an enhanced Type-3 HARQ-ACK codebook may be configured as follows.
Type A: a subset of a total set of (configured) serving cells
Type B: a subset of a total set of (configured) HARQ process numbers
Type C: a subset of a total set of (configured) TB indexes
Type D: a subset of a total set of (configured) CBG indexes
Type E: a combination of at least two among types A to D

The enhanced Type-3 HARQ-ACK codebook may have characteristics of at least one of types A to E, and can be configured by one or multiple sets. The enhanced Type-3 HARQ-ACK codebook may include the entire set of types A to E instead of a subset. As for the meaning of multiple sets, for example, it is possible that type A and type B exist, or that different subsets exist even for type A. In consideration of the types A to E, the enhanced Type-3 HARQ-ACK codebook may be indicated by a higher-layer signal, an L1 signal, or a combination thereof. For example, as in Table 26, it may be possible that a set configuration for HARQ-ACK information bits to be reported in each enhanced Type-3 HARQ-ACK codebook is indicated via a higher-layer signal, and one of these values is indicated by an L1 signal. As in Table 26, it may be possible to individually configure a type of the enhanced Type-3 HARQ-ACK codebook configured for each index via a higher-layer signal. In addition, it is also possible to use the Type-3 HARQ-ACK codebook for reporting of all HARQ-ACK information bits for a specific index, such as index 3. If not separately indicated by a higher-layer signal or if there is no higher-layer signal, it may be determined that the Type-3 HARQ-ACK codebook is used based on a default value (e.g., ACK or NACK states for all HARQ process numbers).

TABLE 26

| Index | Type 3 |
|---|---|
| 1 | Serving cell i, HARQ process number (#1 to #8), TB 1 |
| 2 | Serving cell i, HARQ process number (#9 to #12), TB 1 |
| 3 | Type-3 HARQ-ACK codebook |
| . . . | . . . |

The UE receives a value for requesting of the one-shot HARQ-ACK feedback field, and when a value indicated by index 1 according to Table 26 is received, the UE may report a total of 8 bits of HARQ-ACK information for serving cell i, HARQ process numbers (#1 to #8), and TB 1. The UE receives a value for requesting of the one-shot HARQ-ACK feedback field, and when a value indicated by index 2 according to Table 26 is received, the UE reports a total of 4 bits of HARQ-ACK information for serving cell i, HARQ process numbers (#1 to #8), and TB 1. The UE receives a value for requesting of the one-shot HARQ-ACK feedback field, and when a value indicated by index 3 according to Table 26 is received, the UE calculates a total number of HARQ-ACK bits by considering a serving cell set, a total number of HARQ processes per serving cell i, the number of TBs per HARQ process, and the number of CBGs per TB. Table 26 is only an example, and a total number of indexes may be more or fewer than this, and a range of an HARQ process value indicated by each index and/or information included in the enhanced Type-3 HARQ-ACK codebook may be different.

In addition, Table 26 may be information indicated by a higher-layer signal, and a specific index may be notified via DCI. In addition, HARQ-ACK information indicated via a specific index value or a one-shot HARQ-ACK feedback field (or another L1 signal) in addition to Table 26 above can be used for the purpose of, when specific HARQ-ACK information that is scheduled in advance for the UE so as to be transmitted, other than HARQ-ACK information for a specific (or all) HARQ process number, is dropped, retransmitting the specific HARQ-ACK information scheduled. This is referred to as dropped HARQ-ACK retransmission. The dropping can occur in a case of overlapping with another PUCCH or PUSCH having a higher priority than a PUCCH or PUSCH including the HARQ-ACK information. Alternatively, the dropping can occur when at least one symbol of the PUCCH or PUSCH including the HARQ-ACK information has been previously indicated as a downlink symbol via a higher-layer signal. Alternatively, the dropping can occur when the PUCCH or PUSCH including the HARQ-ACK information at least partially overlaps with a resource indicated by DCI including uplink cancellation information for the purpose of canceling uplink transmission. When the UE supports both the dropped HARQ-ACK retransmission and (enhanced) type-3 HARQ codebook-based transmission, the UE may be able to report HARQ-ACK information by selecting at least one of the dropped HARQ-ACK retransmission and (enhanced) type-3 HARQ codebook-based transmission, via at least one piece of information or a combination of MCS, RV, NDI, HARQ process ID, etc., priority information in DCI fields, a search space type in which DCI has been retrieved, or CRC of DCI and scrambled RNTI information. Alternatively, a specific index value in Table 26 can be configured as and used for the dropped HARQ-ACK retransmission. Selection of the specific index in Table 26 may be indicated by a combination of or at least one of an HARQ process number, MCS, NDI, RV, frequency resource allocation information, or time resource allocation information in DCI fields. A size of a DCI bit field indicating the specific index of Table 26 may be determined by

$$⌈ {log}_{2} ( {N}_{total}^{index} ) ⌉ .$$

### Here,

$${N}_{total}^{index}$$

denotes a total number of indexes of Table 26 configured via a higher-layer signal.

The total number N of HARQ-ACK bits may be expressed as Equation 14 below.

$$N = {{\sum }_{c}}^{n ( c )} {H}_{c} \times {T}_{b , c} \times {B}_{c} \qquad Equation 14$$

In Equation 14, n (c) denotes a total number of serving cells c, H_{c} denotes the number of HARQ processes configured in serving cell c, T_{b,c} denotes the number of TBs for each HARQ process configured in BWP b and serving cell c, and Be denotes the number of CBGs configured in serving cell c. In addition, when the UE searches for a DCI format having a one-shot HARQ-ACK request field value of 1, the UE determines a PUCCH or PUSCH resource for multiplexing a corresponding Type-3 HARQ-ACK codebook (or enhanced Type-3 HARQ-ACK codebook). In addition, the UE multiplexes only the Type-3 HARQ-ACK codebook (or enhanced Type-3 HARQ-ACK codebook) on the determined PUCCH or PUSCH resource for transmission in a corresponding slot. If there is a PUCCH or PUSCH including SR information or CSI information, which overlaps with the PUCCH or PUSCH, the UE may be able to drop the SR information or CSI information without multiplexing the same. That is, it may be possible for the UE to multiplex only Type-3 HARQ-ACK information, and drop other UCI of SR and CSI.

### [PDSCH: SPS]

Hereinafter, an SPS operation will be described. When two or more activated DL SPS operations are possible for the UE in one cell/one BWP, the base station may configure two or more DL SPS configurations for one UE. A reason for supporting two or more DL SPS configurations is that, when the UE supports various traffic, each traffic may have different MCS, time/frequency resource allocation, or periodicity, so that it may be advantageous to configure DL SPS appropriate for each purpose.

The UE may receive at least a part of higher-layer signal configuration information for DL SPS as shown in Table 27 below.

TABLE 27
- Periodicity: DL SPS transmission periodicity
- nrofHARQ-Processes: the number of HARQ processes configured for DL SPS
- n1PUCCH-AN: HARQ resource configuration information for DL SPS
- mcs-Table: MCS table configuration information applied to DL SPS
- sps-ConfigIndex-r16: index of SPS configured in one cell/one BWP
- harq-ProcID-Offset-r16: offset value for HARQ-ACK process number calculation
- periodicityExt-r16: DL SPS transmission periodicity which is configurable to be a
different value according to a subcarrier spacing, and periodicity is ignored when a
corresponding field exists.
- harq-CodebookID-r16: HARQ-ACK codebook index information for SPS or SPS release
- pdsch-AggregationFactor-r16: the number of repeated SPS PDSCH transmissions

In the higher-layer signal configuration information, an SPS index may be used to indicate SPS indicated by DCI (L1 signaling) that provides SPS activation or deactivation. Specifically, in a situation where two SPSs are configured in one cell/one BWP via a higher-layer signal, in order for the UE to identify activation of which of the two SPSs is indicated by the DCI indicating SPS activation, index information indicating the same to SPS higher-layer information may be required. As an example, for the UE, an HARQ process number field in the DCI indicating SPS activation or deactivation indicates an index of a specific SPS, so that activation or deactivation may be possible. Specifically, when DCI including CRC scrambled by CG-RNTI includes the following information as in Table 28, and a new data indicator (NDI) field of the DCI indicates 0, the UE determines that pre-activated specific SPS PDSCH release (deactivation) is indicated.

TABLE 28

| | DCI format 0_0 | DCI format 1_0 |
|---|---|---|
| HARQ process number | SPS index | SPS index |
| Redundancy version | set to ‘00’ | set to ‘00’ |
| Modulation and coding | set to all ‘1’s | set to all ‘1’s |
| scheme | | |
| Frequency domain resource | set to all ‘1’s | set to all ‘1’s |
| assignment | | |

In Table 28, it may be possible for one HARQ process number to indicate one SPS index or indicate multiple SPS indexes. In addition to the HARQ process number field, it may be possible for another DCI field (a time resource field, a frequency resource field, MCS, RV, a PDSCH-to-HARQ timing field, etc.) to indicate one or multiple SPS index(es). Basically, one SPS may be activated or deactivated by one piece of DCI. A position of a Type-1 HARQ-ACK codebook for HARQ-ACK information on DCI indicating SPS PDSCH release is the same as a position of a Type-1 HARQ-ACK codebook corresponding to a reception position of a corresponding SPS PDSCH. When a position of an HARQ-ACK codebook corresponding to candidate SPS PDSCH reception within a slot is k₁, a position of an HARQ-ACK codebook for the DCI indicating the SPS PDSCH release is also k₁. Therefore, when the DCI indicating SPS PDSCH release is transmitted in slot k, the UE may not expect to receive PDSCH scheduling corresponding to HARQ-ACK codebook position k₁ in the same slot k, and when this situation occurs, the UE considers this as an error case. In Table 28, DCI formats 0_0 and 1_0 are used as examples. However, Table 28 is also applicable to DCI formats 0_1 and 1_1, and can be sufficiently extended and applied to other DCI formats 0_x and 1_x as well. Based on the operations described above, the UE may receive an SPS PDSCH higher-layer signal and receive DCI indicating SPS PDSCH activation, so that at least one SPS PDSCH may be operated concurrently within one cell/one BWP. Then, the UE periodically receives an activated SPS PDSCH within one cell/one BWP and transmits HARQ-ACK information corresponding thereto. The HARQ-ACK information corresponding to the SPS PDSCH is determined by the UE via slot interval information based on PDSCH-to-HARQ-ACK timing included in activated DCI information, accurate time and frequency information within a corresponding slot based on n1PUCCH-AN information included in SPS higher-layer configuration information, and PUCCH format information. If there is no PDSCH-to-HARQ-ACK timing field included in DCI information, the UE assumes that one value pre-configured via a higher-layer signal is a default value, and determines that the default value has been applied.

The UE may configure the following DL SPS configuration information from a higher-layer signal.
Periodicity: DL SPS transmission periodicity
nrofHARQ-Processes: the number of HARQ processes configured for DL SPS
n1PUCCH-AN: HARQ resource configuration information for DL SPS
mcs-Table: MCS table configuration information applied to DL SPS

In the disclosure, all DL SPS configuration information can be configured for each PCell or SCell, and can also be configured for each frequency bandwidth part (BWP). In addition, one or more DL SPSs can be configured for each specific cell or BWP.

The UE determines grant-free transmission and reception configuration information by receiving a higher-layer signal for DL SPS. For DL SPS, data transmission and reception may be possible for a resource area configured after receiving of DCI indicating activation, and data transmission and reception is not possible for a resource area before receiving of the DCI. In addition, the UE cannot receive data in a resource area after receiving of DCI indicating release.

The UE verifies a DL SPS assignment PDCCH when both of the following two conditions are satisfied for SPS scheduling activation or release.
Condition 1: a case where a CRC bit of a DCI format transmitted on the PDCCH is scrambled by CS-RNTI configured via higher-layer signaling
Condition 2: a case where a new data indicator (NDI) field for an activated transport block is configured to 0

When some of fields constituting a DCI format transmitted on a DL SPS assignment PDCCH are the same as those presented in Table 29 or Table 30], the UE determines that information in the DCI format is valid activation or valid release of DL SPS. For example, when the UE detects a DCI format including information presented in Table 29, the UE determines that DL SPS has been activated. As another example, when the UE detects a DCI format including information presented in Table 30, the UE determines that DL SPS has been released.

When some of the fields constituting the DCI format transmitted on the DL SPS assignment PDCCH are not the same as those presented in Table 29 (special field configuration information for DL SPS activation) or Table 30] (special field configuration information for DL SPS release), the UE determines that the DCI format has been detected with a CRC that does not match.

TABLE 29

| | DCI format 1_0 | DCI format 1_1 |
|---|---|---|
| HARQ process number | set to all ‘0’s | set to all ‘0’s |
| Redundancy version | set to ‘00’ | For the enabled transport |
| | | block: set to ‘00’ |

TABLE 30

| | DCI format 1_0 |
|---|---|
| HARQ process number | set to all ‘0’s |
| Redundancy version | set to ‘00’ |
| Modulation and coding scheme | set to all ‘1’s |
| Resource block assignment | set to all ‘1’s |

If the UE receives a PDSCH without receiving a PDCCH or receives PDCCH indicating SPS PDSCH release, the UE generates an HARQ-ACK information bit corresponding thereto. In addition, at least in Rel-15 NR, the UE does not expect to transmit HARQ-ACK information for reception of two or more SPS PDSCHs in one PUCCH resource. In other words, at least in Rel-15 NR, the UE includes only HARQ-ACK information for reception of one SPS PDSCH in one PUCCH resource.

DL SPS may also be configured in a primary (P) Cell and a secondary (S Cell. Parameters which may be configured via DL SPS higher-layer signaling are as follows.
Periodicity: DL SPS transmission periodicity
nrofHARQ-processes: the number of HARQ processes which may be configured for DL SPS
n1PUCCH-AN: PUCCH HARQ resource for DL SPS, and the base station configures the resource to be PUCCH format 0 or 1.

Table 29 and Table 30 described above may be fields available in a situation where only one DL SPS is configurable for each cell or each BWP. In a situation where multiple DL SPSs are configured for each cell and each BWP, a DCI field for activating (or releasing) each DL SPS resource may be different. The disclosure provides a method for solving such a situation.

In the disclosure, not all DCI formats described in Table 29 and Table 30 are used to activate or release DL SPS resources, respectively. For example, DCI format 1_0 and DCI format 1_1 which are used for PDSCH scheduling are used to activate DL SPS resources. For example, DCI format 1_0 used for PDSCH scheduling is used to release DL SPS resources.

Power consumption of a UE may occur by various factors, and in a mobile communication environment, transmission power of the UE is usually greater than reception power thereof. In general, downlink traffic occurs more than uplink traffic for a UE. Typically, downlink traffic is received by a UE from a base station via a PDSCH, and the UE transmits HARQ-ACK information in response to the received PDSCH. HARQ-ACK information is information indicating whether the UE has successfully received the PDSCH, and is one of fundamental methods for improving transmission reliability. Therefore, although downlink traffic occurs more, it may not be easy for the UE to lower transmission power due to transmission of HARQ-ACK information to increase transmission reliability. However, when an NACK-only feedback scheme is considered, it may be possible for the UE to reduce power consumption because the UE does not perform transmission when ACK is generated. Hereinafter, for convenience of description, an ACK/NACK feedback scheme refers to a method in which a UE receives a PDSCH, generates and reports ACK if demodulation/decoding of the PDSCH succeeds, and generates and reports NACK if demodulation/decoding of the PDSCH fails. Hereinafter, the NACK-only feedback scheme refers to a method in which a UE receives a PDSCH, does not report ACK if demodulation/decoding of the PDSCH succeeds, and generates and reports NACK if demodulation/decoding of the PDSCH fails.

### Embodiment 1

Hereinafter, the embodiment describes the NACK-only feedback scheme limited to DL SPS. As described above, NACK-only feedback is a method for reducing transmission power of a UE by not transmitting ACK to a base station when the UE generates the ACK. However, such a scheme has a drawback in that the base station cannot distinguish between discontinuous transmission (DTX) and ACK. DTX indicates that the UE has failed to receive DCI in a PDCCH for scheduling a PDSCH. Normally, a PDSCH is scheduled by a DCI format in a PDCCH, and if the UE fails to receive the DCI format, the UE does not know whether a PDSCH exists or an HARQ-ACK transmission resource provided via the DCI format, and therefore does not transmit anything. This is referred to as DTX. When the ACK/NACK feedback scheme is applied, it may be possible for the base station to distinguish between ACK, NACK, and DTX depending on whether DCI of a PDCCH has been received and whether a PDSCH has been successfully demodulated/decoded. However, when the NACK-only feedback scheme is applied, the base station is able to distinguish NACK, but cannot distinguish between ACK and DTX. Accordingly, no additional transmission is required for ACK, but for DTX, since data that has not been actually transmitted should be retransmitted via ARQ, additional energy consumption may occur. Therefore, it may be possible to apply the NACK-only feedback scheme in a manner limited to DL SPS. For DL SPS, there is no separate DCI format for scheduling the same, DTX does not occur. Accordingly, when configuring DL SPS, providing NACK-only feedback may help reduce power consumption of the UE. In addition, this may be applicable only to unicast data. That is, when data included in a PDSCH is unicast data, it may be possible to apply the ACK/NACK feedback scheme to a PDSCH scheduled by a DCI format, and to provide NACK-only feedback to a DL SPS PDSCH.

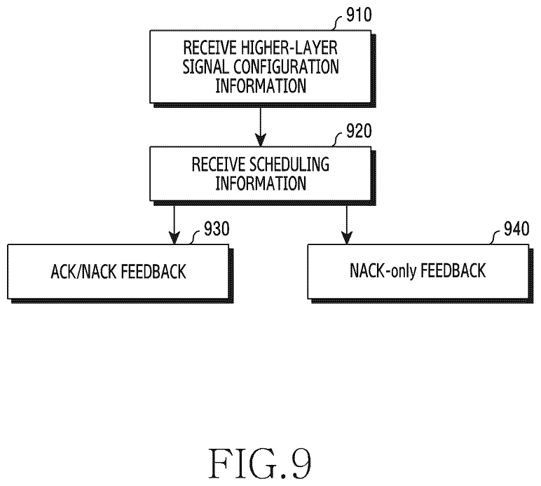

FIG. 9 is a diagram illustrating an operation for transmitting HARQ-ACK feedback according to an embodiment of the disclosure.

In operation 910, a UE may receive higher-layer signal configuration information related to PDSCH and HARQ-ACK via higher-layer signal reception. Subsequently, in operation 920, the UE may receive scheduling information for PDSCH reception. In operation 940, if the information is a signal related to DL SPS, the UE may transmit HARQ-ACK information according to the NACK-only feedback scheme. In operation 930, if the information is a signal related to a PDSCH provided via a DCI format, HARQ-ACK information may be transmitted according to the ACK/NACK feedback scheme. For DL SPS, whether to apply the NACK-only feedback scheme may be configured in advance via higher-layer signals or L1 signals, and if there is no separate higher-layer signal or L1 signal, it may be determined that the ACK/NACK feedback scheme is applied. Alternatively, for DL SPS, either the NACK-only feedback scheme or the ACK/NACK feedback scheme may be applied. For a PDSCH scheduled by a DCI format, it may be possible to apply the ACK/NACK feedback scheme only. HARQ-ACK feedback scheme determination for the PDSCH and DL SPS may be applied only to unicast. For a unicast PDSCH, if the PDSCH is a DL SPS PDSCH, either the ACK/NACK feedback scheme or the NACK-only feedback scheme may be applicable, and if the PDSCH is a PDSCH scheduled by a DCI format, only the ACK/NACK feedback scheme may be applicable. In contrast, for a multicast PDSCH, regardless of whether the PDSCH is a DL SPS PDSCH or a PDSCH scheduled by a DCI format, either the ACK/NACK feedback scheme or the NACK-only feedback scheme may be applicable.

### Embodiment 2

Hereinafter, the embodiment describes a method of indicating an HARQ-ACK feedback method. If the UE supports both the ACK/NACK feedback scheme and the NACK-only feedback scheme, the base station may need to consider which scheme to configure for the UE. By default, a method of configuring a scheme via a higher-layer signal may be possible. In addition, it may be possible to indicate, via a specific DCI field, whether the HARQ-ACK feedback method for a PDSCH scheduled by a corresponding DCI format is ACK/NACK or NACK-only. The DCI field may be provided via a field indicating a PUCCH resource area. In an example, when indicating time and frequency resource areas of the PUCCH, it may also be possible to indicate, in combination, the HARQ-ACK feedback scheme included in a corresponding PUCCH resource. Accordingly, when the UE receives a DCI format including PUCCH resource information, if the PUCCH resource is configured for NACK-only feedback, it may be possible to transmit NACK via the resource only when a PDSCH demodulation/decoding result is NACK. Alternatively, indication via the DCI field including 1 bit may be possible. For example, if a value of the DCI field is 0, the UE may transmit HARQ-ACK feedback using the ACK/NACK feedback scheme, and if the value is 1, the UE may transmit HARQ-ACK feedback using the NACK-only feedback scheme. Alternatively, it may be possible to indicate whether the HARQ-ACK feedback method is ACK/NACK or NACK-only via a field indicating an HARQ process ID. For example, if an HARQ process ID is 1, the UE may transmit HARQ-ACK feedback using the ACK/NACK feedback scheme, and if the HARQ process ID is 10, the UE may transmit HARQ-ACK feedback using the NACK-only feedback scheme.

### Embodiment 3

Hereinafter, a method of supporting NACK-only feedback according to a battery level of the UE will be described. As described above, NACK-only feedback may be used as a method for reducing transmission power of the UE. Therefore, when a battery level of the UE falls below a certain threshold, it may be desirable to minimize power used for transmission. Therefore, when the battery level falls below a certain threshold, the UE may report this to the base station to cause the base station to provide an NACK-only feedback configuration, and then the UE may be able to operate in the NACK-only feedback scheme. The threshold for the battery level can also be provided, for example, as base station configuration information or determined by the UE's own determination. For the reporting to the base station, it may be possible for the UE to perform reporting in a manner similar to a scheduling request (SR) by using specific time and frequency resources that are periodically configured, or to report battery level information of the UE itself via PRACH transmission and subsequent PUSCH transmission including Msg3 PUSCH or other MAC CE information, or to request provision of the NACK-only feedback configuration. Alternatively, when the UE transfers UE assistance information to the base station after RRC re-establishment, it may be possible to report that NACK-only feedback is preferred. After the base station receives such a report or preference message from the UE, it may be possible to configure NACK-only feedback by using a higher-layer signal or an L1 signal or a combination thereof. Through this, it may be possible for the base station to reduce power consumption of the UE, thereby extending a usage time of the UE.

### Embodiment 4

Hereinafter, the embodiment describes a multiplexing operation of the UE in a situation where a PUCCH to which the NACK-only feedback scheme has been applied overlaps with another PUCCH or PUSCH resource by at least one symbol in terms of time resources. When a PUCCH to which the ACK/NACK feedback scheme has been applied overlaps with a PUCCH to which the NACK-only feedback scheme has been applied, the UE may change the NACK-only feedback scheme to the ACK/NACK feedback scheme and apply the same. That is, when a PUCCH to which the NACK-only feedback scheme has been applied has ACK, if there is no PUCCH overlapping with the PUCCH to which the NACK-only feedback scheme has been applied, the UE does not transmit the PUCCH. However, if there are PUCCHs overlapping with the PUCCH to which the NACK-only feedback scheme has been applied, the UE may be able to transmit the ACK by including the same in a final PUCCH that is generated by multiplexing the overlapping PUCCHs. In addition, when a PUCCH to which the ACK/NACK feedback scheme has been applied overlaps with a PUSCH, the UE may change the NACK-only feedback scheme to the ACK/NACK feedback scheme, and apply the same. When a PUCCH to which the NACK-only feedback scheme has been applied has ACK, and if there is no PUSCH overlapping with the PUCCH to which the NACK-only feedback scheme has been applied, the UE does not transmit the PUCCH. However, if there is a PUSCH overlapping with the PUCCH to which the NACK-only feedback scheme has been applied, the UE may be able to transmit the ACK by multiplexing the same on the PUSCH.

When the UE supports simultaneous transmission of PUCCH and PUSCH between the same carrier or different carriers, if a PUCCH to which the NACK-only feedback scheme has been applied overlaps with a PUSCH by at least one symbol in terms of time resources, the UE may be able to transmit the PUCCH according to the NACK-only feedback scheme. For example, for ACK, the UE may transmit only a scheduled PUSCH. As another example, for NACK, the UE may separately transmit a PUSCH and a PUCCH including the NACK.

### Embodiment 5

Hereinafter, the embodiment describes a method of applying the NACK-only feedback scheme for each Type 1, Type 2, and Type 3 HARQ-ACK codebook. Since a Type 1 HARQ-ACK codebook is a method in which a UE maps ACK or NACK to a fixed codebook position for each PDSCH time resource, regardless of whether a PDSCH has been actually received, NACK-only feedback is difficult to be applied. Therefore, NACK-only feedback may not be applicable in a situation where the Type 1 HARQ-ACK codebook has been configured. Since a Type 2 HARQ-ACK codebook indicates a codebook size and a position where ACK or NACK information is be included via a DAI field in a DCI format, it may be possible to apply the NACK-only feedback scheme. For example, in a situation where the number of HARQ-ACK bits is configured to be 3 for a specific PUCCH, if all HARQ-ACK bits are ACK, it may be possible for the UE not to transmit the PUCCH. A Type 3 HARQ-ACK codebook is a method in which a UE maps ACK or NACK to each HARQ process number, wherein, when reporting HARQ-ACK feedback for an HARQ process number provided via a DCI format and a reception result of a corresponding PDSCH, the UE maps ACK or NACK to the HARQ process number and reports the same. Accordingly, the size of the HARQ-ACK codebook is determined by the number of HARQ processes, and therefore is not variable. When the UE fails to receive a PDSCH provided via a DCI format scheduled to a specific HARQ process number, and reports NACK, the UE may be able to report HARQ-ACK information for other HARQ processes, including corresponding HARQ process numbers. If the UE successfully receives a PDSCH provided via a DCI format scheduled for a specific HARQ process number and generates ACK, and if there is no separately scheduled DCI format for other HARQ process numbers, it may be possible for the UE not to transmit a PUCCH including corresponding HARQ-ACK information.

### Embodiment 6

Hereinafter, the embodiment describes a method of applying the NACK-only feedback scheme in a situation where a Type-3 HARQ-ACK codebook has been configured.

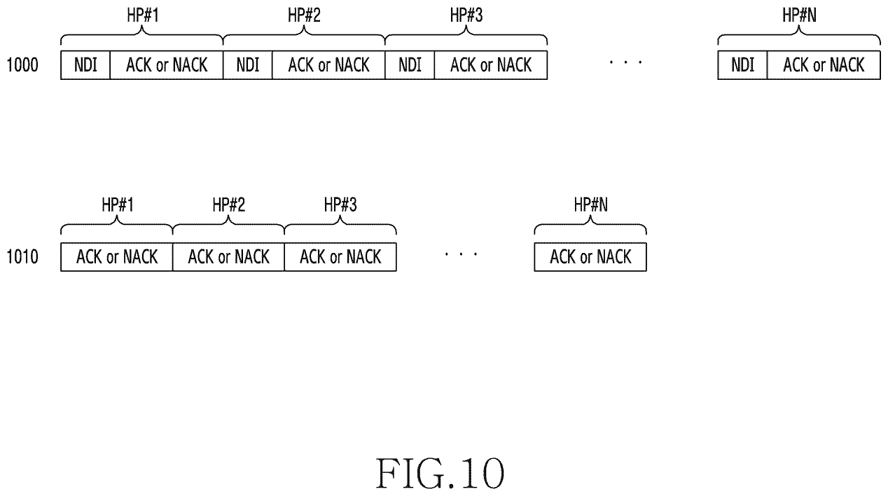

FIG. 10 is a diagram illustrating a method of configuring a Type-3 HARQ-ACK codebook according to an embodiment of the disclosure.

In a first example 1000 of FIG. 10, an NDI and HARQ-ACK information are mapped to each HARQ process number. This is referred to as mode 1 of the Type-3 HARQ-ACK codebook. In an example, when a UE receives a PDSCH scheduled by a DCI format, if a value provided via an NDI field in the DCI format is 0, and an HARQ process number is 1, an NDI value corresponding to HP #1 in the first example 1000 of FIG. 10 is mapped to 0. In addition, if a decoding/demodulation result for the scheduled PDSCH is ACK, an HARQ-ACK value corresponding to HP #1 in the first example 1000 of FIG. 10 is mapped to ACK. If the UE transmits a PUCCH including a Type-3 HARQ-ACK codebook in the form of the first example 1000 of FIG. 10 including the NDI and HARQ-ACK information for HP #1, and then is additionally scheduled with a PUCCH including a Type-3 HARQ-ACK codebook, if no DCI format corresponding to HP #1 has been received, the UE may be able to determine the NDI value as a most recently reported value, and map the HARQ-ACK information to NACK.

Alternatively, it may be possible to determine both the NDI value and the HARQ-ACK information to be most recently reported values. In 1010 of FIG. 10, HARQ-ACK information is mapped to each HARQ process number. This is referred to as mode 2 of the Type-3 HARQ-ACK codebook. If the UE has generated ACK for a PDSCH scheduled for each HARQ process number but has not yet reported the same, the UE maps ACK to a corresponding HARQ process. Otherwise, NACK is generated and mapped. That is, a case where ACK has already been reported or NACK has been generated for a specific HARQ process number indicates that NACK is generated for the HARQ process number. When the NACK-only feedback scheme is applied to mode 2 of the Type-3 HARQ-ACK codebook, this is disadvantageous in terms of reducing transmission power of the UE, because the UE needs to report HARQ-ACK information for all HARQ process numbers if at least one specific HARQ process number generates NACK. For example, in a case where the UE has already reported ACK for a specific HARQ process, and now reports NACK, although the UE has no separately scheduled data, NACK needs to be generated according to the condition, so that it is inevitable for the UE to report NACK. When the NACK-only feedback scheme is applied to mode 2 of the Type-3 HARQ-ACK codebook, if the UE has generated NACK for a PDSCH scheduled for each HARQ process number, but has not reported the NACK, the UE may map ACK to a corresponding HARQ process. Otherwise, ACK may be generated and mapped. By doing so, in a case where the UE has reported NACK for the specific HARQ process number, if no separate scheduling is received thereafter, the UE reports ACK, so that, if ACKs are generated for other HARQ process numbers as well, the UE may be able to avoid transmitting mode 2 of the Type-3 HARQ-ACK codebook in the second example 1010 of FIG. 10. Alternatively, in a situation where the NACK-only feedback scheme is applied to mode 2 of the Type-3 HARQ-ACK codebook in the second example 1010 of FIG. 10, the UE may transmit a PUCCH including the Type-3 HARQ-ACK codebook only when the UE has received a PDSCH for at least one specific HARQ process number and has generated NACK, but has not yet reported the NACK. In all other cases, the UE may not transmit the PUCCH including the Type-3 HARQ-ACK codebook.

### Embodiment 7

Hereinafter, the embodiment describes a UE trigger-based NACK-only feedback transmission method. In embodiment 3, the method of transmitting power information, such as a battery level of a UE, to a base station in the form of UE assistance information has been described. However, even if the UE transmits the information to the base station, it may be possible that the base station does not configure NACK-only feedback, so that a method of directly determining by the UE whether to transmit NACK-only feedback may be required. The base station may first provide a resource for requesting NACK-only feedback transmission via a higher-layer signal. The resource may be in the form of an SR, PRACH, PUCCH, or PUSCH resource. In addition, the resource is periodically configured. When operating in a low-battery state or in a power saving mode, the UE transmits information for requesting NACK-only feedback transmission via the resource. In addition, the UE may be able to transmit a PUCCH including NACK-only feedback by at least one of the following two methods.
Method 7-1: When HARQ-ACK information is included in a first PUCCH that exists immediately after the UE has requested NACK-only feedback transmission, the HARQ-ACK information is applied according to the NACK-only feedback scheme. This may be applicable to a first single PUCCH or may be applicable to N PUCCHs. A value of N may be configured via a separate higher-layer signal. Alternatively, immediately after requesting NACK-only feedback transmission, the PUCCH including HARQ-ACK information can be transmitted according to the NACK-only feedback scheme for a specific time period. The specific time period may be configured via a separate higher-layer signal.

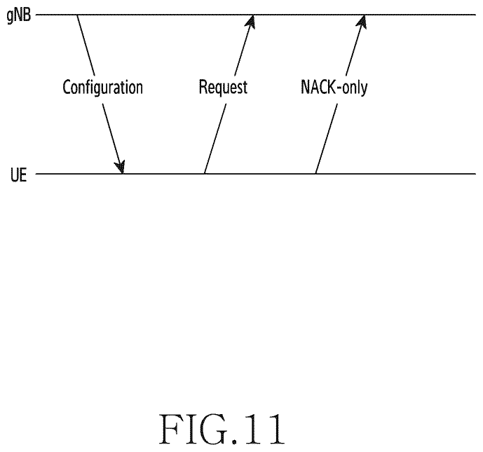

FIG. 11 is a diagram illustrating a situation in which a UE requests NACK-only feedback according to an embodiment of the disclosure.

Specifically, FIG. 11 is a diagram illustrating a situation in which a UE requests NACK-only feedback and transmits NACK-only feedback accordingly, according to an embodiment of the disclosure. A UE receives, from a base station, higher-layer signal information related to an NACK-only feedback request. In addition, immediately after transmitting the NACK-only feedback request signal, the UE may transmit a PUCCH including HARQ-ACK information including NACK-only feedback.
Method 7-2: After requesting NACK-only feedback transmission, the UE may be able to transmit a PUCCH in the NACK-only feedback scheme until the UE transmits, to the base station, a separate signal for releasing NACK-only feedback transmission. The signal for releasing NACK-only feedback transmission can be transmitted by the UE to the base station via a resource used for requesting NACK-only feedback transmission. Alternatively, the signal for releasing NACK-only feedback transmission can be transmitted by the base station to the UE via a higher-layer signal or an L1 signal.

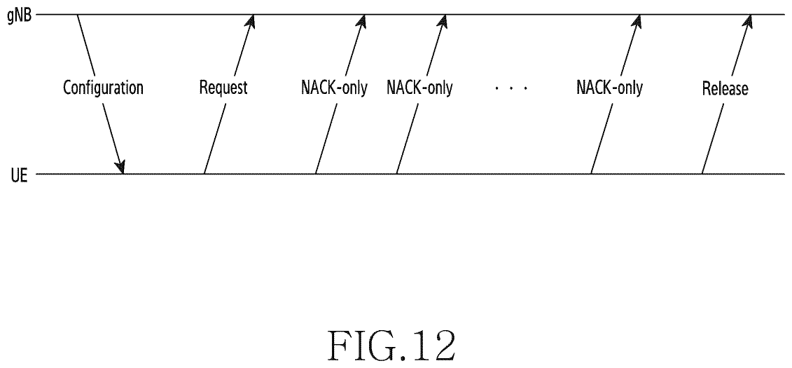

FIG. 12 is a diagram illustrating a situation in which a UE requests NACK-only feedback according to an embodiment of the disclosure.

Referring to FIG. 12 is a diagram illustrating a situation in which a UE requests NACK-only feedback and transmits NACK-only feedback accordingly, according to an embodiment of the disclosure. A UE receives, from a base station, an NACK-only feedback request and resource-related higher-layer signal information for release. In addition, immediately after transmitting the NACK-only feedback request signal, the UE transmits a PUCCH including HARQ-ACK information according to the NACK-only feedback scheme until a separate release signal is transmitted. In FIG. 12, it has been illustrated that the UE transmits a release signal to the base station, but this is not limited thereto, and the base station may transmit a release signal to the UE.

### Embodiment 8

Hereinafter, the embodiment describes an operation in which a delta MCS reporting method is operated together. The delta MCS reporting method is a method in which, after receiving a scheduled PDSCH, a UE informs of an MCS value that the UE prefers or is capable of receiving in a subsequent turn, in comparison with an MCS value applied to the PDSCH. As an example, when the UE applies MCS5 to a first PDSCH transmission and performs transmission, the UE may be able to report to a base station that the UE prefers to use MCS 8 for a subsequent PDSCH transmission. In this case, the UE may report either MCS 8 itself or information indicating that MCS has increased by 3 compared to MCS 5. If delta MCS information is reported together with HARQ-ACK information, there is a drawback in that the number of HARQ-ACK bits increases. Therefore, it may be possible to configure an additional 1 bit apart from the HARQ-ACK bits so as to indicate whether corresponding information includes HARQ-ACK information or delta MCS information. In an example, if the additional 1 bit is 0, the remaining bits may include HARQ-ACK information, and if the additional 1 bit is 1, the remaining bits may include delta MCS information. In this case, a condition for reporting delta MCS may be limited to reporting only when all HARQ-ACK information is ACK.

By doing so, the base station may determine, based on the additional 1 bit being 1, that all previously transmitted PDSCHs have been successfully transmitted. In addition, bits constituting delta MCS may be greater than, equal to, or fewer than bits scheduled for the HARQ-ACK information. Therefore, it may be possible that delta MCS includes 1 bit to 5 bits, and values indicating different ranges are configured in advance via a higher-layer signal according to the size of each bit. When NACK-only feedback has been configured, the UE may be able to avoid transmitting even a delta MCS value itself when all HARQ-ACK information is generated as ACK. Therefore, in such a situation, the UE may use the additional 1 bit to report either delta MCS information or HARQ-ACK information, or may report neither of them.

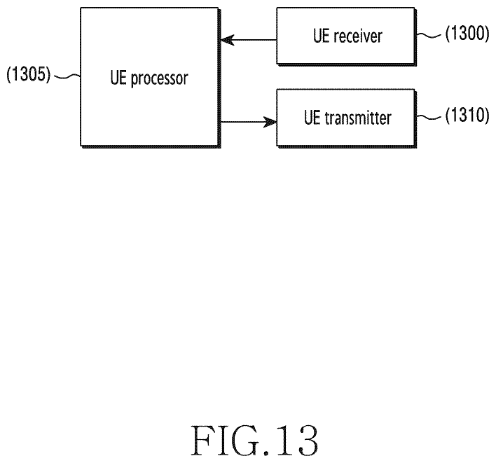

FIG. 13 illustrates a structure of a UE in a wireless communication system according to an embodiment of the disclosure.

Referring to FIG. 13, the UE may include a transceiver, which refers to a UE receiver 1300 and a UE transmitter 1310 as a whole, memory (not illustrated), and a UE processor 1305 (or UE controller or processor). The UE transceiver 1300 and 1310, the memory, and the UE processor 1305 may operate according to the above-described communication methods of the UE. Components of the UE are not limited to the above-described example. For example, the UE may include a larger or smaller number of components than the above-described components. Furthermore, the transceiver, the memory, and the processor may be implemented in the form of a single chip.

The transceiver may transmit/receive signals with base stations. The signals may include control information and data. To this end, the transceiver may include an RF transmitter configured to perform amplification and up-conversion of a frequency of a transmitted signal, an RF receiver configured to perform low-noise amplification of a received signal and down-conversion of a frequency, and the like. However, this is only an embodiment of the transceiver, and the components of the transceiver are not limited to the RF transmitter and the RF receiver.

The transceiver may receive signals through a radio channel, output the same to the processor, and transmit signals output from the processor through the radio channel.

The memory may store programs and data necessary for operations of the UE. In addition, the memory may store control information or data included in signals transmitted/received by the UE. The memory may include storage media such as a ROM, a RAM, a hard disk, a CD-ROM, and a DVD, or a combination of storage media. In addition, the memory may include multiple memories.

The processor may control a series of processes such that the UE can operate according to the above-described embodiments. For example, the processor may control components of the UE to receive DCI configured in two layers so as to simultaneously receive multiple PDSCHs. The processor may include multiple processors, and the processor may perform operations of controlling the components of the UE by executing programs stored in the memory.

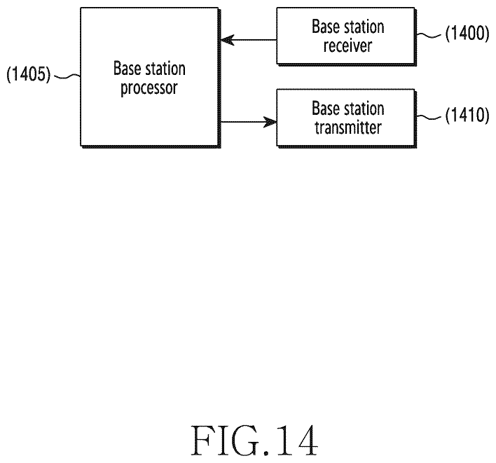

FIG. 14 illustrates a structure of a base station in a wireless communication system according to an embodiment of the disclosure.

Referring to FIG. 14, the base station may include a transceiver, which refers to a base station receiver 1400 and a base station transmitter 1410 as a whole, memory (not illustrated), and a base station processor 1405 (or base station controller or processor). The base station transceiver 1400 and 1410, the memory, and the base station processor 1405 may operate according to the above-described communication methods of the base station. However, components of the base station are not limited to the above-described example. For example, the base station may include a larger or smaller number of components than the above-described components. Furthermore, the transceiver, the memory, and the processor may be implemented in the form of a single chip.

The transceiver may transmit/receive signals with UEs. The signals may include control information and data. To this end, the transceiver may include an RF transmitter configured to perform amplification and up-conversion of a frequency of a transmitted signal, an RF receiver configured to perform low-noise amplification of a received signal and down-conversion of a frequency, and the like. However, this is only an embodiment of the transceiver, and the components of the transceiver are not limited to the RF transmitter and the RF receiver.

The transceiver may receive signals through a radio channel, output the same to the processor, and transmit signals output from the processor through the radio channel.

The memory may store programs and data necessary for operations of the base station. In addition, the memory may store control information or data included in signals transmitted/received by the base station. The memory may include storage media such as a ROM, a RAM, a hard disk, a CD-ROM, and a DVD, or a combination of storage media. In addition, the memory may include multiple memories.

The processor may control a series of processes such that the base station can operate according to the above-described embodiments of the disclosure. For example, the processor may control components of the base station to configure DCI configured in two layers including allocation information regarding multiple PDSCHs and to transmit the same. The processor may include multiple processors, and the processor may perform operations of controlling the components of the base station by executing programs stored in the memory.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including random access memory and flash memory, read only memory (ROM), electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary. In an example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

Various embodiments of the disclosure have been described above. The above description of the disclosure is for the purpose of illustration, and is not intended to limit embodiments of the disclosure to the embodiments set forth herein. Those skilled in the art will appreciate that other specific modifications and changes may be easily made to the forms of the disclosure without changing the technical idea or essential features of the disclosure. The scope of the disclosure is defined by the appended claims, rather than the above detailed description, and the scope of the disclosure should be construed to include all changes or modifications derived from the meaning and scope of the claims and equivalents thereof.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, from a base station, first configuration information for a physical downlink shared channel (PDSCH) and second configuration information for a hybrid automatic repeat request (HARQ) acknowledgement (ACK);
receiving, from the base station, scheduling information for receiving the PDSCH;
receiving, from the base station, the PDSCH;
identifying whether the scheduling information is associated with a downlink (DL) semi-persistent scheduling (SPS); and
transmitting, to the base station, a negative acknowledgement (NACK) message, in case that the scheduling information is associated with the DL SPS and decoding of the received PDSCH fails.

2. The method of claim 1, wherein, in case that the scheduling information is not associated with the DL SPS:
the NACK message is transmitted to the base station, in case that the decoding of the received PDSCH fails; and
an ACK message is transmitted to the base station, in case that the decoding of the received PDSCH succeeds.

3. The method of claim 1, wherein, in case that the scheduling information is associated with the DL SPS and the decoding of the received PDSCH succeeds, an ACK message is not transmitted to the base station.

4. The method of claim 1,
wherein the second configuration information includes resource information for:
initiating transmission of the NACK message, and
releasing the transmission of the NACK message,
wherein a NACK request message is transmitted to the base station, based on the resource information, and
wherein the NACK message is transmitted to the base station until a NACK release message is transmitted to the base station.

5. The method of claim 1, wherein the PDSCH is for unicast.

6. A user equipment (UE) in a wireless communication system, the UE comprising:
at least one transceiver;
at least one processor communicatively coupled to the at least one transceiver; and
at least one memory, communicatively coupled to the at least one processor, storing instructions executable by the at least one processor individually or in any combination to cause the UE to:
receive, from a base station, first configuration information for a physical downlink shared channel (PDSCH) and second configuration information for a hybrid automatic repeat request (HARQ) acknowledgement (ACK),
receive, from the base station, scheduling information for receiving the PDSCH,
receive, from the base station, the PDSCH,
identify whether the scheduling information is associated with a downlink (DL) semi-persistent scheduling (SPS), and
transmit, to the base station, a negative acknowledgement (NACK) message, in case that the scheduling information is associated with the DL SPS and decoding of the received PDSCH fails.

7. The UE of claim 6, wherein, in case that the scheduling information is not associated with the DL SPS:
the NACK message is transmitted to the base station, in case that the decoding of the received PDSCH fails; and
an ACK message is transmitted to the base station, in case that the decoding of the received PDSCH succeeds.

8. The UE of claim 6, wherein, in case that the scheduling information is associated with the DL SPS and the decoding of the received PDSCH succeeds, an ACK message is not transmitted to the base station.

9. The UE of claim 6,
wherein the second configuration information includes resource information for:
initiating transmission of the NACK message, and
releasing the transmission of the NACK message,
wherein a NACK request message is transmitted to the base station, based on the resource information, and
wherein the NACK message is transmitted to the base station until a NACK release message is transmitted to the base station.

10. The UE of claim 6, wherein the PDSCH is for unicast.

11. A method performed by a base station in a wireless communication system, the method comprising:
transmitting, to a user equipment (UE), first configuration information for a physical downlink shared channel (PDSCH) and second configuration information for a hybrid automatic repeat request (HARQ) acknowledgement (ACK);
transmitting, to the UE, scheduling information for the PDSCH;
transmitting, to the UE, the PDSCH; and
receiving, from the UE, a negative acknowledgement (NACK) message, in case that the scheduling information is associated with a downlink (DL) semi-persistent scheduling (SPS) and decoding of the PDSCH fails.

12. The method of claim 11, wherein, in case that the scheduling information is not associated with the DL SPS:
the NACK message is received from the UE, in case that the decoding of the PDSCH fails; and
an ACK message is received from the UE, in case that the decoding of the PDSCH succeeds.

13. The method of claim 11, wherein, in case that the scheduling information is associated with the DL SPS and the decoding of the PDSCH succeeds, an ACK message is not received from the UE.

14. The method of claim 11,
wherein the second configuration information includes resource information for:
initiating transmission of the NACK message, and
releasing the transmission of the NACK message,
wherein a NACK request message is received from the UE, based on the resource information, and
wherein the NACK message is received from the UE until a NACK release message is transmitted to the base station.

15. The method of claim 11, wherein the PDSCH is for unicast.

16. A base station in a wireless communication system, the base station comprising:
at least one transceiver;
at least one processor communicatively coupled to the at least one transceiver; and
at least one memory, communicatively coupled to the at least one processor, storing instructions executable by the at least one processor individually or in any combination to cause the base station to:
transmit, to a user equipment (UE), first configuration information for a physical downlink shared channel (PDSCH) and second configuration information for a hybrid automatic repeat request (HARQ) acknowledgement (ACK),
transmit, to the UE, scheduling information for the PDSCH,
transmit, to the UE, the PDSCH, and
receive, from the UE, a negative acknowledgement (NACK) message, in case that the scheduling information is associated with a downlink (DL) semi-persistent scheduling (SPS) and decoding of the PDSCH fails.

17. The base station of claim 16, wherein, in case that the scheduling information is not associated with the DL SPS:
the NACK message is received from the UE, in case that the decoding of the PDSCH fails, and
an ACK message is received from the UE, in case that the decoding of the PDSCH succeeds.

18. The base station of claim 16, wherein, in case that the scheduling information is associated with the DL SPS and the decoding of the PDSCH succeeds, an ACK message is not received from the UE.

19. The base station of claim 16,
wherein the second configuration information includes resource information for:
initiating transmission of the NACK message; and
releasing the transmission of the NACK message,
wherein a NACK request message is received from the UE, based on the resource information, and
wherein the NACK message is received from the UE until a NACK release message is transmitted to the base station.

20. The base station of claim 16, wherein the PDSCH is for unicast.
